(19) United States
(12) Patent Application Publication
(10) Pub. No.: US 2025/0292556 A1
(43) Pub. Date: Sep. 18, 2025

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: MASAFUMI TAKIMOTO, Kanagawa (JP)

(21) Appl. No.: 19/224,612

(22) Filed: May 30, 2025

Related U.S. Application Data
(63) Continuation of application No. PCT/JP2023/043192, filed on Dec. 1, 2023.

(30) Foreign Application Priority Data
Dec. 6, 2022 (JP) 2022-194903
Dec. 15, 2022 (JP) 2022-200489

(51) Int. Cl. G06V 10/778; G06V 10/25; G06V 10/82; G06V 20/10

(52) U.S. Cl. CPC G06V 10/7788; G06V 10/25; G06V 20/188; G06V 10/82

(57) ABSTRACT

An information processing apparatus detects a partial region corresponding to a detection target from an input image using a learning model. The information processing apparatus accepts information indicating a specific partial region, which is input by a user based on the input image, and generates learning data from a result of correction of the result of detection using the learning model based on the accepted information indicating the specific partial region and the input image.

### CROSS-REFERENCE TO RELATED APPLICATIONS

This application is a Continuation of International Patent Application No. PCT/JP2023/043192, filed Dec. 1, 2023, which claims the benefit of Japanese Patent Application No. 2022-194903, filed Dec. 6, 2022, and Japanese Patent Application No. 2022-200489, filed Dec. 15, 2022, all of which are hereby incorporated by reference herein in their entirety.

### TECHNICAL FIELD

The present disclosure relates to an information processing apparatus, an information processing method, and a program, which are intended for prediction based on images that are captured.

### BACKGROUND ART

Efforts to solve various challenges using Information Technology (IT) have been actively made in agriculture in recent years. The various challenges include prediction of yields, prediction of optimal harvest times, control of the application amounts of agricultural chemicals, and planning of farm field restoration. PTL 1 discloses a method of early acquire growth situation and harvest prediction by appropriately referring to sensor information acquired from a farm field in which agricultural crops are grown and a database storing the information to early find the abnormal growth state for handling. PTL 2 discloses a method of performing arbitrary inference with reference to registered information that is acquired from various sensors concerning agricultural crops to perform farm field management for suppressing variation in the quality and the yield of the agricultural crops.

### CITATION LIST

### Patent Literature

PTL 1 Japanese Patent Laid-Open No. 2005-137209
PTL 2 Japanese Patent Laid-Open No. 2016-49102

However, it is assumed in the proposed methods that a sufficient number of cases that were acquired in the past for the farm field for which the prediction or the like is to be performed are held and an adjustment work enabling accurate estimation of prediction cases based on information concerning the cases has been completed.

In contrast, success or failure of agricultural crop yield is generally greatly influenced by variation in environment, such as weather and climate, and is also greatly differentiated depending on the application state of fertilizer, agricultural chemicals, and the like by a worker. If the conditions determined by all external factors are constant every year, it is not necessary to perform the prediction of yields, the prediction of harvest times, and so on. However, particularly in the agriculture, it is very difficult to perform the prediction because many external factors uncontrollable by the worker exist. In addition, in the prediction of the yields and so on when an unexperienced weather continues, it is difficult to perform correct prediction with a prediction system adjusted based on the cases described above which were acquired in the past.

The prediction of a case is most difficult, in which the prediction system is newly introduced in a farm field. For example, a case is considered in which detection designed to predict the yield in a specific farm field or repair a poor growth region (a dead arm or a disease portion) is performed. In such a task, images and parameters concerning the agricultural crops that were collected in the farm field in the past are normally held in a database. When the prediction or the like is actually performed for the farm field, adjustment is performed with reference to the images that have been captured in the current farm field and data concerning growth information acquired from another sensor to attempt to improve the prediction accuracy. However, since the conditions of a new farm field are likely not to coincide with the conditions of the original farm field when the prediction system is introduced in the new different farm field, as described above, it is not possible to directly adopt the prediction system. In this case, it is necessary to collect a sufficient amount of data in the new farm field for adjustment.

In manual adjustment of the prediction system described above, the adjustment takes a lot of trouble because the level of the parameters concerning the growth of the agricultural crops is made high. In contrast, there is a case in which images of the farm field are captured and deep learning or a machine learning-based method corresponding to the deep learning is performed using the images that are input. However, in this case, it is necessary to perform a manual label attachment (annotation) operation to achieve high performance for a new input. A massive amount of manual annotation is required with the increasing complexity of the challenge to increase the cost. If the detection is performed for a new farm field using a known learned model without generation and learning of learning data using new images and the manual annotation operation, the probability of not detecting an input target image having a look different from that of a pattern that has been learned is increased. However, since high human cost is required to perform the annotation operation each time a new farm field is handled, it is desirable to achieve the performance without the annotation operation as much as possible.

The present disclosure is provided to attain a prediction result capable of achieving expected performance with low cost.

### SUMMARY OF INVENTION

In an embodiment of the present disclosure, an information processing apparatus includes detecting means for detecting a partial region corresponding to a detection target from an input image using a learning model; accepting means for accepting information indicating a specific partial region, which is input by a user based on the input image; and generating means for generating learning data from a result of correction of a result of detection by the detecting means based on the information indicating the specific partial region, accepted by the accepting means, and the input image. In an embodiment of the present disclosure, an information processing apparatus includes detecting means for detecting a partial region corresponding to a detection target from an input image using a learning model and correcting means for correcting a result of detection by the detecting means using an identifier generated through learning using data resulting from certain processing to correct data generated for learning of the learning model as learning data. In an embodiment of the present disclosure, an information processing apparatus includes acquiring means for acquiring correct data generated for learning of a learning model that detects a detection target from an image; processing means for performing certain processing to the correct data; and generating means for generating an identifier through learning using data subjected to the certain processing to the correct data by the processing means as learning data.

Further features of the present invention will become apparent from the following description of exemplary embodiments with reference to the attached drawings.

### BRIEF DESCRIPTION OF DRAWINGS

FIG. 1 is a diagram illustrating an example of the configuration of a system according to an embodiment.

FIG. 2A is a diagram illustrating an example of a method of shooting a farm field by a camera 10.

FIG. 2B is a diagram illustrating an example of the method of shooting a farm field by the camera 10.

FIG. 3A is a diagram illustrating an example of a captured image of agricultural crops.

FIG. 3B is a diagram illustrating an example of a captured image of agricultural crops.

FIG. 4A is a diagram illustrating an example in which annotation is performed for learning for a captured image.

FIG. 4B is a diagram illustrating an example in which the annotation is performed for learning for a captured image.

FIG. 5 is a flowchart of information processing according to first and second embodiment.

FIG. 6 is a flowchart of an annotation creating process.

FIG. 7 is a flowchart of another variation of information processing.

FIG. 8 is a diagram used for description of the respective functions in an information processing apparatus and data.

FIG. 9A is an explanatory diagram of a result of detection in a learned AI model and how to determine a non-detected rectangular region.

FIG. 9B is an explanatory diagram of the result of detection in the learned AI model and how to determine the non-detected rectangular region.

FIG. 10A is an explanatory diagram of a result of detection in the learned AI model and a rectangle input by a user.

FIG. 10B is an explanatory diagram of the result of detection in the learned AI model and the rectangle input by a user.

FIG. 11A is an explanatory diagram of modification with rectangles input by the user and final rectangular regions.

FIG. 11B is an explanatory diagram of the modification with the rectangles input by the user and the final rectangular regions.

FIG. 12 is a diagram illustrating an alert screen.

FIG. 13 is a diagram illustrating an example of an annotation data set.

FIG. 14A is an explanatory diagram of an example of a rectangle to be deleted from the annotation data set.

FIG. 14B is an explanatory diagram of the example of the rectangle to be deleted from the annotation data set.

FIG. 15A is an explanatory diagram of another rectangle to be deleted from the annotation data set.

FIG. 15B is an explanatory diagram of the other rectangle to be deleted from the annotation data set.

FIG. 16A is an explanatory diagram of an example of multiple rectangular regions to be deleted from the annotation data set.

FIG. 16B is an explanatory diagram of the example of the multiple rectangular regions to be deleted from the annotation data set.

FIG. 17A is an explanatory diagram of an example of addition of a random region to the annotation data set.

FIG. 17B is an explanatory diagram of the example of addition of the random region to the annotation data set.

FIG. 18A is an explanatory diagram of an example of rewriting of a rectangular region of the annotation data set.

FIG. 18B is an explanatory diagram of the example of rewriting of the rectangular region of the annotation data set.

FIG. 19A is a flowchart of information processing according to a third embodiment.

FIG. 19B is a flowchart of the information processing according to the third embodiment.

FIG. 20 is a diagram illustrating an example of a manufacturing line of an industrial product.

FIG. 21A is a diagram illustrating an example of a captured image of a target component in appearance check and rectangular regions.

FIG. 21B is a diagram illustrating the example of a captured image of the target component in the appearance check and rectangular regions.

FIG. 21C is a diagram illustrating the example of a captured image of the target component in the appearance check and rectangular regions.

FIG. 21D is a diagram illustrating the example of a captured image of the target component in the appearance check and rectangular regions.

FIG. 21E is a diagram illustrating the example of a captured image of the target component in the appearance check and rectangular regions.

FIG. 22A is a diagram illustrating an example of a captured image of a target component to which other components are assembled and rectangular regions.

FIG. 22B is a diagram illustrating the example of a captured image of the target component to which the other components are assembled and rectangular regions.

FIG. 22C is a diagram illustrating the example of a captured image of the target component to which the other components are assembled and rectangular regions.

FIG. 23A is a diagram illustrating an example of a captured image of a target component having an assembly failure and rectangular regions.

FIG. 23B is a diagram illustrating the example of a captured image of the target component having the assembly failure and a rectangular region.

FIG. 24 is a diagram illustrating a table used in determination of regions for non-estimated portions.

FIG. 25A is a diagram illustrating an example of an image in which non-detected regions occur and an example of learned images.

FIG. 25B is a diagram illustrating the example of the image in which the non-detected regions occur and the example of the learned images.

FIG. 26 is a flowchart of information processing according to a fourth embodiment.

FIG. 27A is a diagram illustrating an example of rectangular regions of GT and rectangular regions that are deleted.

FIG. 27B is a diagram illustrating the example of the rectangular regions of the GT and the rectangular regions that are deleted.

FIG. 28 is a diagram illustrating an example of defective GT data.

FIG. 29 is a diagram illustrating an image resulting from imaging of the defective GT data in FIG. 27B.

FIG. 30 is a flowchart of a process with the learned AI model and a deficit correction identifier.

FIG. 31 is a diagram illustrating an example of a captured image in which false detection is likely to occur.

FIG. 32 is a flowchart of information processing according to a fifth embodiment.

FIG. 33A is a diagram illustrating rectangular regions including the false detection and images resulting from imaging.

FIG. 33B is a diagram illustrating the rectangular regions including the false detection and the images resulting from imaging.

FIG. 34 is a flowchart of a process with the learned AI model and a false detection correction identifier.

FIG. 35 is a flowchart of information processing according to a sixth embodiment.

FIG. 36 is a diagram schematically illustrating a process handling both the non-detection and the false detection.

FIG. 37 is a flowchart of information processing according to a seventh embodiment.

FIG. 38A is a flowchart illustrating a variation of combination of correcting methods.

FIG. 38B is a flowchart illustrating a variation of combination of the correcting methods.

FIG. 39 is a flowchart used in Step S98 in FIG. 37.

FIG. 40 is a flowchart of information processing according to an eighth embodiment.

FIG. 41A is a table indicating an example of a parameter set.

FIG. 41B is a table indicating an example of a parameter set.

FIG. 42A is a diagram illustrating an exemplary image of a ninth embodiment and a result of detection.

FIG. 42B is a diagram illustrating an exemplary image of the ninth embodiment and a result of detection.

FIG. 42C is a diagram illustrating an exemplary image of the ninth embodiment and a result of detection.

FIG. 42D is a diagram illustrating an exemplary image of the ninth embodiment and a result of detection.

FIG. 42E is a diagram illustrating an exemplary image of the ninth embodiment and a result of detection.

FIG. 43A is a diagram illustrating an example of correction in the ninth embodiment.

FIG. 43B is a diagram illustrating the example of the correction in the ninth embodiment.

FIG. 43C is a diagram illustrating the example of the correction in the ninth embodiment.

### DESCRIPTION OF EMBODIMENTS

Embodiments according to the present disclosure will herein be described with reference to the drawings. The respective embodiments described below are not intended to limit the present disclosure and all the combinations of features described in the embodiments are not necessarily required for resolving means of the present disclosure. The components of the embodiments may be appropriately modified or changed depending on the specifications and various conditions (conditions for use, usage environment, and so on) of apparatuses to which the present disclosure is applied. The same reference numerals are used in the following embodiments to identify the same components or similar components and duplicated description of such components is omitted herein.

### First Embodiment

In a first embodiment, a learning process in a system will be described. The system performs an analysis process of a farm field, such as prediction of the yield of agricultural crops or detection of a portion to be repaired in the farm field, from a captured image of the farm field, which are captured by a camera, using a machine learning model.

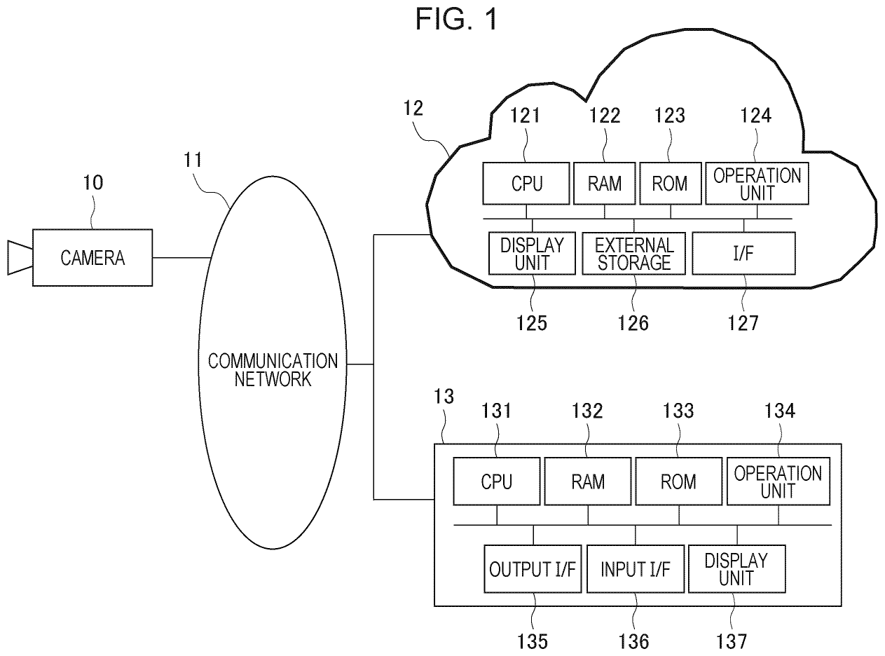

FIG. 1 is a diagram illustrating an example of the configuration of a system according to the first embodiment. Referring to FIG. 1, the system according to the first embodiment includes a camera 10, a cloud server 12, and an information processing apparatus 13.

The camera 10 captures a moving image of a farm field and outputs the image of each frame in the moving image as a “captured image of the farm field”. Alternatively, the camera 10 periodically or non-periodically captures a still image of a farm field and outputs the captured still image as the “captured image of the farm field”. It is desirable to capture the images captured in the same farm field in the same environment and condition as much as possible to accurately perform prediction described below from the captured image. The captured image output from the camera 10 is transmitted to the cloud server 12 and the information processing apparatus 13 via a communication network 11, such as a local area network (LAN) or the Internet.

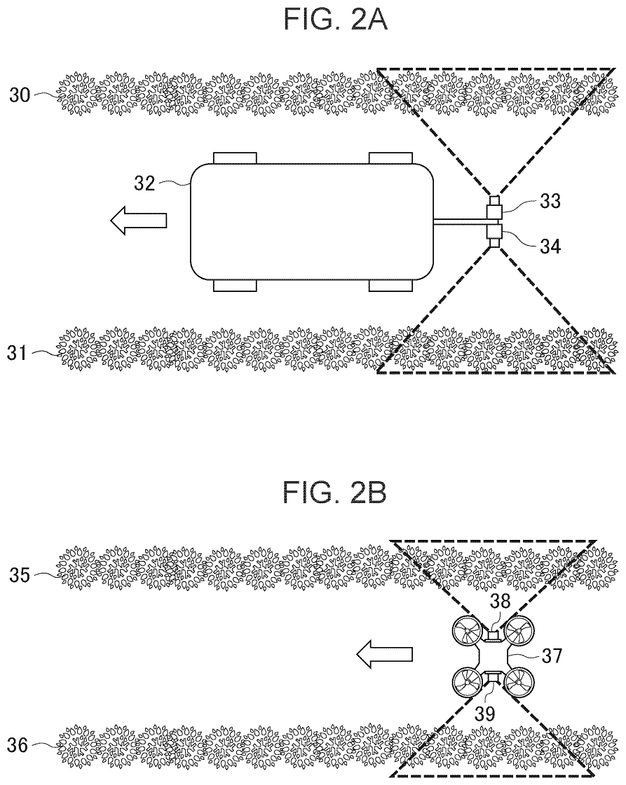

The method of shooting a farm field by the camera 10 is not limited to a specific shooting method. An example of the method of shooting a farm field by the camera 10 will be described with reference to FIG. 2A. In the example in FIG. 2A, a camera 33 and a camera 34 are used as the camera 10. In a common farm field, agricultural crops (trees in the examples in FIG. 2A and FIG. 2B) systematically planted by a farmer are aligned in line. For example, the agricultural crop trees are planted in multiple lines including a line 30 and a line 31 of the agricultural crop trees, as illustrated in FIG. 2A. The farm field illustrated in the example in FIG. 2A is designed so that a farm work tractor 32 enters the farm field for working and the agricultural crop trees are planted with equal spacing. The farm work tractor 32 is provided with the camera 34 that shoots the left-side line 31 of the agricultural crop trees and the camera 33 that shoots the right-side line 30 of the agricultural crop trees, in the moving direction illustrated by an arrow in FIG. 2A. Accordingly, when the farm work tractor 32 moves in the moving direction illustrated by the arrow between the line 30 and the line 31 of the trees, the camera 34 captures multiple images of the agricultural crop trees on the line 31 and the camera 33 captures multiple images of the agricultural crop trees on the line 30.

In the farm field designed in the manner illustrated in FIG. 2A, shooting the agricultural crop trees with the cameras 33 and 34 installed on the farm work tractor 32 enables a greater number of the agricultural crop trees to be relatively easily shot at a constant height and in a state in which a constant distance is kept from the agricultural crop trees. Accordingly, in the farm field designed in approximately the same condition, it is possible to capture the images in the above manner to easily realize the capturing of the images in the desired condition.

If the shooting of the farm field in approximately the same condition is enabled, another shooting method may be adopted. Another example of the method of shooting a farm field by the camera 10 will be described with reference to FIG. 2B. In the example in FIG. 2B, a camera 38 and a camera 39 are used as the camera 10. In the farm field or the like in which the interval between a line 35 and a line 36 of the agricultural crop trees is narrow, as illustrated in FIG. 2B, and the running of the tractor 32 is disabled, shooting by the camera 38 and camera 39, which are mounted on a drone 37, may be performed. The drone 37 is provided with the camera 39 that shoots the left-side line 36 of the agricultural crop trees and the camera 38 that shoots the right-side line 35 of the agricultural crop trees, in the moving direction illustrated by an arrow in FIG. 2B. Accordingly, when the drone 37 moves in the moving direction illustrated by the arrow between the line 35 and the line 36, the camera 39 captures multiple images of the agricultural crop trees on the line 36 and the camera 38 captures multiple images of the agricultural crop trees on the line 35.

The images of the agricultural crop trees may be captured by a camera installed in a mobile robot, instead of the drone. Although the number of the cameras used in the shooting is two in the examples in FIG. 2A and FIG. 2B, the number of the cameras is not limited to a specific number.

The camera 10 attaches shooting information acquired in the shooting to the captured image to output the captured image to which the shooting information is attached regardless of the method of capturing the image of the agricultural crop trees. The shooting information is exemplified by information concerning the shooting, such as a shooting position measured by a global positioning system (GPS), a shooting date and time, and an exposure setting of the camera 10, and such shooting information is recorded in the captured image as Exif information.

The captured image output from the camera 10 may be temporarily stored in the memory of another device and, then, may be transferred from the memory to the cloud server 12 via the communication network 11.

The captured image transmitted from the camera 10 (the captured image to which the Exif information is attached) is registered in the cloud server 12. In addition, multiple artificial intelligence (AI) models (including a detector in machine learning and settings of the detector) for detecting an object from the captured image are registered in the cloud server 12. The AI model is a concept including settings, such a deep neutral network (DNN) to be used, weighting parameters that are learned and used in the DNN, and other parameters for adjusting the output from the DNN when the DNN is used, in deep learning. Similar concepts in the machine learning other than the deep learning are hereinafter referred to as the AI models. In the first embodiment, the object detected from the captured image is the agricultural crops and the AI model is the machine learning model for detecting partial regions concerning the agricultural crops from the captured image. The AI model may be the multiple machine learning models learned in different leaning environments. In this case, the AI models of different breeds of the agricultural crops (for example, tomato, grape, rice, wheat, and so on) are exemplified.

In the cloud server 12, the AI model matched with the condition of the target agricultural crops, among the multiple AI models held in the cloud server 12, is selected using an arbitrary method. The AI model may be selected based on the parameters added to the model, for example, based on the breed of the agricultural crops (when the AI model is used in a tomato farm, the AI model learned with the images of the tomatoes) or based on the growing method. In addition to this, a method of selecting the AI model that has acquired favorable results of detection for the images that have been actually captured in the farm field may be used. The cloud server 12 detects the partial regions concerning the agricultural crops from the captured image by the camera 10 using the selected AI model to perform the analysis process.

A central processing unit (CPU) 121 performs various processes using computer programs and data stored in a random access memory (RAM) 122 and a read only memory (ROM) 123. The CPU 121 controls the operation of the entire cloud server 12 and performs or controls various processes described to be performed by the cloud server 12.

The RAM 122 has an area in which computer programs and data loaded from the ROM 123 or an external storage 126 are stored and an area in which data received from the outside via an interface (I/F) 127 is stored. In addition, the RAM 122 has a working area used by the CPU 121 to perform the various processes. As described above, the RAM 122 is capable of appropriately providing the various areas.

Setting data of the cloud server 12, computer programs and data concerning start-up of the cloud server 12, computer programs and data concerning the basic operation of the cloud server 12, and so on are stored in the ROM 123.

The external storage 126 is a mass information storage device, such as a hard disk drive. Computer programs and data causing the CPU 121 to perform or control various processes described to be performed by an operating system (OS) or the cloud server 12 are stored in the external storage 126. The data stored in the external storage 126 includes the data concerning the AI model described above. The computer programs and the data stored in the external storage 126 are appropriately loaded in the RAM 122 under the control of the CPU 121 to be processed by the CPU 121.

An operation unit 124 is a user interface, such as a keyboard, a mouse, or a touch panel. Various instructions input by a user with the operation unit 124 are capable of being supplied to the CPU 121.

A display unit 125 includes a screen, such as a liquid crystal display or a touch panel display. The result of processing by the CPU 121 is capable of being displayed in the display unit 125 with images, characters, and/or the likes. The display unit 125 may be a projection device, such as a projector, that projects images and/or characters.

The I/F 127 is a communication interface for data communication with the outside of the cloud server 12. The cloud server 12 performs transmission and reception of data with the outside via the I/F 127. The CPU 121, the RAM 122, the ROM 123, the operation unit 124, the display unit 125, the external storage 126, and the I/F 127 are connected to a system bus. The configuration of the cloud server 12 is not limited to the one illustrated in FIG. 1.

The information processing apparatus 13 is a computer apparatus, such as a personal computer (PC), a smartphone, or a tablet terminal device, which includes a set of input-output devices. In the information processing apparatus 13, a manual annotation operation by the user is performed for the image of the farm field, which is to be identified using the AI model selected in the cloud server 12 in the above manner. In other words, in the information processing apparatus 13, the annotation operation is performed for a “captured image requiring a manual attachment operation (annotation operation) of a label (teaching data (ground truth (GT)) indicating a correct answer)”. Additional learning of a “relatively robust AI model in detection accuracy in detection of the partial regions concerning the agricultural crops from the captured image” is performed using the captured image subjected to such an annotation operation by the user to update the AI model. The update of the AI model may be performed in the information processing apparatus 13 or may be performed in the cloud server 12. The information processing apparatus 13 or the cloud server 12 may detect the partial regions concerning the agricultural crops from the captured image by the camera 10 using the AI model to perform the farm field analysis process, such as the prediction of the yield of the agricultural crops or the detection of the portion to be repaired in the farm field.

A CPU 131 performs various processes using computer programs and data stored in a RAM 132 and a ROM 133. The CPU 131 controls the operation of the entire information processing apparatus 13 and performs or controls various processes described to be performed by the information processing apparatus 13.

The RAM 132 has an area in which computer programs and data loaded from the ROM 133 are stored and an area in which data received from the camera 10 or the cloud server 12 via an input I/F 136 is stored. In addition, the RAM 132 has a working area used by the CPU 131 to perform the various processes. As described above, the RAM 132 is capable of appropriately providing the various areas.

Setting data of the information processing apparatus 13, computer programs and data concerning start-up of the information processing apparatus 13, computer programs and data concerning the basic operation of the information processing apparatus 13, and so on are stored in the ROM 133.

An output I/F 135 is an interface used by the information processing apparatus 13 to output or transmit a variety of information to the outside of the information processing apparatus 13.

The input I/F 136 is an interface used by the information processing apparatus 13 to input or receive a variety of information from the outside of the information processing apparatus 13.

A display unit 137 has a liquid crystal display or a touch panel display. The result of processing by the CPU 131 is capable of being displayed in the display unit 137 with images, characters, and/or the likes. The display unit 137 may be a projection device, such as a projector, that projects images and/or characters.

An operation unit 134 includes a keyboard and a mouse. Various instructions input by the user with the operation unit 134 are capable of being supplied to the CPU 131. The operation unit 134 may include a touch sensor, such as a touch panel.

The configuration of the information processing apparatus 13 is not limited to the configuration illustrated in FIG. 1. For example, the information processing apparatus 13 may include a mass information storage device, such as a hard disk drive. Computer programs and data of a graphical user interface (GUI) described below or the like may be stored in the hard disk drive.

Next, a task flow of predicting the yield of the agricultural crops to be harvested in the farm field from the captured image of the farm field, which is acquired by the camera 10, at a stage earlier than the harvest time will be described. Here, when the yield amount is predicted by simply counting fruits or the likes to be harvested at the harvest time, the purpose is achieved by detecting the target fruits from the captured image with an identifier (an estimator) using a method called specific object detection. This is a method of detecting the very characteristic appearance of the fruits themselves with the identifier that has learned the characteristic appearance.

In the first embodiment, when the agricultural crops are the fruits, not only the counting of the fruits after the fruits have matured but also the prediction of the yield of the fruits at a stage earlier than the harvest time are supposed. Specifically, for example, detection of inflorescences that will produce the fruits to predict the yield from the number of the inflorescences, detection of dead arms and disease portions with low probability of producing the fruits to predict the yield, prediction of the yield from the state of the growth of the leaves, and so on are considered as the prediction of the yield of the fruits. In order to perform such prediction, it is necessary to use a prediction method considering the growth situation of the agricultural crops, which is varied depending on the shooting time and the climate. In other words, it is necessary to select the prediction method having high prediction performance depending on the shooting time, the climate, and the status of the agricultural crops. In this case, the prediction described above is expected to be appropriately performed using a learning model matched with the farm field for which the prediction is to be performed.

To this end, in the first embodiment, various objects, such as the farm field, the agricultural crops, and so on, in the captured image are classified into multiple classes to predict the yield based on the classes resulting from the classification. In the first embodiment, a tree trunk class, an arm class, a dead arm class, a support class, and so on of the agricultural crops are exemplified as the various object classes, such as the farm field and the agricultural crops, and the yield is predicted based on the classes resulting from the classification. However, since the appearances of the objects belonging to the tree trunk class, the arm class, and so on are varied depending on the shooting time, it is not possible to realize the versatile prediction.

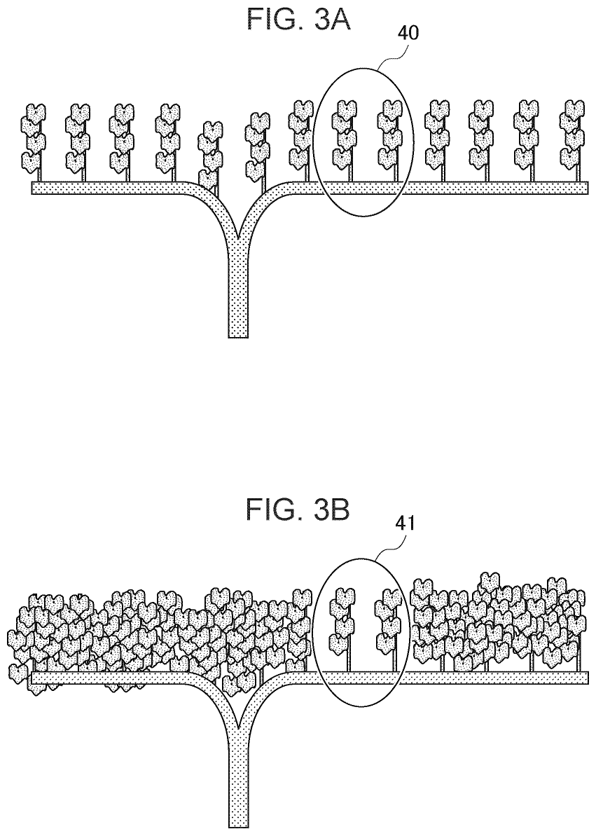

FIG. 3A and FIG. 3B are diagrams used for description of such difficult cases. Examples of images in FIG. 3A and FIG. 3B image wine grape trees. The arms lengthen in the horizontal direction in the images in FIG. 3A and FIG. 3B. FIG. 3A and FIG. 3B illustrate examples of the captured images captured by the camera 10 described above. Although the agricultural crop trees are aligned with approximately equal spacing in the captured images, a task of detecting the fruits themselves is not capable of being performed from the captured images because the fruits or the likes to be harvested are not produced.

The trees in the captured image in FIG. 3A are the agricultural crop trees shot at a relatively early stage while the tress in the captured image in FIG. 3B are the trees shot at a stage at which the leaves are grown to some extent. In the captured image in FIG. 3A, the arms of all the trees have the same degree of leaves. Accordingly, it can be determined that no poor growth region exists and, thus, it can be determined that the harvest of the fruits will be possibly available in the regions of all the arms. In contrast, in the captured image in FIG. 3B, for example, the growth of the leaves on the arms near a region 41 is apparently different from that in the other regions. Accordingly, it can be determined that the leaves on the arms near the region 41 are poorly grown. However, the state of the region 41 (the region having a small number of leaves) in FIG. 3B can be found near a region 40 in the captured image in FIG. 3A as a similar pattern. These two cases indicate that an abnormal region of the agricultural crop trees is not capable of being determined only from a local pattern. In other words, the abnormal region of the agricultural crop trees is not capable of being determined only with a method, such as the specific object detection, using the local pattern, and it is necessary to determine the abnormal region of the agricultural crop trees with the context acquired from the entire image being reflected.

In addition, for example, when the specific object detection is performed using the learning model, it is not possible to achieve sufficient performance unless the learning model that has performed the learning with the images captured from the agricultural crops in similar growth situations under similar conditions in the past is prepared. In other words, in order to address various cases including an image of a new farm field, which is first captured, an image captured in a condition different from the previous shooting condition, and an image captured at a time convenient to the user, it is necessary to use the learning model that has performed the learning in conditions close to the conditions of such images. For example, a case in which the shooting condition is varied from the previous one due to an external factor, such as a continuous dry weather or an extremely large amount of rain, is supposed as the image captured in a condition different from the previous shooting condition.

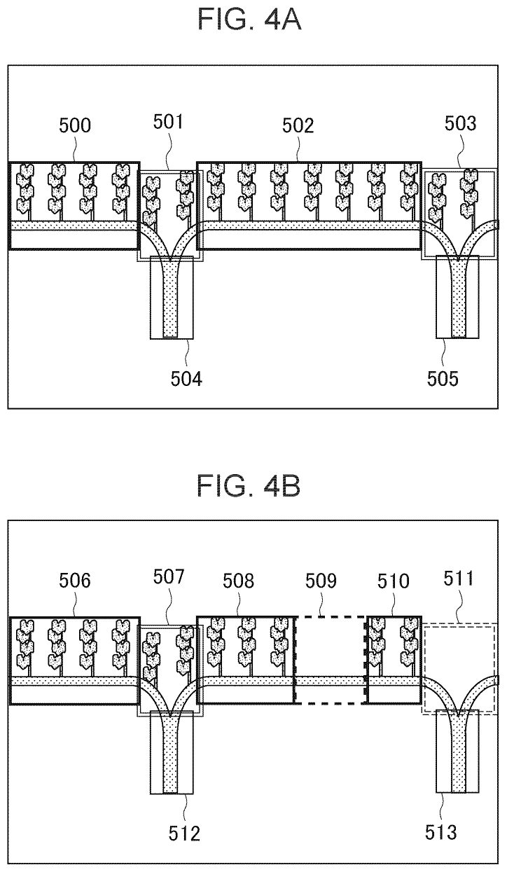

The annotation operation required when the annotation operation and the machine learning in the deep learning are performed each time the farm field is shot will now be described. For example, FIG. 4A and FIG. 4B are diagrams used for description of the result of the annotation operation performed for the captured image of the farm field having a growth environment close to that in FIG. 3A.

Image regions surrounded by rectangles in the captured image in FIG. 4A are the partial regions specified in the annotation operation. In the first embodiment and the other embodiments described below, the partial regions specified in the annotation operation are represented as rectangular regions, the machine learning is performed using the images of the rectangular regions, and the rectangular regions are estimated in an estimation process. Rectangular regions 500 and 502 are the partial regions specified as normal arm regions and rectangular regions 504 and 505 are the partial regions specified as tree trunk regions. Rectangular regions 501 and 503 are the partial regions in which the growth state is normal in a branching portion (Y-shaped section) of the tree trunk. In the case of the example of the image in FIG. 4A, since the rectangular regions 500, 501, 502, and 503 are the regions having the normal growth state, the respective rectangular regions are greatly related to the prediction of the yield. In the following description, the rectangular region, such as the rectangular region 500, having the normal tree growth state and the rectangular region in which the fruits or the likes are harvestable are referred to as “production regions”.

FIG. 4B is represented in the same manner as in FIG. 4A and rectangular regions 506 to 513 in the captured image in FIG. 4B represent the partial regions specified in the annotation operation. The rectangular regions 506, 508, and 510 are the partial regions specified as the regions of the arms having the normal growth state. The rectangular region 507 is the partial region of the normal Y-shaped section and the rectangular regions 512 and 513 are the partial regions specified as the regions of the tree trunk. In contrast, in the example in FIG. 4B, the rectangular region 509 is the partial region specified as the dead arm region having the abnormal growth state and the rectangular region 511 is the partial region specified as the Y-shaped section in the abnormal dead arm state. In the following description, the rectangular regions, such as the rectangular region 509 and the rectangular region 511, indicating the abnormal growth state, that is, the rectangular regions in which the fruits or the likes are not harvestable are referred to as “non-production regions”. Also in the example in FIG. 4B, since the partial regions determined as the production regions in which the fruits or the likes are harvestable are the rectangular regions 506, 507, 508, and 510, these rectangular regions are greatly related to the prediction of the yield.

In the following description, which portion of the agricultural crops each rectangular region corresponds to, whether each rectangular region is the production region or the non-production region, and so on are represented using an Arm pattern, a Bare Arm pattern, a Fork pattern, a Bare Fork pattern, and a Trunk pattern described below.
Arm: Arm region and production region
Bare Arm: Arm region and non-production region
Fork: Y-shaped section region and production region
Bare Fork: Y-shaped section region and non-production region
Trunk: Trunk region

In the first embodiment, the rectangular regions of the five patterns are learned and the detection is performed using the object detection method using the learning model.

In the first embodiment, the rules of the respective rectangular regions on the drawings are defined in the following manner in FIG. 4A and FIG. 4B and the respective drawings described below used for description of the annotation operation.
Rectangular region indicated by bold solid line: Arm pattern
Rectangular region indicated by broken line: Bare Arm pattern
Rectangular region indicated by double solid lines: Fork pattern
Rectangular region indicated by double broken lines: Bare Fork pattern
Rectangular region indicated by thin solid line: Trunk pattern

In other words, in the first embodiment, the respective rectangular regions are processed as regions to which labels meaning the Arm pattern, the Bare Arm pattern, the Fork pattern, the Bare Fork pattern, and the Trunk pattern are added (annotated).

Here, in order to perform the annotation operation described above for the many captured images (for example, several hundred farm fields to several thousand captured images) each time the farm field is shot, it takes a lot of cost (cost including time and effort).

Accordingly, in the first embodiment, annotation data is efficiently generated through information processing described below without inputting all the annotations required for the learning to enable reduction of the cost concerning the annotation operation.

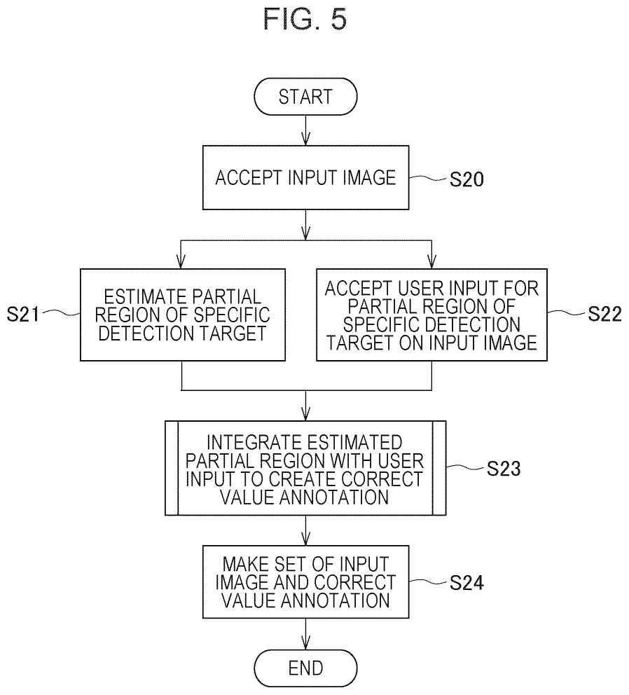

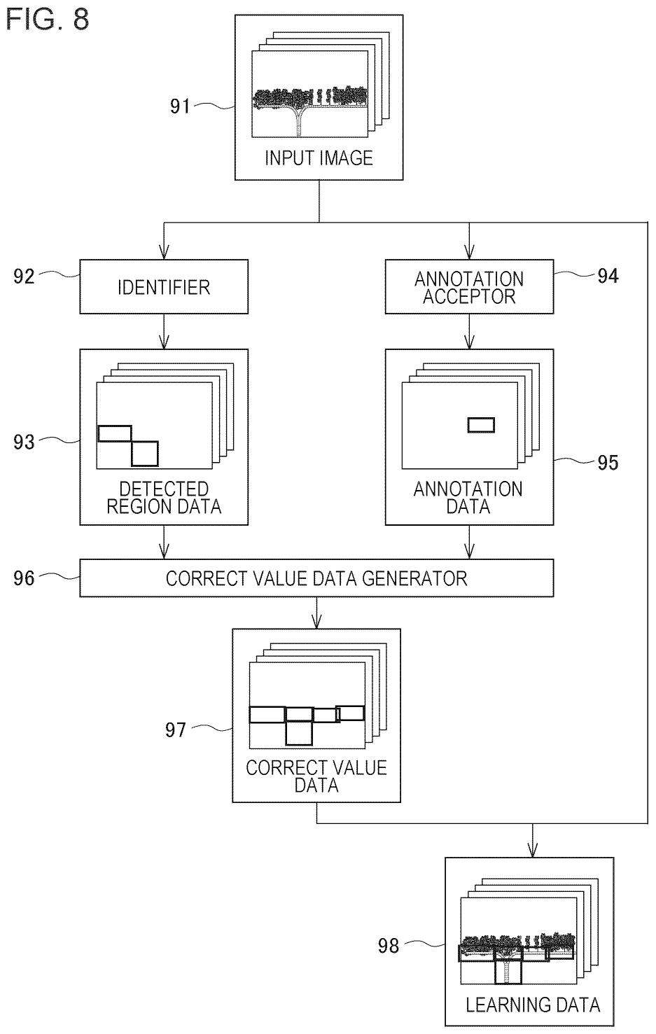

How to realize the annotation capable of reducing the cost including time and effort (hereinafter referred to as simple annotation) in the first embodiment will be described with the previous and subsequent processes. FIG. 5 to FIG. 7 are flowcharts illustrating flows of the information processing in the information processing apparatus 13 of the first embodiment. FIG. 8 is a diagram used for description of the function and the data realized by performing an information processing program of the first embodiment in the CPU 131 in the information processing apparatus 13 of the first embodiment. In other words, FIG. 8 is a diagram simply illustrating an example of the functional configuration and the data from acceptance of the captured image to generation of the learning data to be added in the first embodiment.

The AI model that has learned in advance a detection target is used in the first embodiment. However, it is assumed that, since the learning of the detection target is insufficient, improvement of detection performance by further adding the learning data is required. If no learning of the detection target is performed, all the rectangular regions to be detected described above are manually added to the images for learning and, then, the simple annotation in the first embodiment described below is performed.

Referring to FIG. 5, in Step S20, the CPU 131 in the information processing apparatus 13 acquires the captured image of the farm field by the camera 10 installed in a moving body, such as the farm work tractor 32 or the drone 37, as an input image 91 via the input I/F 136. Then, the CPU 131 in the information processing apparatus 13 performs the information processing described below using the input image 91. After Step S20, the CPU 131 concurrently performs Step S21 and Step S22.

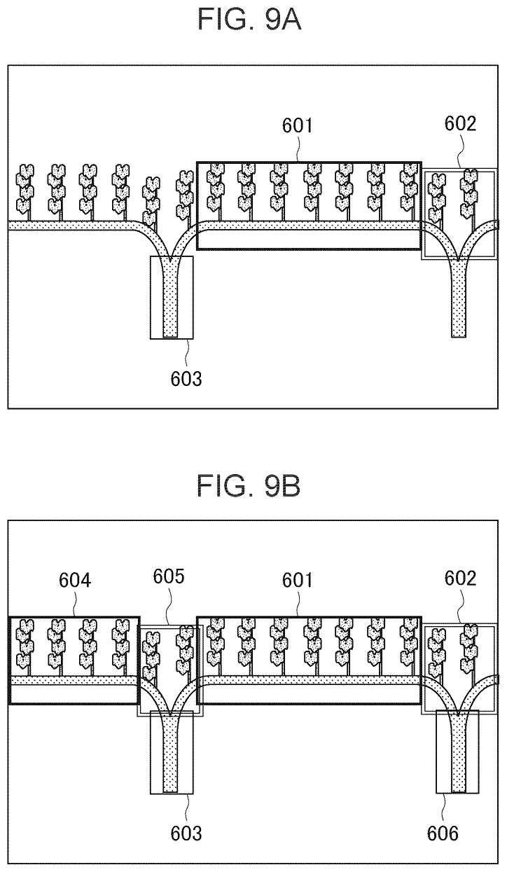

In Step S21, the CPU 131 performs a detection process by an identifier 92 for which a learned AI model that is pre-learned is set to acquire detected region data 93, which is the result of detection. FIG. 9A illustrates an example of the rectangular regions in the detected region data 93, which is the result of detection. FIG. 9A is a typical example of the rectangular regions that have been detected when an image slightly different from the learning environment of the learned AI model is input as the input image. In other words, since a portion to be detected as the rectangular region may not be detected if an image the tendency of look of which is only slightly different from that of the image used in the learning is input, only a rectangular region 601 and a rectangular region 603 are detected in FIG. 9A. As described above, in the case of the example in FIG. 9A, a region that is not detected exists despite that the region is a portion to be detected as the rectangular region.

Accordingly, in Step S22, the CPU 131 displays a GUI on which input of the rectangular region by the user is available in the display unit 137 for the input image 91 acquired in Step S20 to accept the input of the rectangular region to be learned. In other words, the CPU 131 accepts the simple annotation by the user as an annotation acceptor 94 in Step S22. In the first embodiment, the simple annotation is the annotation not for all the rectangular regions that are finally required in the learning but for a specific partial region. The CPU 131 accepts annotation data 95 generated through the simple annotation from the user. In the first embodiment, the rectangular region for which the input is accepted from the user in the simple annotation is only the non-production region.

As described above, the input of the non-production region is asked of the user in the first embodiment. The meaning of asking the input of the non-production region of the user will be described here. The examples in FIG. 4A and FIG. 4B are illustrated as recognizable cases in which the patterns of the production regions are greatly different from the patterns of the non-production regions for convenience of description. However, when the poor growth region is detected as the non-production region, the criterion for determining how much difference is found between the good growth region and the poor growth region to detect the poor growth region as the non-production region is varied depending on the user and the result of detection may be greatly varied depending on the criterion.

For example, when the Arm pattern such as the rectangular region 508 illustrated in FIG. 4B is compared with the Bare Arm pattern such as the rectangular region 509 illustrated in FIG. 4B, stems which will produce flowers and fruits exist in the rectangular region 508 while such arms do not exist in the rectangular region 509. Accordingly, the user is capable of easily recognizing the rectangular region 509 as the non-production region of the Bare Arm pattern. However, in the image that is actually captured, there is a case in which the pattern of the production region is very similar to the pattern of the non-production region. For example, as illustrated in FIG. 2A and FIG. 2B, in the farm fields in which the multiple tree lines are aligned, other tree leaves or the likes behind the tree lines may be shot in the rectangular region of the Bare Arm pattern. In the rectangular region of the Bare Arm pattern at this time, the pattern of the non-production region may be falsely determined as the pattern of the production region due to the images of the other tree leaves or the likes behind the tree lines. Such false detection due to the tree leaves behind the tree lines may occur in the same manner also in the region of the Bare Fork pattern, such as the rectangular region 511 in FIG. 4B.

As described above, since the difference between the non-production region and the production region is frequently obscure in the captured image, only the determination of the non-production region is performed by the user with his/her eyes in the first embodiment. If all the non-production regions are determined, the production regions are automatically determined. In addition, the frequency of occurrence of the abnormal portion, such as the poor growth region, is generally frequently lower than that of the good growth region and, thus, it is considered that the portion corresponding to the case with the low frequency of occurrence has high probability of the abnormal portion. Accordingly, inputting only the non-production region as in the first embodiment suppresses the input cost.

For example, if the rectangular region detected in Step S21 is in the state in FIG. 9A, it is assumed that the user determines that no non-production region exists in the input image in Step S22. In this case, since the user does not input the rectangular regions (or inputs of non-existence of the non-production region), only a history of viewing of the input image by the user is held in the information processing apparatus 13. Accordingly, in Step S23, the CPU 131 integrates the result of estimation of the rectangular region in Step S21 with information indicating that “no non-production region exists in the input image” in Step S22 to generate correct value data. In Step S24, the CPU 131 makes a set of the input image and the correct value data to generate learning data 98.

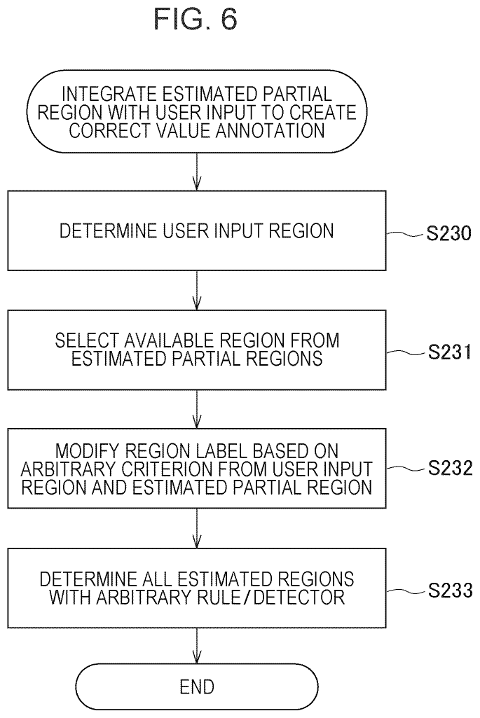

FIG. 6 is a flowchart illustrating a detailed process of Step S23 in FIG. 5.

In Step S230, the CPU 131 simply performs only confirmation of any apparent human error in the user input. For example, the CPU 131 performs error determination based on the size of the rectangular region input by the user and error determination using the overlapped area of the input rectangular regions to perform the simple confirmation of any human error. In the error determination based on the size of the rectangular region, if the size of the rectangular region is too small in consideration of the property of the input image, for example, is one pixel in both length and width, the CPU 131 determines that the error exists. The CPU 131 deletes the user input determined to be erroneous based on the size of the rectangular region. In the error determination using the overlapped area of the rectangular regions, the rectangular regions input by the user are only the Bare Arm pattern and the Bare Fork pattern. Accordingly, the CPU 131 performs error check of the determinable level based on the rectangular regions of these two patterns. Specifically, the CPU 131 determines that the error exists if the area in which the rectangular regions of the two patterns are overlapped is greater than or equal to a predetermined threshold value. For example, Intersection over Union (IoU) is exemplified as the index used in the overlapping determination and the CPU 131 determines that the rectangular region input by the user is a human error input if IoU is higher than or equal to 0.3. If the user determines that no non-production region exists in the input image in Step S22 and the user does not input the rectangular region, the CPU 131 determines information indicating that no non-production region exists in the input image in Step S230 as processing by a correct value data generator 96.

In Step S231, the CPU 131 selects only a reliable region, that is, only an available region from the regions estimated as the partial regions in the detection process in Step S21 to hold the selected region. In the example in FIG. 9A, since overlapping of the inconsistent partial regions (rectangular regions) is not detected in the estimated partial regions, all the estimated rectangular regions are selected as the reliable regions in Step S231.

In Step S232, the CPU 131 integrates the result in Step S230 with the result in Step S231. Since the non-production region is not input by the user at this time, the look of the image in FIG. 9A is kept.

In Step S233, the CPU 131 performs filling of a non-detected region, which is not detected as the production region, the non-production region, or the like, with the rectangular region to which an appropriate label is attached based on certain rules. It is assumed in the first embodiment that the following rules R-1 to R-6 are implemented as the certain rules. These rules R-1 to R-6 are made by simply describing the rules actually operated in the actual wine grape farm field for description of the first embodiment.
R-1: The Fork pattern or the Bare Fork pattern is detected above the Trunk pattern.
R-2: The Trunk pattern is detected below the Fork pattern or the Bare Fork pattern.
R-3: The Arm pattern or the Bare Arm pattern is detected at both ends of the Fork pattern or the Bare Fork pattern.
R-4: No pattern is detected above the Fork pattern, the Bare Fork pattern, the Arm pattern, or the Bare Arm pattern.
R-5: No pattern is detected below the Arm pattern or the Bare Arm pattern.
R-6: The rectangular regions of the Fork pattern, the Bare Fork pattern, the Arm pattern, or the Bare Arm pattern are always allocated with no space in the horizontal one-dimensional direction.

In the first embodiment, it is possible to determine the rectangular regions for the non-detected regions in FIG. 9A with reference to the implemented rules R-1 to R-6. In the case of the example in FIG. 9A, since the rectangular region 603 is the trunk although the non-detected region exists above the rectangular region 603, the Fork pattern or the Bare Fork pattern is determined to exist above the rectangular region 603 according to the rule R-1. In addition, since it is determined that the non-production region is not detected above the rectangular region 603 in Step S230, a rectangular region 605 of the Fork pattern is determined to exist above the rectangular region 603, as illustrated in FIG. 9B. When the rectangular region 605 is determined to have the Fork pattern, the region on the left side of the rectangular region 605 is to have the Arm pattern or the Bare Arm pattern according to the rules R-6 and R-3. Furthermore, since these regions are also determined not to be the non-production regions, that is, to be the production regions in Step S230, a rectangular region 604 of the Arm pattern is finally determined to exist. Although the non-detected region is also detected below a rectangular region 602, a rectangular region 606 of the Trunk pattern exists below the rectangular region 602 according to the rule R-2. The dimensions (width and length) of each rectangular region determined based on the rules R-1 to R-6 may be determined to be the dimensions (width and length) inferred from the size of an adjacent rectangular region or may be determined to be the dimensions (width and length) based on the statistical average value of the respective rectangular regions. Generation of correct value data 97 is completed through the above processing.

An example of the processing in Step S23 (Steps S230 to S233) when the user does not input the non-production region in Step S22 as the result of the input of the image including no non-production region is described above.

A case will be described, in which the image including the non-production region is input. Not only the determination of the rectangular region for the non-detected region but also an example in which a region that is falsely detected is modified will be described in this case.

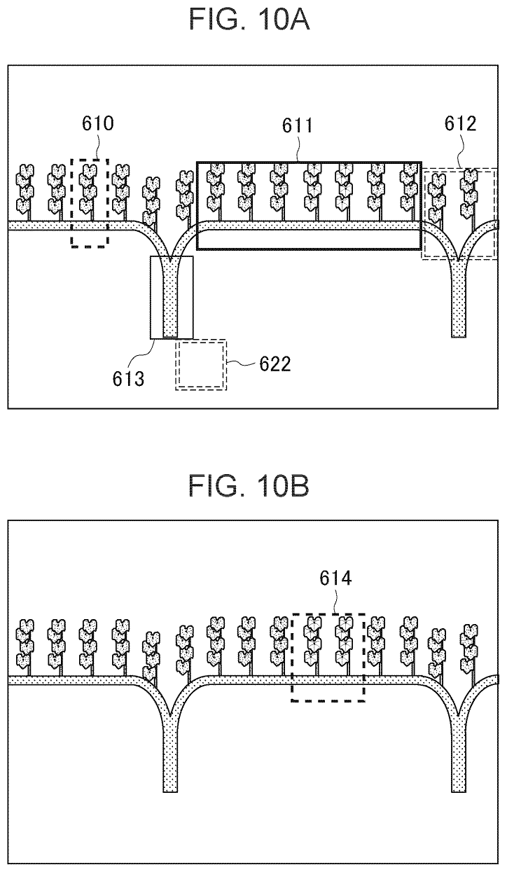

FIG. 10A is a diagram illustrating an example in which the detection of the rectangular regions has been performed for the input image using the learned AI model in Step S21, as in the case described above. It is assumed that a rectangular region 610 illustrated by a broken line in FIG. 10A is determined to have the Bare Arm pattern, and a rectangular region 612 and a rectangular region 622, which are illustrated by double broken lines in FIG. 10A, are determined to have the Bare Fork pattern. It is assumed that a rectangular region 611 illustrated by a bold solid line in FIG. 10A is determined to have the Arm pattern and a rectangular region 613 illustrated by a thin solid line in FIG. 10A is determined to have the Trunk pattern.

In Step S22, the CPU 131 accepts the input of the rectangular region indicating the non-production region from the user. In this case, the user inputs the rectangular region for a portion determined to be the non-production region from the look in FIG. 10A. A rectangular region 614 illustrated by a broken line in FIG. 10B illustrates the rectangular region, which is determined to be the non-production region and is input by the user.

Upon such input of the specification of the non-production region by the user, in Step S230, the CPU 131 performs the simple human error check for the user input in the same manner as described in the cases in FIG. 9A and FIG. 9B. The CPU 131 determines the rectangular region determined not to be the error. In the example in FIG. 10B, only the rectangular region 614 is input by the user and it is assumed that the CPU 131 determines that the rectangular region 614 is not the error.

In Step S231, the CPU 131 deletes the rectangular region determined to be the obvious false detection based on the simple rules, among the rectangular regions detected using the learned AI model. In addition, the CPU 131 determines whether the remaining rectangular regions resulting from the deletion of the falsely-detected rectangular region are matched with the rectangular regions input by the user, which are determined not to be the error in Step S230. For example, a process of leaving only the rectangular region having a higher likelihood in the detection using the learned AI model, when the two rectangular regions of different levels are detected in approximately the same region, one of the two rectangular regions is the production region, and the other of the two rectangular regions is the non-production region, is exemplified as the process of deleting the rectangular region determined to be falsely detected. The determination of whether the rectangular regions are in approximately the same region is performed, for example, using the IoU between the partial regions (the rectangular regions) that are detected. In the case of in FIG. 10A, since the rectangular regions of different levels are not detected in the same region, the CPU 131 selects all the detected rectangular regions in Step S231.

In Step S232, the CPU 131 performs modification or the like of the labels attached to the respective rectangular regions with reference to both the rectangular region input by the user, determined in Step S230, and the rectangular region after the erroneous or falsely-detected region is deleted in Step S231. In the cases in FIG. 10A and FIG. 10B, since the rectangular regions 610, 612, and 622 detected using the learned AI model are obviously falsely detected because of the rectangular region 614, which is the non-production region, determined by the user input in Step S230, the labels of the rectangular regions 610, 612, and 622 are modified. For example, since the rectangular region 614, which is the non-production region, determined by the user input, is included in the rectangular region 611 in FIG. 10A but the rectangular region 611 is detected as the production region of the Arm pattern, the shape of the rectangular region 611 is obviously false. Such false detection is caused by, for example, adjacence of the production region to the non-production region in a feature space because the image pattern of the production region is very similar to the image pattern of the non-production region and a false label may be attached due to this. When the false label is attached in the above manner, the CPU 131 modifies the label.

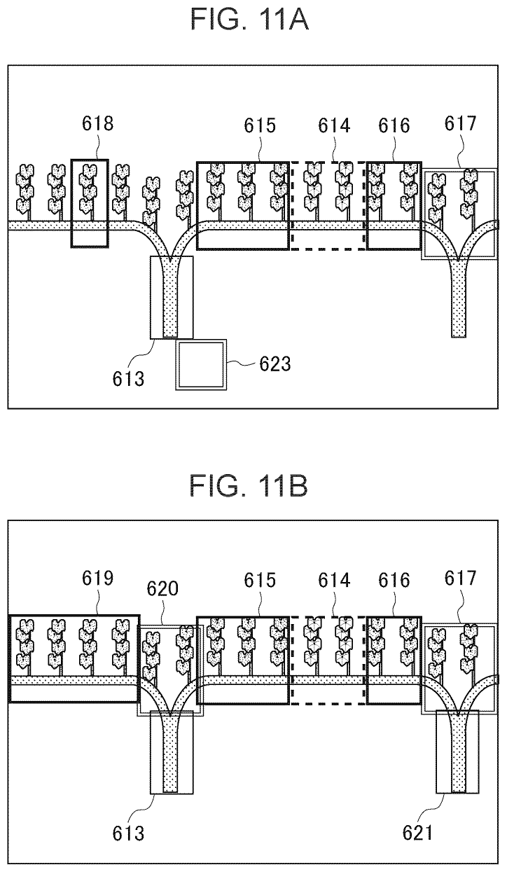

FIG. 11A is a diagram illustrating the result after the CPU 131 has modified the rectangular regions 610, 612, and 622 detected in the learned AI model, which are illustrated in FIG. 10A, with reference to the label of the rectangular region input by the user in Step S232. As illustrated in FIG. 11A, the label of the rectangular region 610 in FIG. 10A is modified to the Arm pattern to be converted into a rectangular region 618 illustrated by a bold solid line in FIG. 11A. The labels of the rectangular region 612 and the rectangular region 622 in FIG. 10A are modified to the Fork pattern to be converted into a rectangular region 617 and a rectangular region 623, illustrated by double solid lines in FIG. 11A. The rectangular region 611 of the Arm pattern in FIG. 10A is divided by a rectangular region 614 input by the user and a rectangular region 615 and a rectangular region 616, which are the production regions, are newly added as the regions of the Arm pattern.

Since the non-detected region and the falsely-detected region may be included at this time, the CPU 131 deletes the rectangular region falsely detected in Step S233. Specifically, the CPU 131 deletes the rectangular region 623 in FIG. 11A, which is against the rule R-4. In addition, the CPU 131 fills the non-detected region with the rectangular region inferred from the current rectangular region according to the rule R-6, as in the example in FIG. 9B. For example, the Fork pattern or the Bare Fork pattern is to exist above the Trunk pattern of the rectangular region 613 according to the rule R-1. Since the non-production region is not input by the user, the region above the Trunk pattern of the rectangular region 613 is to be the production region. Accordingly, the region above the rectangular region 613 is filled with a rectangular region 620 of the Fork pattern. Since the region below the rectangular region 617 is to have the Trunk pattern, the region below the rectangular region 617 is filled with a rectangular region 621 of the Trunk pattern. The rectangular region 620 has the Fork pattern and the region on the left side of the rectangular region 620 is to have the Arm pattern or the Bare Arm pattern according to the rule R-3. However, since the rectangular region 618 is determined in the label modification process described above, a rectangular region 619 is determined to be a rectangular region of the Arm pattern. Since the rectangular region 618 at this time has the same label as that of the rectangular region 619, the rectangular region 618 is included in the rectangular region 619 to be deleted. The respective rectangular regions illustrated in FIG. 11B are finally determined through the above processing.

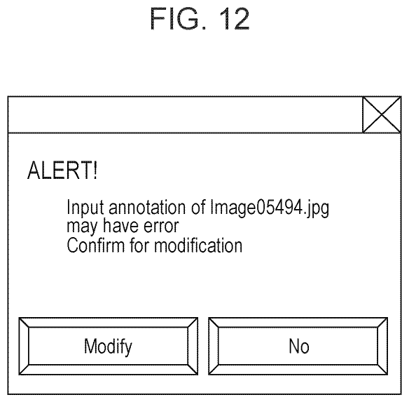

Step S233 include a process of further modifying the error of the rectangular regions determined at this time. For example, there is a case in which the rectangular region input by the user, determined in Step S230, is determined to be false. In this case, the CPU 131 creates an alert screen illustrated as an example in FIG. 12 and displays the alert screen in the display unit 137 to notify the user that the rectangular region input by the user may be possibly false or to automatically modify the rectangular region input by the user.

The generation of the correct value data 97 for the image including the non-production region is completed through the processing described above.

According to the first embodiment, as described above, if the rectangular regions have been detected to some extent in Step S21, the respective rectangular regions are capable of being integrated from information describing in advance the relationship between the detected rectangles using the rectangular region input by the user in Step S22. In other words, the CPU 131 is capable of generating the correct value data with high reliability by performing Step S23 (Steps S230 to S233).

Step S21 and Step S22 are concurrently performed in FIG. 5. This is because showing the output result in Step S21 to the user may influence the user input in Step S22.

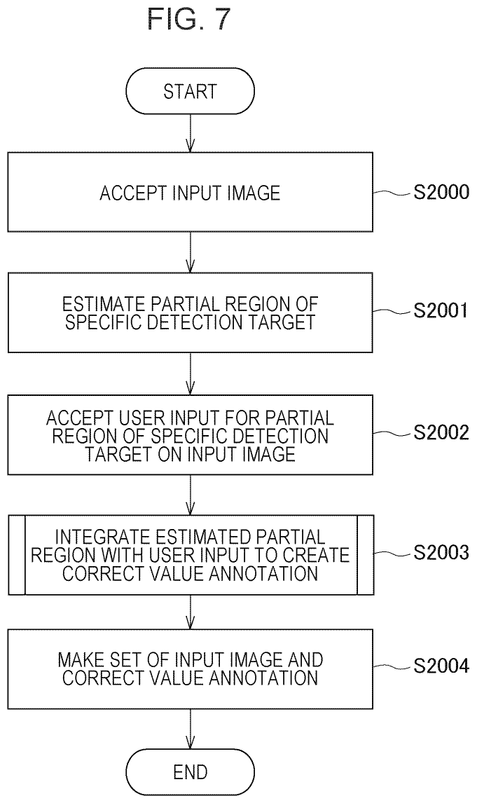

A flowchart illustrated in FIG. 7 may be performed as another variation of the information processing in the first embodiment. In the flowchart in FIG. 7, Step S2000 is the step having the same content as that of Step S20, Step S2001 is the step having the same content as that of Step S21, Step S2003 is the step having the same content as that of Step S23, and Step S2004 is the step having the same content as that of Step S24. However, in the flowchart in FIG. 7, Step S2002 differs from Step S22 in that the user is capable of viewing the rectangular region detected in Step S2001. Performing the process in the flowchart in FIG. 7, in which the user views the rectangular region that is automatically detected, instead of the process in the flowchart in FIG. 5, has the advantage of expecting an effect of reducing the operation cost in the input of the rectangular region by the user.

In the information processing described in the first embodiment, the partial region is detected from the input image using the learned AI model that is prepared in advance and the portion that is not correctly detected using the learned AI model is resolved using the rule-based method with reference to the determination by the user. When the target is the agricultural crop plant exemplified in the first embodiment, the look of the agricultural crop plant is greatly varied depending on the shooting time and the shooting condition. Accordingly, to achieve the result with high detection (estimation) accuracy, it is necessary to prepare the learned AI model that has performed the learning using a substantial number of images. What condition of images and how many images are required to achieve the stable detection (estimation) accuracy is not clear in advance. In addition, the knowledges to be learned from the images are the patterns in the rectangular regions to be taught and the relationship of arrangement between the rectangular regions. Although a learning image required to stabilize the detection of the patterns in the rectangular regions to be taught, among the above two knowledges, is not clear, the relationship of arrangement between the rectangular regions is frequently capable of being described as the rules in advance. Accordingly, it is considered that describing the relationship of arrangement between the rectangular regions as the rules in advance enables the AI model with high performance to be created quickly, compared with the learning using a massive number of images. Consequently, a method of implementing the latter rules in advance to acquire the AI model with low cost is used in the first embodiment. In other words, according to the first embodiment, it is possible to acquire the information required to learn the insufficient information with low cost even when the it is difficult to perform the processing with the information that has been collected in the past or when the insufficient information has been collected in the past.

Although all the detected regions are described as the rectangular regions in the first embodiment, the detected regions are not limited to the rectangular regions. The detected region may be, for example, a circular region defined only by the radius, the X coordinate, and the Y coordinate or a region that derives from an arbitrary heat map and that has an arbitrary largeness higher than or equal to a specific threshold value, instead of the rectangle.

Although the AI model according to the first embodiment is described on the assumption that the AI model is learned with the deep learning-mechanical learning, any method may be adopted as long as the image pattern concerning the detection target is capable of being detected and identified. For example, the acquisition of the detector (estimator) is capable of being achieved with various identification techniques, such as fuzzy inference, genetic algorithm, or rules artificially defined with various parameters.

Although the wine grape trees are exemplified for description in the first embodiment, the target is not limited to the wine grape trees. The handling method according to the first embodiment is effective for all the targets having any rule in the relationship of arrangement between the rectangular regions to be detected.

### Second Embodiment

A second embodiment will now be described. The example is described in the first embodiment, in which Step S233 is performed based on the arrangement rules (rules) implemented in advance. An example is described in the second embodiment, in which Step S233 is performed with the detector (estimator) acquired through the learning, instead of using the arrangement rules (rules) implemented in advance. Since the hardware configuration, the functional configuration, and so on in the second embodiment are the same as those in the first embodiment described above, illustration and description of the hardware configuration, the functional configuration, and so on are omitted and only the learning portion different from the first embodiment will be described.

Although the case is described in the first embodiment, in which the arrangement rules of the rectangular regions, which are described as the rules R-1 to R-6, are implemented in advance, division into many cases may practically occur depending on the target and the rules may be complicated. Accordingly, it is considered that, if the same effect is achieved through the learning, the inconvenience of preparing and implementing the complex rules in advance is capable of being avoided.

The target to be learned in the second embodiment is the relationship between the partial regions (the rectangular regions), which are the targets to be detected. In other words, in the second embodiment, the learning is supposed, in which the true relationship of arrangement of the rectangular regions to be detected is inferred from the arrangement of the rectangular regions, which is made so as to include the error. An example is described in the second embodiment, in which the targets to be learned are the correct value data and data lacking part of the rectangular regions and/or data including the falsely detected rectangle and the problem of estimating the correct value data from the set of the rectangular regions is learned. In the second embodiment, the estimator acquired through the learning described below is referred to as a “region estimator” for distinction in order to avoid confusion with a “detector that detects the non-production region from the captured image”. The region estimator in the second embodiment is acquired through the learning using the data about the partial regions corresponding to the format detected in the learned AI model described above. In the second embodiment, the learning data is generated and learned using the “region estimator” with low cost to enable the acquisition of the “detector that detects the non-production region from the captured image”. According to the second embodiment, since only the data about the arrangement of the rectangular regions is acquired, it is possible to efficiently perform the detection of the rectangular regions with low cost and with high accuracy, compared with the case in which the image is newly acquired.

A method of acquiring the detector (estimator) in Step S233 through the learning will be described in the second embodiment.

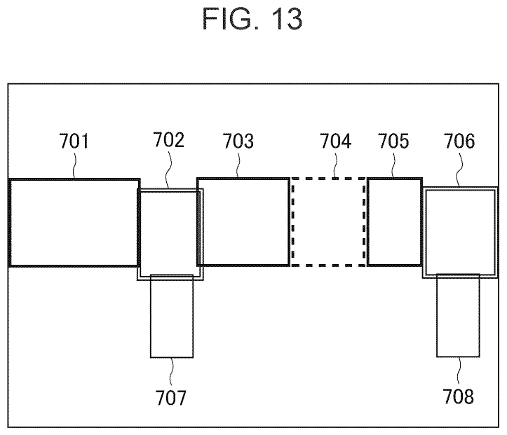

For example, it is assumed that 1,000 sets of learning data generated for the learning of the learned AI model used in Step S21 exist and the learning data sets are composed of 1,000 images and 1,000 pieces of annotation data. In the second embodiment, a data set only including the annotation, excluding the images, is prepared from the 1,000 sets of data. If one of the data sets includes rectangular regions 701 to 708 illustrated in FIG. 13, the information processing apparatus 13 of the second embodiment generates the learning data set including only the rectangular regions based on the rectangular regions 701 to 708. It is not necessary to newly fill the non-production region in the second embodiment. In addition, in the second embodiment, it is not necessary to learn the output pattern of the rectangular region concerning the non-production region because the rectangular coordinate of the non-production region has been determined.

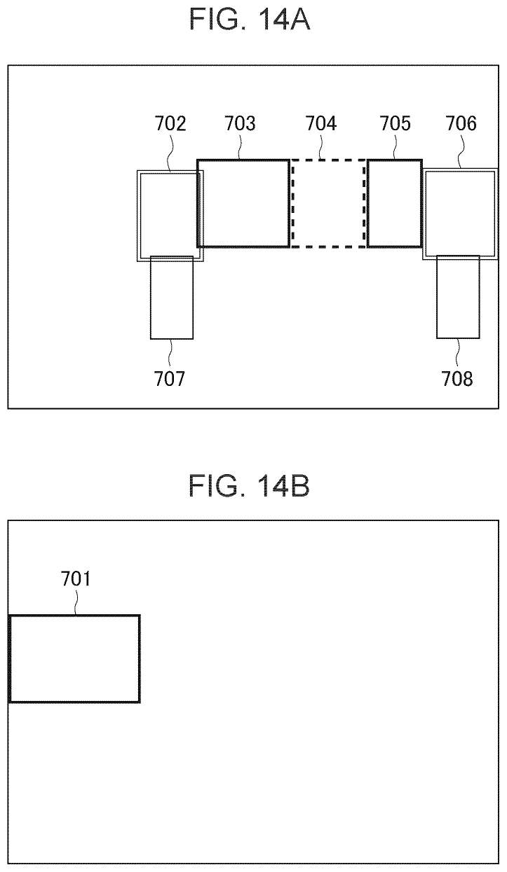

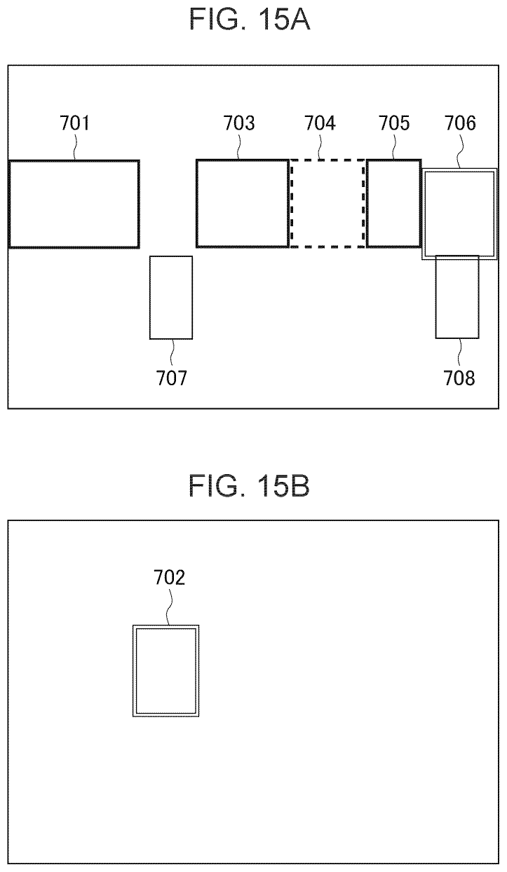

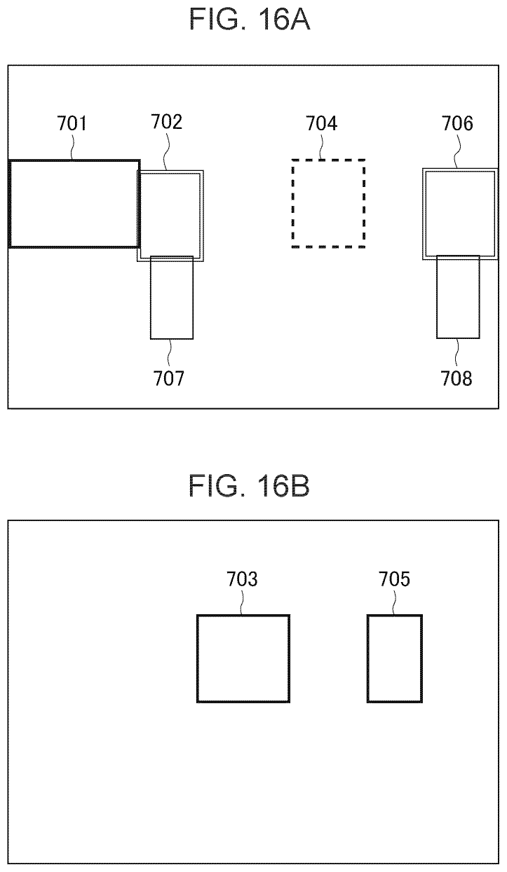

Accordingly, a case will be considered here, in which data only including the rectangular regions 702 to 708 in FIG. 14A is generated as the annotation data from which, for example, the rectangular region 701 is deleted from FIG. 13. At this time, data only including the rectangular region 701, illustrated in FIG. 14B, is concurrently generated from the rectangular region 701 deleted from FIG. 13. In the second embodiment, upon input of the data in FIG. 14A, the learning data for resolving the problem to estimate the deleted rectangular region, such as the estimation of the data in FIG. 14B, is generated. Similarly, the rectangular region 702 is deleted from FIG. 13, data in FIG. 15A is generated, and data only including the deleted rectangular region 702 in FIG. 15B is concurrently generated to generate a data set for estimating the rectangular region in FIG. 15B upon input of FIG. 15A. The number of the rectangular region to be deleted is not limited to one. For example, the two rectangular regions: the rectangular region 703 and the rectangular region 705 may be deleted from FIG. 13 to generate data in FIG. 16A, thus generating the learning data for estimating FIG. 16B. The number of the rectangular regions to be deleted is desirably appropriately determined in accordance with the challenge to be resolved. When the case in which the number of the rectangular regions to be deleted in the learning data set is zero is included, the data in FIG. 13 may be directly input and the data to be estimated may be data with no rectangular region.

Although the method of automatically generating the learning data for acquiring the “region estimator” detecting the rectangular region that is not detected is exemplified in the above example, a case in which the “region estimator” for suppressing the false detection of the rectangular region is learned is also capable of being realized using the same method.

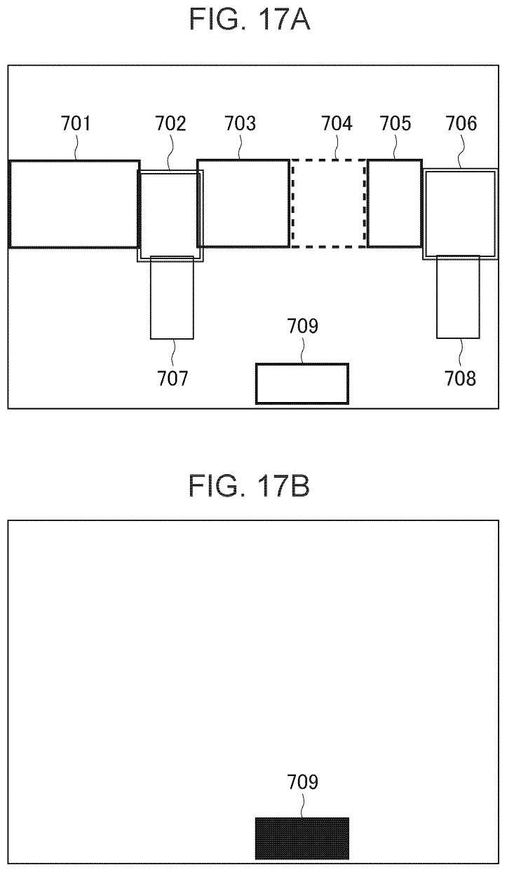

For example, among the rectangular regions 701 to 709 illustrated in FIG. 17A, the rectangular region, such as the rectangular region 709, of a random label may be added to a random position different from those of the rectangular regions 701 to 708 illustrated in FIG. 13 to generate the falsely-detected rectangular region. The rectangular region 709 to which the false detection label is attached is generated as the correct value data for this case, as illustrated in FIG. 17B, and a pair of FIG. 17A and FIG. 17B is made to enable the learning of the “region estimator” for detecting the false rectangular region. Any number of sets of the falsely-detected rectangular regions to be detected through the above procedure may be made for learning.

As the method of generating the learning data set for learning the “region estimator” modifying false determination of the detected rectangular region, a method of rewriting the label of the rectangular region selected at random from the correct value label illustrated in FIG. 13 to a random label different from the original label to generate the learning data set is also considered.

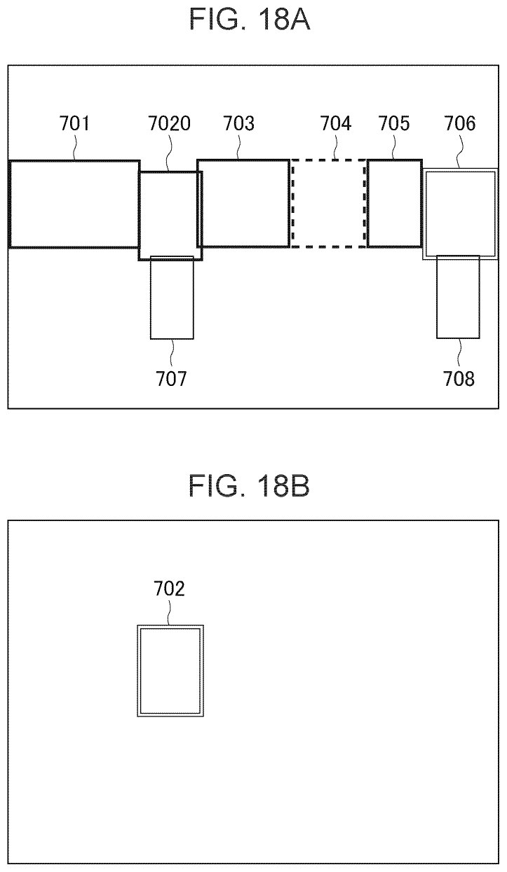

FIG. 18A illustrates an example in which the label of the rectangular region 702 of the Fork pattern is rewritten to the false label of the Arm pattern to make a rectangular region 7020. FIG. 18B is a diagram only illustrating the rectangular region 702 having the original correct label. In learning of the “region estimator” modifying the false determination of the rectangular region, the learning data set of the data including the rectangular region 7020 having the false label in FIG. 18A and the data in FIG. 18B in which only the rectangular region 702 having the original correct label is described is generated. How many rectangular regions having the false labels are to be generated using the same method can be appropriately selected depending on the kind of the challenge.

As described above, many rectangular region data sets capable of learning the AI model supporting the non-detection, the false detection, and the false determination are generated in the second embodiment. The “region estimators” performing the learning using the learning data sets may be different identifiers or may be one identifier.

Also in the second embodiment, the process of further modifying the error of the rectangular regions that are determined at this time is included in Step S233, as in the first embodiment. For example, if the rectangular region input by the user, which is determined in Step S230, is determined to be false, the CPU 131 may display an alert screen similar to that in FIG. 12 to notify the user that the rectangular region input by the user may be possibly false or to automatically modify the rectangular region input by the user.

In order to acquire the “region estimator” capable of learning and estimating the variety of learning data generated in the above manner, the data set resulting from imaging of the data set for input only including the rectangular regions by allocating a specific luminance value to each label may be used. In this example, the learning is performed in which a combination image of the rectangular regions of the respective luminance values is input to estimate the deleted rectangular region from the combination image. As a result, a massive number of data sets are capable of being generated from the only 1,000 sets of data.

In the generation of the learning data set only including the rectangular regions, the example is described in the second embodiment, in which the rectangular region is deleted at random or is added at random, or the label of the rectangular region is rewritten at random using the existing correct value annotation data set. The method of generating the learning data set is not limited to the method performing the deletion, the addition, or the rewriting at random. For example, the learning data set may be generated using the data that is not detected, the data that is falsely detected, or the data the label of which is falsely determined by the identifier when the detection is actually performed for the image making the set with the existing correct value annotation data.

According to the second embodiment, using only the combination of the rectangular regions excluding the input image as the input data in the learning enables new acquisition of a variation image required as the input image to be suppressed to greatly reduce the complexity of the challenge. For example, in the learning using the input image, overfitting to the learning data is likely to occur due to the complexity of the challenge to be resolved and the number of the collected images and a massive number of processes is required to collect the learning images of a required number and perform the sufficient annotation. In contrast, according to the second embodiment, the “region estimator” that has learned the components on the left, the right, the top, and the bottom of the rectangular region is capable of being acquired with low cost, for example, even if the breed, the amount of leaves, and/or the growth stage of the target plant or the like is varied to greatly vary the look on the image. In other words, according to the second embodiment, since the “region estimator” estimating the correct rectangle set only from the rectangular regions is capable of being acquired, automatic annotation capable of handling a new input image is enabled. Accordingly, according to the second embodiment, it is possible to greatly reduce the final cost of generating the learning data required for performing object identification from the input image.

Although all the detected regions are described as the rectangular regions also in the second embodiment, the detected regions are not limited to the rectangles. As described above in the first embodiment, the detected region may be a circular region defined only by the radius, the X coordinate, and the Y coordinate or a region that derives from an arbitrary heat map and that has an arbitrary largeness higher than or equal to a specific threshold value. Any method may be adopted as the learning model as long as the image pattern concerning the detected region is capable of being detected and identified. For example, the acquisition of the detector is capable of being achieved with various identification techniques, such as fuzzy inference, genetic algorithm, or rules artificially defined with various parameters.

### Third Embodiment

The method for improving the performance of the AI model when the learning in the learned AI model used in the detection process is insufficient in Step S21 is described in the first and second embodiments. In other words, the method of correcting the AI model for supporting a non-learned case to generate the learning data improving the performance of the AI model is described because, although the correct detection is performed to a certain level, the non-detection, the false detection, or the false determination may occur if the non-learned case or the like is input. In contrast, an example is described in a third embodiment, in which the learning data that is newly learned is added to the learned model that is prepared in advance. Since the hardware configuration and the functional configuration in the third embodiment are the same as those in the embodiments described above, illustration and description of the hardware configuration and the functional configuration are omitted and only the learning portion different from the first embodiment will be described.

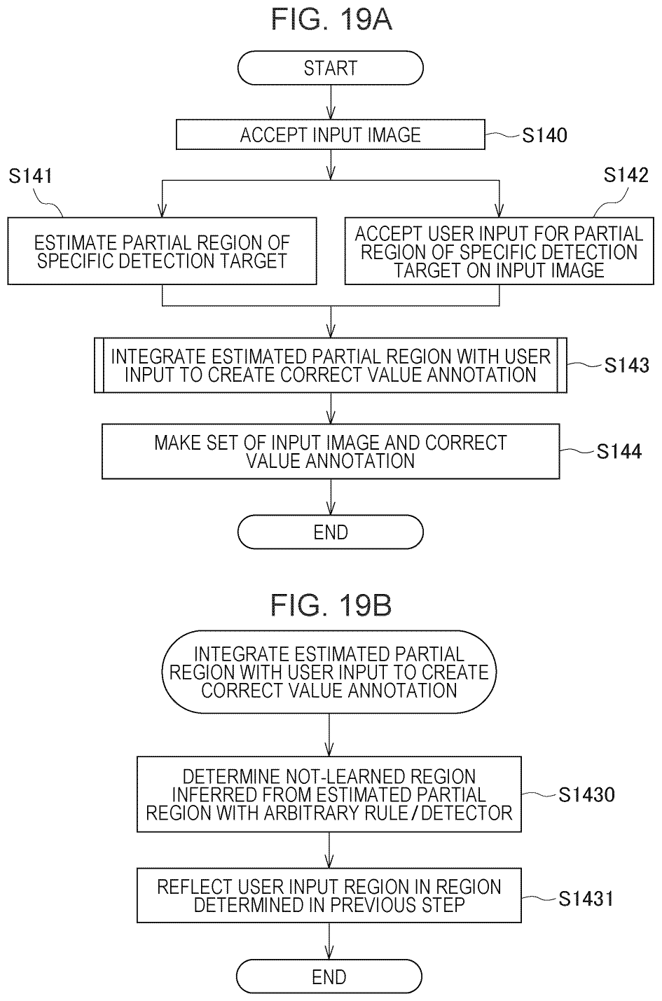

FIG. 19A is a flowchart illustrating the flow of the information processing in the information processing apparatus 13. FIG. 19B is a flowchart illustrating Step S143 in FIG. 19A in detail. It is assumed that the AI model used in Step S141 in the flowchart in FIG. 19A is the learned AI model that is pre-learned for another purpose and, in the third embodiment, is the learned AI model described in the first and second embodiments. However, since a case is exemplified in the third embodiment in which appearance check of industrial products is performed, as described below, the learned AI model in the third embodiment is the AI model that is pre-learned for the appearance check of the industrial products. In the generation of the learning data to be added in the third embodiment, although the learned AI model itself used in Step S141 may be used, it is basically supposed that the AI model different from the learned AI model that is prepared in advance is generated. In addition, although the detector in Step S141 is a region-based convolutional neural networks (R-CNN), the detector using the learning data finally generated in Step S144 may be a different identifier, such as a single shot detector (SSD). In other words, in the third embodiment, the identifier appropriate for the complexity of each challenge may be selected and used, among the various identifiers.

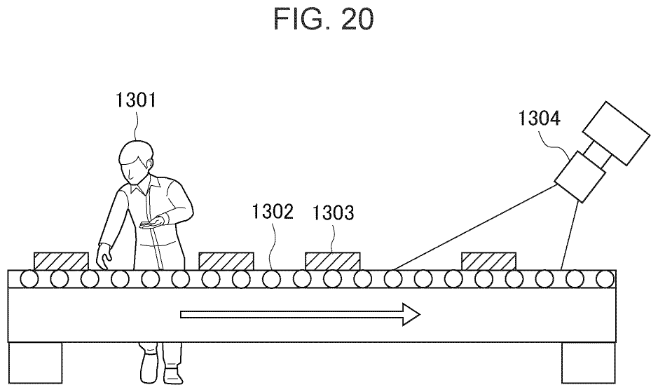

An example is described in the third embodiment, in which a component 1303 during manufacturing is conveyed on a belt conveyor 1302 illustrated in FIG. 20 and shooting by a camera 1304 is performed as an appearance check process of the component 1303 to detect the abnormal region on the appearance from the image captured by the camera 1304. In the example in FIG. 20, an operation is imaged in which a worker 1301 picks up the component 1303, finishes an operation to assemble specific components to the component 1303 within a predetermined time, and places the component 1303 to which specific components are assembled on the belt conveyor 1302. The appearance check is performed using the image resulting from shooting of the component 1303 to which specific components are assembled.

In the third embodiment, the camera 1304 corresponds to the camera 10 in FIG. 1. In other words, the image captured by the camera 1304 is transmitted to the cloud server 12 and the information processing apparatus 13 via the communication network 11, such as the LAN or the Internet, as illustrated in FIG. 1. Since the relationship of input and output of the data, the user operation, and so on are approximately the same as those in the above embodiments, description of them is omitted herein. The worker 1301 assembles specific components to the component 1303 and, then, returns the component 1303 on the belt conveyor 1302. At this time, it is sufficient for the detection face on which the appearance check is performed to face upward and the orientations other than that of the detection face are freely determined to some extent. In other words, the angle or the like when the component 1303 to which specific components are assembled is shot by the camera 1304 is not fixed. In the appearance check, it is determined whether necessary parts are assembled to specific portions, whether stamping and the like are normally performed, whether any stain or flaw exists, and so on.

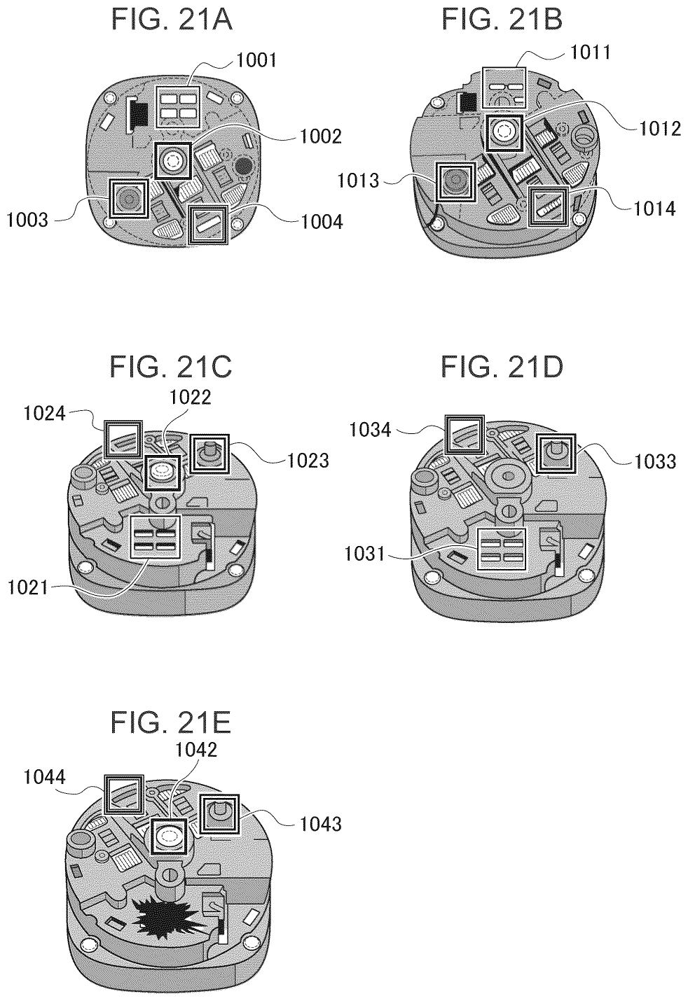

FIG. 21A to FIG. 21E are examples of images having different looks when the component 1303 to be inspected, which is placed on the belt conveyor 1302 after components are assembled by the worker 1301, is shot by the camera 1304 at different angles. In addition, the inspection is supposed to be performed at four portions on the component 1303 to be inspected and the four portions are hereinafter referred to as inspection regions a, b, c, and d. The inspection region a corresponds to a rectangular region 1001 in an example of the image in FIG. 21A, corresponds to a rectangular region 1011 in FIG. 21B, corresponds to a rectangular region 1021 in FIG. 21C, and corresponds to a rectangular region 1031 in FIG. 21D. However, the rectangular region corresponding to the inspection region a is not seen due to the stain or the like in FIG. 21E. Similarly, the inspection region b corresponds to a rectangular region 1002 in FIG. 21A, corresponds to a rectangular region 1012 in FIG. 21B, corresponds to a rectangular region 1022 in FIG. 21C, and corresponds to a rectangular region 1042 in FIG. 21E. However, no component to be assembled to the portion corresponding to the inspection region b exists in FIG. 21D. The inspection region c corresponds to a rectangular region 1003 in FIG. 21A, corresponds to a rectangular region 1013 in FIG. 21B, corresponds to a rectangular region 1023 in FIG. 21C, corresponds to a rectangular region 1033 in FIG. 21D, and corresponding to a rectangular region 1043 in FIG. 21E. The inspection region d corresponds to a rectangular region 1004 in FIG. 21A, corresponds to a rectangular region 1014 in FIG. 21B, corresponds to a rectangular region 1024 in FIG. 21C, corresponds to a rectangular region 1034 in FIG. 21D, and corresponding to a rectangular region 1044 in FIG. 21E. In the appearance check, it is required to correctly detect the respective rectangular regions corresponding to the inspection regions a, b, c, and d in all the cases in FIG. 21A to FIG. 21E.

When the appearance check process is performed using the learned AI model that is pre-learned, the many images at all the varied shooting angles are collected in advance for the non-defective target components in the normal state and the annotation of the four inspection targets is performed in the respective images. If a large amount of varied learning of the normal state of the regions of the respective inspection targets has been completed, it is possible to accurately and stably perform the determination of whether the respective regions are in the normal state in the actual appearance check process. If no assembly, assembly error, poor stamping, stain, or flaw exits, any of the four inspection regions is not detected and it is determined that abnormality occurs in the appearance check.

FIG. 21D and FIG. 21E illustrate examples of two appearance abnormality states to be detected. Specifically, in the case of FIG. 21D, since the component to be assembled in the normal product does not exist in the portion corresponding to the inspection region b although the inspection regions a, c, and d are detected as the rectangular region 1031, 1033, and 1034, respectively, the rectangular region is not detected in the portion corresponding to the inspection region b. Accordingly, the component in FIG. 21D is determined to be the product having the abnormal appearance. In the case of FIG. 21E, the portion corresponding to the inspection region a is not detected because of the stain although the inspection regions b, c, and d are detected as the rectangular region 1042, 1043, and 1044, respectively. Accordingly, the component in FIG. 21E is also determined to be the product having the abnormal appearance because all the four rectangular regions to be detected are not detected. In the third embodiment, in the appearance check process of the assembled component illustrated in FIG. 21A to FIG. 21E, it is assumed that the AI model having the performance enabling the appearance check with sufficient accuracy has been acquired through the pre-learning even when the images of the components shot at the various angles are input.

In the third embodiment, the manufacturing process of the production line described above is revised. Specifically, it is assumed that the appearance check process for the assembled component illustrated in FIG. 21A to FIG. 21E is abolished and the manufacturing process is changed to a process of performing the appearance check after other components are further assembled to the assembled component.

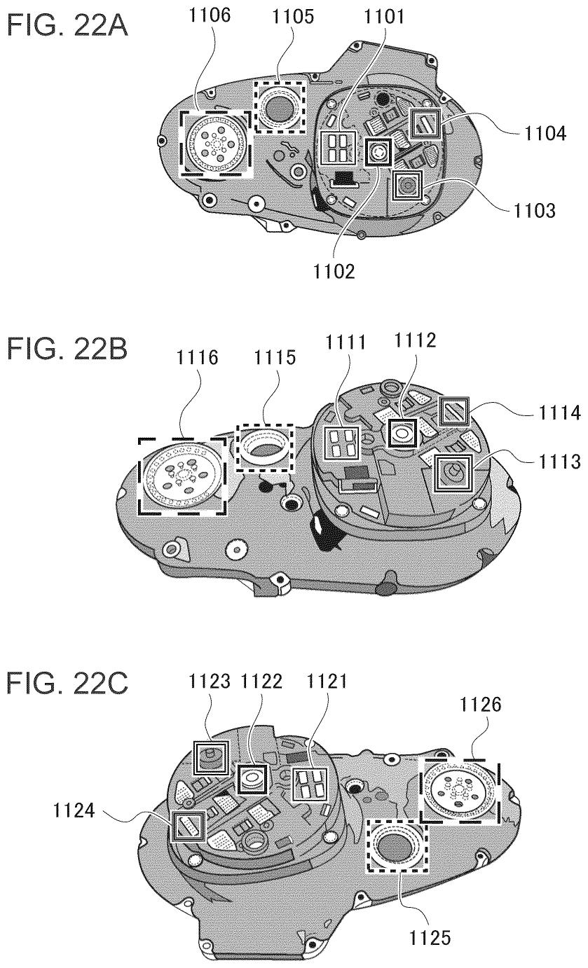

FIG. 22A to FIG. 22C are diagrams illustrating the states after other components are further assembled to the assembled component illustrated in FIG. 21A to FIG. 21E. FIG. 22A to FIG. 22C illustrate examples of images having different looks when the component to which the other components are assembled is shot by the camera 1304 at different angles. In the appearance check for the component to which the other components are assembled, the six target regions are to be detected. Specifically, the appearance check is performed for other two target regions, in addition to the four target regions described above with reference to FIG. 21A to FIG. 21E, and the six regions are the inspection target regions. In the cases of FIG. 22A to FIG. 22C, the inspection region a corresponds to rectangular regions 1101, 1111, and 1121, the inspection region b corresponds to rectangular regions 1102, 1112, and 1122, the inspection region c corresponds to rectangular regions 1103, 1113, and 1123, and the inspection region d corresponds to rectangular regions 1104, 1114, and 1124. When the two new inspection regions are referred to as inspection regions e and f in FIG. 22A to FIG. 22C, the inspection region e corresponds to rectangular regions 1105, 1115, and 1125, and the inspection region f corresponds to rectangular regions 1106, 1116, and 1126 in the examples of the images in FIG. 22A to FIG. 22C.

In the information processing apparatus 13 of the third embodiment, it is assumed that the learned AI model for inspection for the component in FIG. 21A to FIG. 21E is held while the AI model capable of detecting the inspection region e and the inspection region f in the component to which the other components are assembled in FIG. 22A to FIG. 22C after the manufacturing process is revised is not learned. In this case, it is not possible to perform the appearance check through a process of collectively detecting the six inspection regions. Although, normally, a set of the images for learning the six inspection regions and the correct value data to which the coordinate of each inspection region is added is collected and the AI model for learning the relationship between the images and the correct value data is newly acquired, this increases the cost.

Accordingly, in the third embodiment, the processes in the flowcharts in FIG. 19A and FIG. 19B are performed in the information processing apparatus 13 to realize the generation of the annotation data at minimized cost.

First, to generate the correct value data, it is necessary to collect the data in a condition similar to that in the normal appearance check. In the third embodiment, in order to acquire the images shot in the same shooting condition as in the appearance check for learning, the component to which the other components are assembled, illustrated in FIG. 22A to FIG. 22C, is actually conveyed on the belt conveyor 1302 in FIG. 20 for shooting. Although generating the correct value data from nothing involves a significant cost, it is possible to detect the four inspection regions of the assembled component in FIG. 21A to FIG. 21E using the learned AI model with stable high accuracy. In addition, since the geometrical arrangement of the respective partial regions (the respective components) on the component is known, it is possible to infer the arrangement of the two inspection regions that are not learned, with respect to the four inspection regions.

Accordingly, in the third embodiment, geometrical information describing the relationship of arrangement on the coordinate between the inspection regions a, b, c, and d that has been detected using the learned AI model and the inspection regions e and f to be newly added is prepared to identify the positions of the inspection regions e and f that are not learned based on the geometrical information. In other words, a code for each piece of geometrical information, in which the rule concerning the relationship of arrangement on the coordinate between the inspection regions a, b, c, and d and the inspection regions e and f is described, is implemented in the third embodiment. This enables the six inspection target regions to be handled.

In the third embodiment, referring to FIG. 19A, in Step S140, the CPU 131 accepts the input image 91 from the camera 1304.

In Step S141, the CPU 131 detects the four rectangular regions corresponding to the inspection regions a, b, c, and d described above from the captured image. The detection performance of the rectangular regions corresponding to the four inspection regions a, b, c, and d is considered to be sufficiently high because the learned AI model actually operated in the appearance check described with reference to FIG. 21A to FIG. 21E is used.

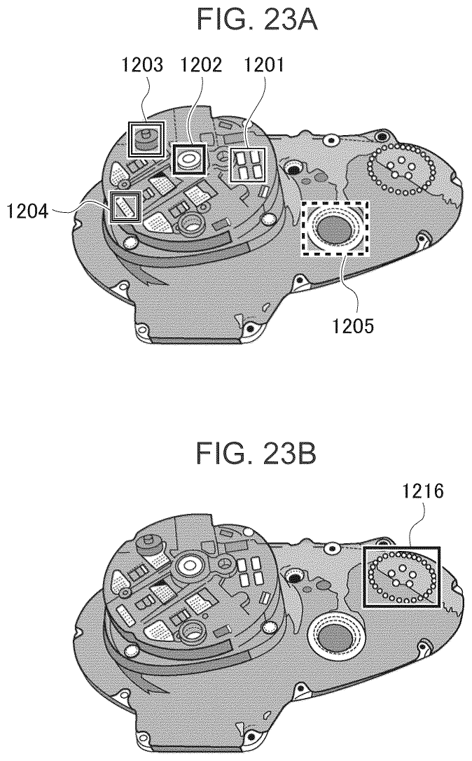

Assembly failure is exemplified as one case to be determined to be appearance abnormality (appearance check failure). For example, FIG. 23A is an example of the image resulting from shooting of the component in the same condition as the angle illustrated in FIG. 22C. Rectangular regions 1201 to 1204 illustrated in FIG. 23A are the rectangular regions corresponding to the four inspection regions a, b, c, and d, respectively. A rectangular region 1205 in FIG. 23A is the rectangular region corresponding to the rectangular region 1125 in FIG. 22C. In the example in FIG. 23A, since the component to be assembled to the rectangular region 1126 in FIG. 22C does not exist, it is determined to be the appearance abnormality in the appearance check. In order to prevent false determination of the appearance abnormal region as the normal pattern of the rectangular region, it is necessary to perform the annotation for the appearance abnormal region.

In Step S142, the CPU 131 accepts input of the annotation data 95 about the partial region from the user as the processing in the annotation acceptor 94. At this time, the CPU 131 displays a captured image illustrated in FIG. 23B on a GUI screen capable of accepting input of the rectangular region from the user. Upon input of a rectangular region 1216 from the user on the screen, the annotation acceptor 94 in the CPU 131 accepts the rectangular region as the appearance abnormal region.

Since the user inputs no rectangular region (or inputs absence of the abnormal region) when the user determines that no abnormal region exists, in Step S142, the CPU 131 records a history indicating that the image has been viewed. If the user does not input the rectangular region for the appearance abnormality, in Step S1430 in FIG. 19B in Step S143, the CPU 131 detects the two remaining regions inferred from the detected rectangular regions, as the processing in the correct value data generator 96.

The following method is available as the simplest method when the detection process in Step S1430 is performed. For example, it is assumed here that the captured image includes no appearance abnormal region and the four rectangular regions corresponding to the inspection regions a, b, c, and d have been detected. In this case, the CPU 131 determines the positions of the remaining regions from the positional relationship between the four detected rectangular regions with reference to the codes of the geometrical information describing discrete orientations for determining the two remaining non-detected inspection regions e and f.

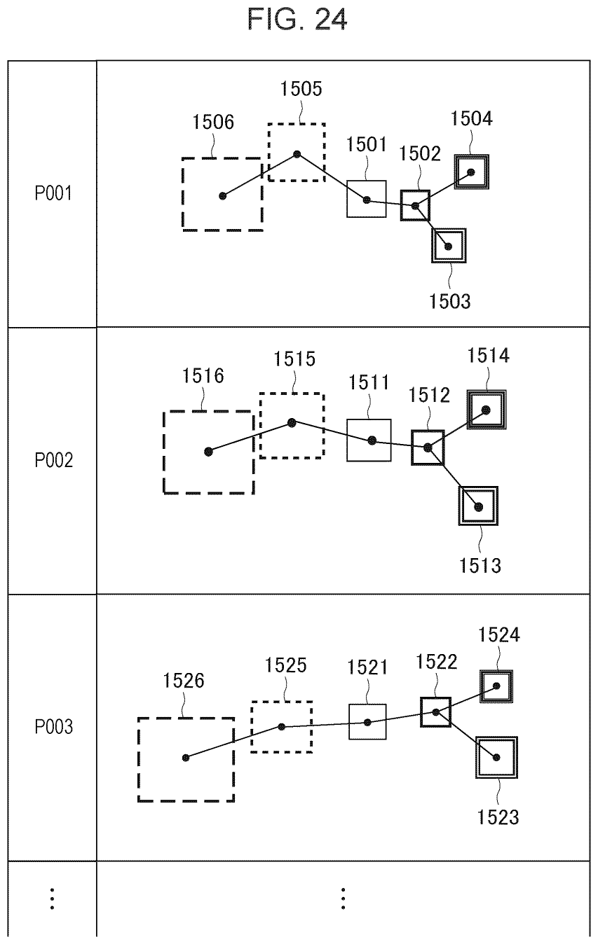

In the third embodiment, the codes of the geometrical information describing the discrete orientations for determining the two remaining inspection regions e and f from the positional relationship between the four detected rectangular regions are stored in a tabular format, like codes P001, P002, P003, . . . in FIG. 24. Rectangular regions 1501, 1511, and 1521 in FIG. 24 correspond to detected rectangular regions (the rectangular regions 1101, 1111, and 1121 in FIG. 22A to FIG. 22C, respectively) detected as the inspection region a. Similarly, rectangular region 1502, 1512, and 1522 correspond to detected rectangular regions (the rectangular regions 1102, 1112, and 1122 in FIG. 22A to FIG. 22C, respectively) detected as the inspection region b. Similarly, rectangular region 1503, 1513, and 1523 correspond to detected rectangular regions (the rectangular regions 1103, 1113, and 1123 in FIG. 22A to FIG. 22C, respectively) in the inspection region c and rectangular region 1504, 1514, and 1524 correspond to detected rectangular regions (the rectangular regions 1104, 1114, and 1124 in FIG. 22A to FIG. 22C, respectively) in the inspection region d. Rectangular region 1505, 1515, and 1525 in FIG. 24 correspond to detected rectangular regions (the rectangular regions 1105, 1115, and 1125 in FIG. 22A to FIG. 22C, respectively) in the inspection region e and rectangular region 1506, 1516, and 1526 correspond to detected rectangular regions (the rectangular regions 1106, 1116, and 1126 in FIG. 22A to FIG. 22C, respectively) in the inspection region f.

The CPU 131 normalizes the distances between all the detected rectangular regions so that, for example, the distance between the detected rectangular regions of the inspection regions a and b is constantly one. In addition, the CPU 131 calculates the coordinates on a two-dimensional plane of the respective detected rectangular regions of the inspection regions c and d, for example, when it is assumed that the center point of the detected rectangular region of the inspection region a is set as the origin and the detected rectangular region of the inspection region b is a coordinate (1,0) on the X axis. The CPU 131 identifies the pattern in which the detected rectangular region of the inspection region c is closest to the detected rectangular region of the inspection region d from the codes in the tabular format in FIG. 24.

In the third embodiment, the CPU 131 performs comparison using the following scores in the identification of the code. The scores are defined in the following manner in the third embodiment. In the case of the code P001 in FIG. 24, the CPU 131 adopts the distance at which the sum of the distance between the center coordinate of the inspection region c and the center coordinate of the detected rectangular region 1503 and the distance between the center coordinate of the inspection region d and the center coordinate of the detected rectangular region 1504 is minimized as the score of the code P001. Similarly, the CPU 131 calculates the respective scores of the codes P002, P003, . . . . In addition, the CPU 131 determines that the minimal score, among the calculated scores, is closest to the orientation of the product in the input image. The CPU 131 overlaps the inspection region e and the inspection region f described in the code of the determined orientation with the input image and sets the respective rectangular regions from around the center coordinate to determine the positions of the all the rectangular regions.

In the table illustrated in FIG. 24, the positional relationship between all the six rectangular regions is capable of being determined based on the three-dimensional coordinate of each inspection region actually measured on the product. For example, the positional relationship between all the six rectangular regions is capable of being determined using, for example, a program that two-dimensionally projects the positional relationship as the positional relationship viewed from an arbitrary point of view.

In Step S1431, the CPU 131 determines the result in Step S1430 without change to use the result in Step S1431 as the correct value data 97.

When the rectangular region is input as the appearance abnormality from the user in Step S142, the region is not included in the rectangular region of the detection target for learning. Accordingly, although the CPU 131 estimates the two remaining rectangular regions inferred from the detected rectangular regions in Step S1430, the rectangular region input as the appearance abnormality from the user is excluded from the region of the detection target to generate the correct value data 97. Alternatively, the CPU 131 may describe the image from the result in Step S1431 as abnormal data for inspection so as not to be used in the learning to hold the image for confirmation of whether the abnormal data is detected after learning.

After Step S143, in Step S144, the CPU 131 makes a set of the input image and the annotation data determined in Step S143 to generate the learning data 98.

In the third embodiment, the rectangular regions are detected from the input image using the learned AI model that is pre-learned and the inspection regions that are not learned with the learned AI model are determined based on the coordinates of the rectangular regions detected using the learned AI model and the geometrical information that is set in advance. In the third embodiment, the method based on the learning is applicable to the process of determining the regions that are not learned with reference to the table in FIG. 24, as in the second embodiment described above. According to the third embodiment, since only the geometrical relationship between the detected regions is learned against the variable input image having high-level information, it is possible to relatively easily estimate the rectangular region that is not detected from the input rectangular region. Also in this case, the estimation is achieved by generating the learning data, which is a combination of the data resulting from deletion of the rectangular region necessary to be estimated from the correct value data and the rectangular region to be estimated, as in the second embodiment. Although the inspection target is the industrial product in the example in the third embodiment, the look of the inspection target region is greatly varied depending on the positional relationship with a light source because the position of the industrial product on the belt conveyor is not fixed. Accordingly, reduction of the data volume to be learned only by learning the positional relationship between the rectangular regions to be detected achieves large gain. In addition, the cost of generating the learning data is capable of being reduced. Furthermore, the example of application of the third embodiment is not limited to the industrial product and the third embodiment is applicable to the agricultural crops described above.

### Fourth Embodiment

When the detection process is performed using the AI model that is pre-learned with correct data (hereinafter referred to as GT), which is the teaching data described above with reference to FIG. 4A and FIG. 4B, it is desirable to detect the detection targets as the rectangular regions that are approximately the same as the GT illustrated in FIG. 4A and FIG. 4B. In the following description, the AI model that is pre-learned with the correct data is particularly referred to the “learned AI model”, which is literally discriminated from the AI model of the identifier that is acquired using the learning data generated through the information processing in the following embodiments.

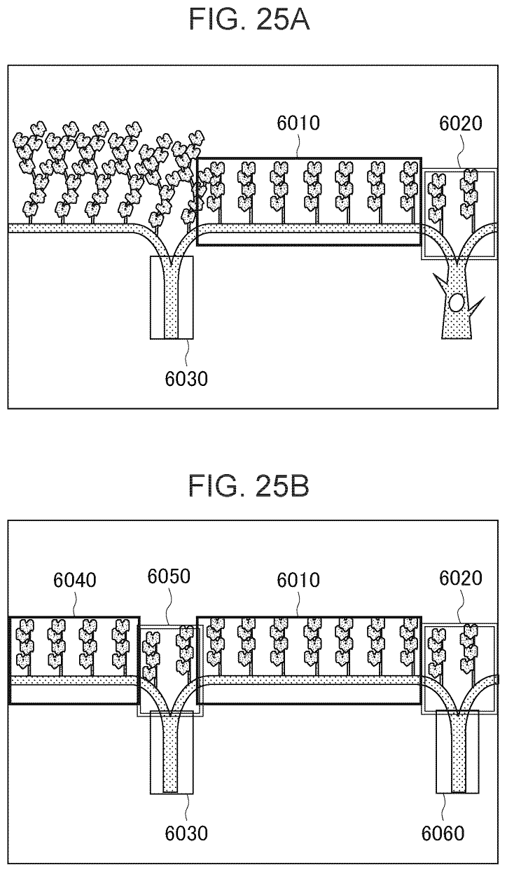

However, when the image having a property different from that of the image used in the learning (hereinafter referred to as a “learned image”) is input, the non-detection or the false detection may occur. FIG. 25A illustrates an example in a state in which, although the respective rectangular regions 6010, 6020, and 6030 are detected, the regions that are not detected exist, where the rectangular regions are not detected despite that the rectangular regions are to be detected. The region that is not detected, where the rectangular region is not detected despite that the rectangular region is to be detected, is hereinafter referred to as a “non-detected region” in the following description. The false detection will be described below in a fifth embodiment.

In the case in FIG. 25A, since the image having a look different from that of the pattern of each detection target included in the learned image is input, the regions where the rectangular regions are to be detected are made the non-detected regions. FIG. 25B illustrates an example of an image of the respective rectangular regions 6010 to 6060 in a state in which no non-detected region occurs. Since the pattern of each detection target included in the example of the image in FIG. 25B has a look similar to that of the pattern of each detection target included in the learned image, no non-detected region occurs. In contrast, in the example of the image in FIG. 25A, since the pattern of part of the detection targets has a look different from that of the pattern of each detection target included in the learned image, the portions of the detected regions having different patterns of look are the non-detected regions. Comparison between the example in FIG. 25A and the example in FIG. 25B indicates that the non-detected regions in FIG. 25A are the portions where the rectangular region 6040 of the Arm pattern, the rectangular region 6050 of the Fork pattern, and the rectangular region 6060 of the Trunk pattern are detected in the example in FIG. 25B. As described above, when the image the tendency of look of which is different from that of the learned image is input, the region where the rectangular region is to be detected may be made the non-detected region and the number of the non-detected regions is increased as the difference tendency of look of the image is increased.

The common measures to reduce the occurrence of the non-detected region is to perform the operation that is the same as the annotation described above also for a new image having a look different from that of the learned image. The learned AI model is, for example, updated through the learning using the GT that is newly generated as the result of the new annotation operation to enable the detection of the rectangular regions also in the image the tendency of look of which is different from that of the learned image, thus reducing the occurrence of the non-detected region. However, a significant cost is involved if such an annotation operation is performed each time a new farm field is shot. In other words, since the annotation operation is performed for the many (for example, several hundred to several thousand) images that are newly captured, the cost including time and effort is increased.

In a fourth embodiment, it is assumed that the detection process is performed using the learned AI model that has performed the learning so that a specific detection target is detected using the learned image. In other words, in the fourth embodiment, the detection process using the learned AI model is performed also for a new input image resulting from shooting of a new farm field or the like. However, when the learned AI model is used, the non-detected region or the like may occur if a new image the tendency of look of which is different from that of the learned image is input, as described above.

Accordingly, in the fourth embodiment, when the image having a look different from that of the learned image is input as the result of shooting of a new farm field or the like, the information processing described below is performed for the result of detection by the detection process using the learned AI model through the pre-learning to enable improvement of the detection performance. The information processing apparatus 13 of the fourth embodiment performs the information processing to generate the learning data required to acquire the identifier enabling the filling of the non-detected region that is not detected through the detection process using the learned AI model with the rectangular region (estimated region) of a probable label. In addition, the information processing apparatus 13 of the fourth embodiment displays the result of detection using the learned AI model in the display unit 137 as a visualized image. Accordingly, the user is capable of viewing the visualized image to confirm the result of detection. For example, when the non-detected region occurs, the user is capable of instructing the information processing apparatus 13 to perform the information processing. Upon input of an execution instruction from the user, the information processing apparatus 13 of the fourth embodiment performs the information processing described below to generate the learning data required to acquire the identifier for filling the non-detected region with the rectangular region of a probable label.

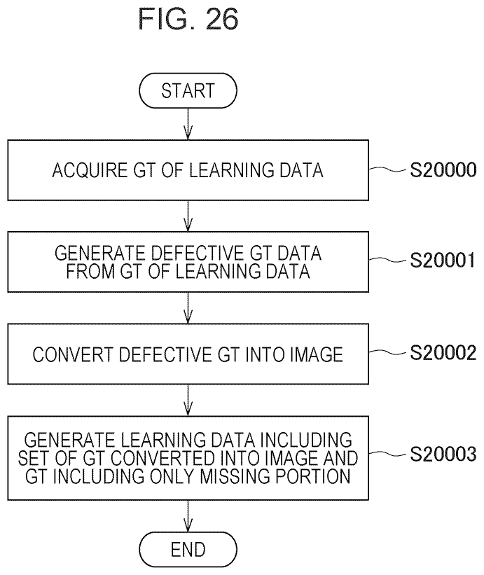

FIG. 26 is a flowchart of a learning data generating process enabling the acquisition of the identifier for filling the non-detected region with the rectangular region of a probable label. Although the processes in the flowchart in FIG. 26 and in the respective flowcharts described below are realized by, for example, the CPU 131 in the information processing apparatus 13 that executes the information processing program of the fourth embodiment, the processes may be realized with the configurations of circuits or the likes.

In the fourth embodiment, it is assumed that the learned AI model that is pre-learned so that a specific detection target is capable of being detected using the learned image is held in, for example, the cloud server 12, as described above. In Step S20000, the CPU 131 in the information processing apparatus 13 acquires the GT (the correct data) of the learning data used in the learning of the learned AI model. The GT at the time of Step S20000 is data having a format similar to that described above with reference to FIG. 4A and FIG. 4B and is data including only information about the rectangular regions that are discriminated by attaching the label to each image pattern in the learned image.

In Step S20001, the CPU 131 generates the GT data resulting from a certain processing process for the GT of the learning data acquired in Step S20000. In the fourth embodiment, the processing process for the GT of the learning data is a processing process of intendedly deleting part of the rectangular regions in the accurate GT corresponding to the rectangular regions of all the objects to be detected in the learned image. In other words, since the processing process of deleting part of the rectangular regions in the accurate GT is a process of generating the partially defective GT, the partially defective GT as the result of the processing process is hereinafter referred to as “defective GT data”. In other words, the defective GT data in the fourth embodiment is the GT data supposing the existence of the non-detected region in which the detection of part of the rectangular regions fails.

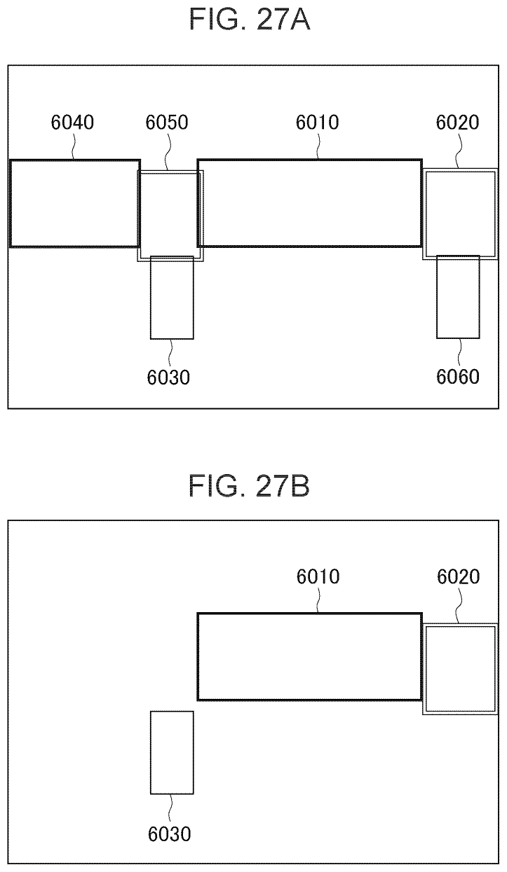

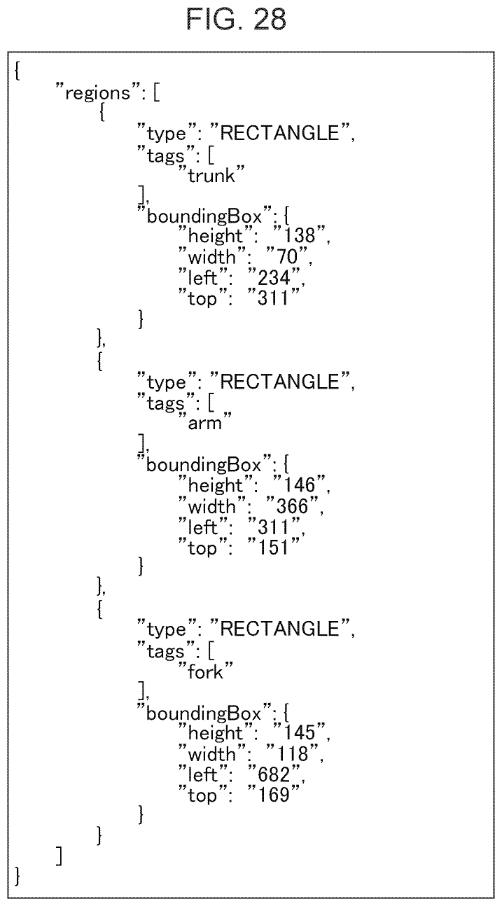

For example, when the respective rectangular regions of the GT acquired in Step S20000 are the respective rectangular regions 6010 to 6060 illustrated in FIG. 27A, the CPU 131 deletes part of the rectangular regions to generate the defective GT data illustrated in FIG. 27B. In other words, FIG. 27B illustrates an example of the defective GT data after the rectangular regions 6040, 6050, and 6060 in FIG. 27A are deleted. Although only the rectangular regions are illustrated in FIG. 27A and FIG. 27B, for example, FIG. 27A corresponds to the example in FIG. 25B and FIG. 27B corresponds to the example in FIG. 25A when the respective rectangular regions are superposed on the original image (the learned image). It is supposed that the defective GT data generated in Step S20001 is specifically recorded as information having a format illustrated in FIG. 28, which includes no image and in which only the labels and the coordinates of the rectangular regions are recorded in a plain text format or a JSON format.

In the deletion of one or more rectangular regions from the respective rectangular regions included in the original GT acquired in Step S20000, the CPU 131 determines the positions, the number, and the kinds of the rectangular regions selected to be deleted, for example, at random. Accordingly, the CPU 131 is capable of generating the multiple kinds of defective GT data from the original GT in Step S20001. The defective GT data generated in Step S20001 may include a case in which the number of the deleted rectangular regions is zero, that is, the GT data with no missing rectangular region. The defective GT data from which the rectangular regions are deleted is capable of being easily automatically generated with a simple program. The number of the rectangular regions deleted in Step S20001 may be a random number. For example, if all the rectangular regions are deleted, the GT data includes no rectangular region and it is not possible to estimate the positions of the rectangular regions from the GT data including no rectangular region. Accordingly, it is desirable to set in advance the maximum value of the number of the rectangular regions deleted in Step S20001 or the minimal number of the number of the rectangular regions that are left after the deletion.

In Step S20002 and the subsequent step, the CPU 131 generates the learning data making a set with the GT for leaning the identifier estimating the positions and the labels of the rectangular regions that are deleted in the generation of the defective GT data including the various rectangle deletion patterns described above. Although any identifier may be used as the identifier estimating the rectangular regions that are not included in the defective GT data, the identifier using the DNN, such as Faster R-CNN or a single shot detector (SSD) in deep learning, is exemplified in the fourth embodiment.

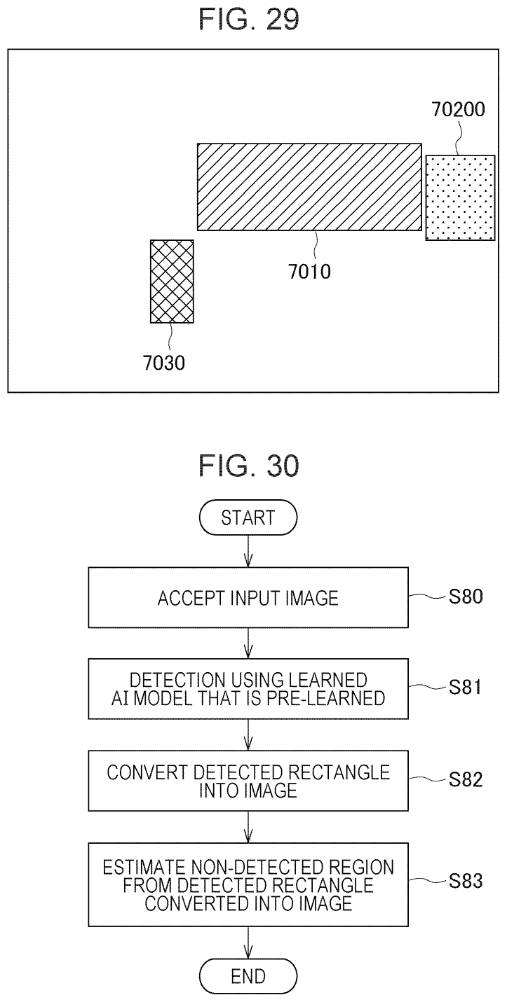

In Step S20002, the CPU 131 converts the defective GT data generated in Step S20001 into an image through an imaging process. For example, when conversion into a monochrome image is exemplified, for example, a method of allocating the same luminance value to the respective rectangular regions having the same label for imaging may be exemplified as a conversion rule in the imaging process. The CPU 131 realizes the imaging of the GT data by, for example, allocating the same luminance vale to the respective rectangular regions having the same label to draw the rectangular regions. FIG. 29 illustrates an example resulting of imaging of the defective GT data illustrated in FIG. 27B. Rectangular images 7010, 70200, and 7030 in FIG. 29 are the images after the imaging process is performed for the rectangular regions 6010, 6020, and 6030 in FIG. 27B.

In Step S20003, the CPU 131 makes a set of the rectangular images subjected to the imaging process in Step S20002 and the GT data resulting from writing out of only the rectangular regions in the missing portions deleted in Step S20001 to generate the learning data set. The GT data resulting from writing out of only the rectangular regions in the missing portions deleted in Step S20001 is recorded in a file in the plain text format or the JSON format, as in the example in FIG. 28. In other words, the learning data acquired in Step S20003 is the learning data set for the learning estimating the missing rectangular regions from the image including the missing portions.

Then, the information processing apparatus 13 or the cloud server 12 learns the learning data set that is automatically generated in the above manner using the DNN. As a result, the identifier capable of estimating the rectangular region for the non-detected region as the result of the detection process using the learned AI model through the pre-learning, that is, for the partial region with no rectangular region is capable of being acquired. The identifier estimating the rectangular region for the region (the non-detected region) lacking the rectangular region in the learned AI model through the pre-learning is hereinafter referred to as a “deficit correction identifier”. Since the deficit correction identifier is the identifier that has learned the appearance pattern of the rectangular regions to be detected, the deficit correction identifier is capable of estimating the rectangular region for the non-detected region that is not detected using the learned AI model from the captured image of a farm field or the like in a different environment. In the fourth embodiment, the deficit correction identifier is held in, for example, the cloud server 12. The AI model of the deficit correction identifier may not be the DNN of the same kind of that of the learned AI model that is pre-learned for detection (object detection) of the rectangular region of the object (the agricultural crops) from the captured image and may have an unrelated configuration.

FIG. 30 is a flowchart illustrating the flow of a process of detecting the rectangular region to be detected from the input image using the two identifiers: the identifier using the learned AI model and the deficit correction identifier acquired in the above manner in the information processing apparatus 13 of the fourth embodiment.

It is assumed that the information processing apparatus 13 has acquired the learned AI model that is pre-learned so as to detect the wine grape trees as the specific detection target from the cloud server 12 using an arbitrary method. For example, when the detection process using the learned AI model has been performed for the image resulting from shooting of the wine grape trees in the same farm field in a condition close to that in shooting of the learned image, the non-detected region is unlikely to occur. Accordingly, it is supposed that it is not necessary to perform the detection process of the rectangular region using the deficit correction identifier. In contrast, when the detection process using the learned AI model has been performed for the image resulting from shooting of the wine grape trees in a condition different from that in shooting of the learned image, the non-detected region is likely to occur. Accordingly, it is supposed that it is effective to perform the detection process of the rectangular region using the deficit correction identifier. Accordingly, a case will be described in the following example, in which the learned AI model is the AI model that has performed the learning using the image resulting from shooting of the tree in the growth state illustrated in FIG. 25B while the input image that is newly captured is the captured image of the tree having a partially different growth state, as in FIG. 25A.

In Step S80, the information processing apparatus 13 accepts the image captured by the camera 10 mounted on, for example, the tractor as the input image.

In Step S81, the CPU 131 in the information processing apparatus 13 performs the detection process for the input image accepted in Step S80 using the learned AI model described above. Here, since the input image is the image of the tree having a growth state that is partially different from that in the learning of the learned AI model, it is assumed that, for example, the non-detected regions illustrated in FIG. 27B occur in the detection process using the learned AI model.

In Step S82, the CPU 131 performs the imaging process to the respective detected rectangular regions 6010, 6020, and 6030 in the result of detection including the non-detected regions, as in FIG. 27B, to convert the rectangular regions into the rectangular images. This produces the rectangular images 7010, 70200, and 7030 illustrated in FIG. 29.

In Step S83, the CPU 131 inputs the rectangular images subjected to the imaging into the deficit correction identifier to acquire the respective rectangular regions, such as the ones illustrated in FIG. 27A, in which the rectangular regions 6040, 6050, and 6060 are complemented for the non-detected regions. Since the deficit correction identifier is the identifier that identifies the non-detected region from the arrangement of the rectangular regions detected using the learned AI model and that has performed the learning so as to estimate the optimal rectangular region for the non-detected region, the deficit correction identifier is capable of estimating the rectangular region for the portion that is not detected in the learned AI model.

As described above, in the fourth embodiment, the non-detected region is identified from the arrangement of the detected rectangular regions, the deficit correction identifier estimating the optimal rectangular region for the non-detected region is acquired, and the deficit correction identifier is combined with the learned AI model to achieve the favorable result of detection.

In the fourth embodiment, in addition to making a set of the deficit correction identifier and the learned AI model, the learned AI model itself may be updated (re-learned) using the GT resulting from correction of the result of detection using the learned AI model with the result of detection using the deficit correction identifier. Then, the detection process may be performed for a new input image only using the learned AI model that is updated (re-learned).

In the case of the detection target, like the exemplified wine grape trees, the look of which is greatly varied and which involves a cost to collect the images, it is difficult to acquire the AI model exhibiting the robust detection performance for the variation in look of the detection target and, particularly, the detection performance is likely to decrease in the case of a new farm field. In contrast, in the fourth embodiment, since the defective GT data is used for learning of the deficit correction identifier, the variation in look is not large, unlike the captured image, and the original GT data itself is held, it is possible to easily realize the learning of the deficit correction identifier with low cost. In other words, the fourth embodiment is capable of being realized with lower cost, compared with an attempt to increase the robustness of the learned AI model using the captured image.

Although all the detected regions are described as the rectangular regions in the fourth embodiment described above, the detected regions are not limited to the rectangular regions. The detected region may be, for example, a circular region defined only by the radius, the X coordinate, and the Y coordinate or a region that derives from an arbitrary heat map and that has an arbitrary largeness higher than or equal to a specific threshold value, instead of the rectangle. Although the identifier according to the fourth embodiment is described on the assumption that the identifier is implemented with the model learned with the deep learning-mechanical learning, any method may be adopted as long as the image pattern concerning the detection target is capable of being detected and identified. For example, the acquisition of the detector (estimator) is capable of being achieved with various identification techniques, such as fuzzy inference, genetic algorithm, or rules artificially defined with various parameters. Although the wine grape trees are exemplified for description in the fourth embodiment, the target is not limited to the wine grape trees. The fourth embodiment is applicable to all the targets having any rule in the relationship of arrangement between the rectangular regions to be detected.

### Fifth Embodiment

The example is described in the fourth embodiment, in which the estimator (the deficit correction identifier) correcting the non-detected region in the result of detection with the learned AI model that is pre-learned is generated. An example is described in a fifth embodiment, in which the identifier correcting (modifying) the rectangular region that is falsely detected with the learned AI model that is pre-learned is generated. For example, when an object having a texture similar to that of the detection target exists in the background or the like of the detection target in the captured image, the texture in the background may be falsely detected as the rectangular region. As the measures to reduce such false detection, performing the same operation as the operation (annotation) described above also for a new image is generally considered. However, since it takes time and effort to perform the annotation operation for a new image and the cost is increased, as in the case of the measures against the non-detected region described above, it is desirable to suppress the occurrence of the false detection without the new annotation operation. When the false detection occurs, it is desirable to realize a process of deleting the falsely-detected rectangular region or a process of modifying the false label.

In the fifth embodiment, when the detection process is performed using the learned AI model, the result of detection is displayed in the display unit 137 as the visualized image. Accordingly, the user is capable of viewing the visualized image to confirm the result of detection. For example, when the falsely-detected rectangular region exists, the user is capable of instructing the information processing apparatus 13 to perform the information processing according to the fifth embodiment. Upon input of an execution instruction of the information processing from the user, the information processing apparatus 13 performs the information processing described below to generate the learning data required to acquire the identifier for correcting (modifying) the falsely-detected region to the rectangular region of a probable label.

Also in the fifth embodiment, the GT data resulting from the certain processing process to the GT in the learning of the learned AI model is generated, as in the fourth embodiment described above. In the fifth embodiment, the processing process to the GT in the learning of the learned AI model is a processing process of adding the falsely-detected region to the accurate GT corresponding to the rectangular regions of all the objects to be detected in the learned image or a processing process of attaching a false label to the rectangular region. The false rectangular region to be added to the original accurate GT and the rectangular region to which the false label is attached are hereinafter referred to as “falsely added regions”. Since the configuration of a prediction system and so on in the fifth embodiment are the same as those in the fourth embodiment described above, illustration and description of the configuration of the prediction system and so on are omitted and only the portion different from the fourth embodiment will be described.

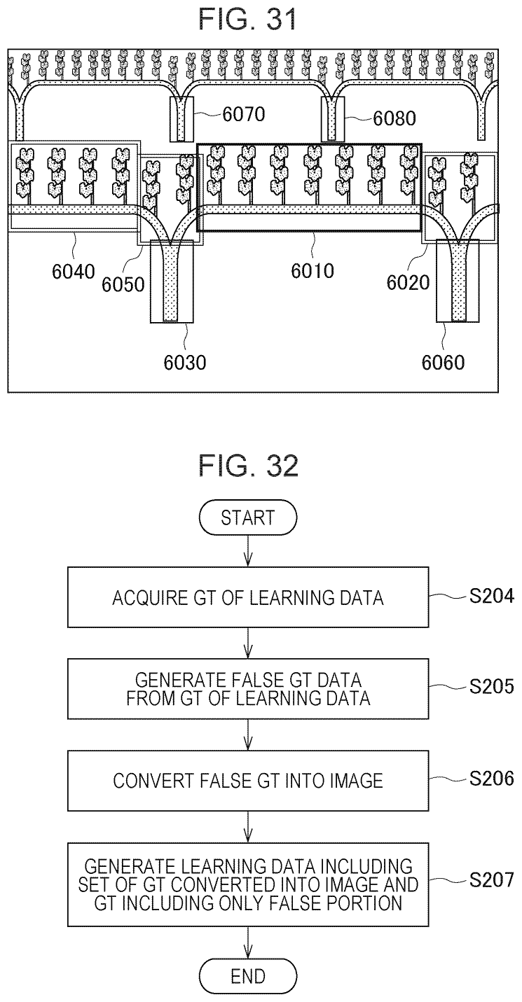

FIG. 31 is a diagram illustrating an example of an image in which the false detection is likely to occur because an object having a texture similar to that of the detection target exists in the background or the like. FIG. 32 is a flowchart of a learning data generating process according to the fifth embodiment, for enabling the acquisition of the identifier for correcting the falsely-detected region to the rectangular region of a probable label.

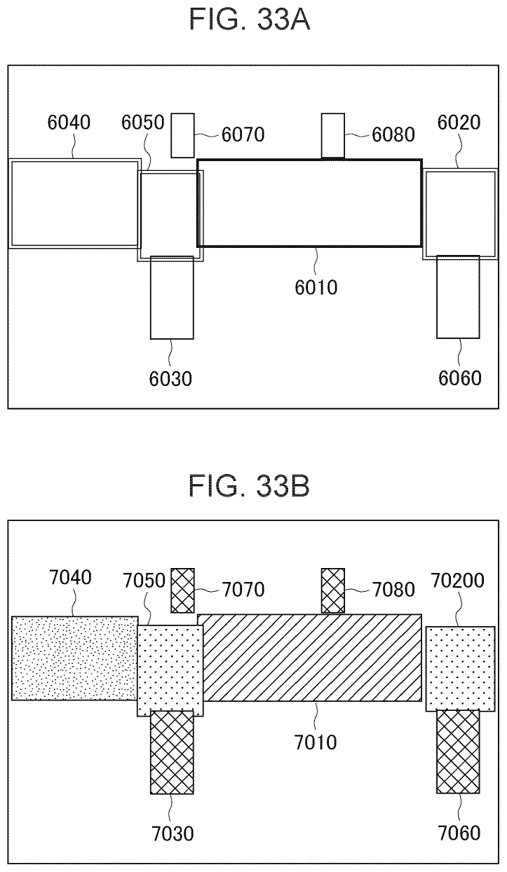

FIG. 33A is a diagram illustrating examples of the respective rectangular regions 6010 to 6080 detected using the learned AI model from the captured image illustrated in FIG. 31. In order to facilitate understanding of the correspondence between the rectangular regions 6010 to 6080 in FIG. 33A and the original captured image, the respective rectangular regions 6010 to 6080 in FIG. 33A are superposed on the image in FIG. 31. In the example of the image in FIG. 31, the wine grape trees to be detected are planted in two lines on the front side and the rear side. As the result of shooting the wine grape trees, similar patterns exist in the image with being overlapped. As exemplified in FIG. 31, when the wine grape trees on the front side are to be detected, only the rectangular regions 6010 to 6060 corresponding to the wine grape tress on the front side are desirably detected from the captured image. However, with the detection process using the learned AI model that is pre-learned, not only the regions 6010 to 6060 corresponding to the wine grape tress on the front side but also the rectangular regions 6070 and 6080 and so on corresponding to the trees on the rear side may also detected. In other words, the rectangular regions 6070 and 6080 are the rectangular regions falsely detected from the image of the trees on the rear side.

In the case of the captured image in FIG. 31, a case in which the pattern similar to that of the trees to be detected on the front side is detected from the image of the trees on the rear side and a case in which the label of the rectangular region detected from the image of the trees to be detected is not correct are supposed as the cases in which the false detection occurs. Accordingly, it is necessary to handle the two kinds of cases.

The information processing apparatus 13 of the fifth embodiment performs the process in the flowchart in FIG. 32 to generate the learning data for acquiring the identifier enabling correction (modification) of the rectangular region falsely-detected in the detection process using the learned AI model that is pre-learned. Also in the fifth embodiment, the learned AI model used to detect the detection target is generated through the pre-learning, as in the embodiments described above. In Step S204, the CPU 131 acquires the GT of the learning data used in the learning of the learned AI model.

In Step S205, the CPU 131 performs the processing process, such as addition of the false rectangular region, attachment of the false label, or rewiring of the false label, for the GT of the learning data acquired in Step S204. For example, when the respective rectangular regions of the GT acquired in Step S204 are the rectangular regions 6010 to 6060 in FIG. 27A, the CPU 131 processes the GT so as to add the rectangular regions 6070 and 6080 illustrated in FIG. 33A as the falsely added region. Although the example is illustrated in FIG. 33A, in which the rectangular regions 6070 and 6080 corresponding to the tress on the rear side in FIG. 31 are added, the rectangular region of the position or the size, which is not to be detected, may be added at random or the false label may be attached or rewritten at random. For example, a processing process of changing the label of the rectangular region 6040 of the Arm pattern to the Fork pattern in the example in FIG. 33A is exemplified as the processing process of attaching the false label to the rectangular region or rewrite the false label. The label to be changed in the attachment of the label or the rewriting of the label is assumed to be selected at random.

The CPU 131 sets the falsely added region for the GT of the learning data to process the GT data in Step S205. The GT data generated by setting the falsely added region to the GT of the learning data is hereinafter referred to as “false GT data”.

In the fifth embodiment, the number of the falsely added regions due to the false rectangular region or the attachment or rewriting of the false label may be arbitrarily set. However, since the addition of the rectangular regions of a number that does not actually occur does not lead the meaningful learning although the number of the falsely added regions may be arbitrarily set, it is desirable to set the maximum value in advance for the number of the rectangular regions to be added. Since it is sufficient to add the false rectangular region at random, attach the label at random, or rewrite the label to another label at random in the processing process in Step S205, the processing process in Step S205 is capable of being performed as a simple automatic process.

In Step S206, the CPU 131 performs the same imaging process as in the fourth embodiment for all the rectangular regions including the falsely added region described above. In the fifth embodiment, in the imaging, the same luminance value is allocated to the rectangular regions to which the same label is attached, among the respective rectangular regions. FIG. 33B illustrates an example of the respective rectangular regions after the imaging process has been performed for the respective rectangular regions including the falsely added regions, illustrated in FIG. 33A. In FIG. 33B, the rectangular images 7010, 7030 to 7080, and 70200 correspond to the rectangular regions 6010 to 6080 in FIG. 33A.

In Step S207, the CPU 131 makes a set of the rectangular regions after the conversion through the imaging in Step S206 and the GT data resulting from writing out of only the falsely added regions, for example, added in Step S205 and the label information to generate the learning data set. The GT data at this time is recorded in a file in the plain text format or the JSON format, as in the example in FIG. 28. In other words, the learning data acquired in Step S207 is the learning data set for enabling estimation of the rectangular region with no false detection and with the correct label from the image in which the false detection is likely to occur.

In the fifth embodiment, the learning data set automatically generated in the above manner is learned using the DNN, as in the example in the fourth embodiment, to acquire the identifier capable of identifying the falsely added region from the input image and estimating the correct rectangular region. The identifier capable of identifying the falsely added region and estimating the correct rectangular region is hereinafter referred to as a “false detection correction identifier”. The false detection correction identifier acquired in the fifth embodiment is held in the cloud server 12. The false detection correction identifier is not necessarily the DNN of the same kind as that of the learned AI model for detection (object detection) of the image region concerning the agricultural crops (object) from the captured image and may have an unrelated configuration.

The false detection correction identifier in the fifth embodiment is acquired by learning the appearance pattern of the rectangular regions to be detected, as described above. Accordingly, with the false detection correction identifier, it is possible to identify and correct the rectangular region that is falsely detected with the identifier of the original learned AI model, for example, when the image shot in a farm field having a different environment is input.

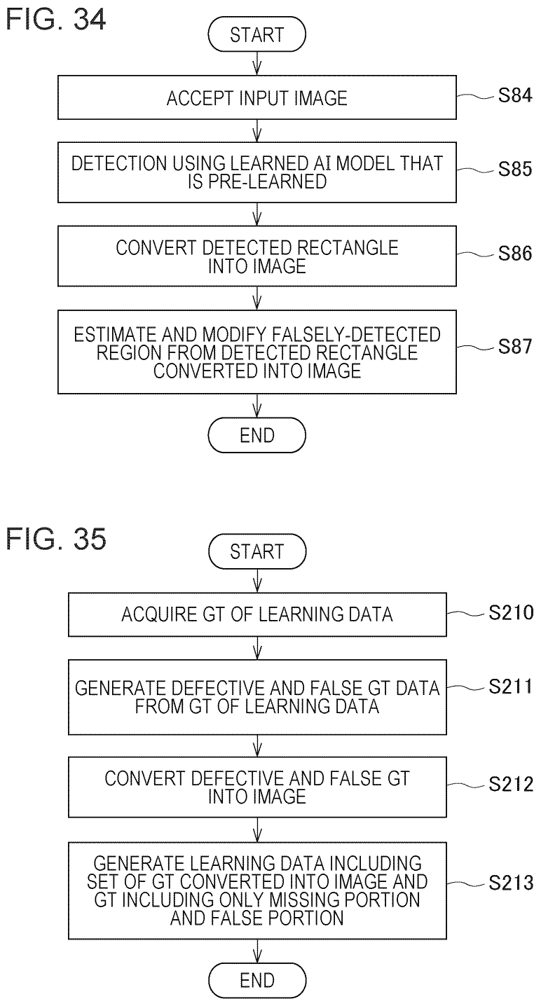

Also in the fifth embodiment, the detection process is performed using the two identifiers: the identifier of the learned AI model and the false detection correction identifier, as in the fourth embodiment described above. FIG. 34 is a flowchart illustrating a detection process performed using the two identifiers: the identifier of the learned AI model through the pre-learning and the false detection correction identifier acquired in the above manner. In the flowchart in FIG. 34, it is assumed that the information processing apparatus 13 has acquired the learned AI model that is pre-learned from the cloud server 12 using an arbitrary method, as in the flowchart in FIG. 30.

In Step S84, the information processing apparatus 13 accepts the image captured by the camera 10 mounted on, for example, the tractor as the input image. In Step S85, the CPU 131 in the information processing apparatus 13 performs the detection process for the input image accepted in Step S84 using the learned AI model described above. Here, since the input image is the image captured in an environment different from that in the learning of the learned AI model, it is assumed that, for example, the false rectangular regions 6070 and 6080 illustrated in FIG. 33A are detected in the detection process using the learned AI model.

In Step S86, the CPU 131 performs the image conversion process to all the rectangular regions 6010 to 6080 including the falsely-detected rectangular regions in FIG. 33A. This produces the rectangular images 7010, 7030 to 7080, and 70200 illustrated in FIG. 33B. In Step S87, the CPU 131 inputs the image subjected to the conversion process through the imaging into the false detection correction identifier to identify the falsely-detected regions (the rectangular regions 6070 and 6080), thus finally acquiring the rectangular regions exemplified in FIG. 27A.

As described above, in the fifth embodiment, the false detection correction identifier capable of identifying and correcting the falsely-detected rectangular region is acquired. The false detection correction identifier is combined with the learned AI model to achieve the favorable result of detection.

Also in the fifth embodiment, in addition to making of a set of the false detection correction identifier and the learned AI model, the learned AI model itself may be updated using the GT after the result of detection using the learned AI model is corrected, as in the fourth embodiment. Then, the detection process may be performed to a new input image only using the updated learned AI model.

Also in the fifth embodiment, the false detection correction identifier identifying and correcting the rectangular region that is falsely detected is capable of being automatically generated from the GT data in the learning of the learned AI model, as in the fourth embodiment. Accordingly, the fifth embodiment is also capable of being realized with lower cost, compared with an attempt to increase the robustness of the learned AI model using the captured image.

Also in the fifth embodiment, the detected region is not limited to the rectangular region and may be a circular region or a region that derives from an arbitrary heat map and that has an arbitrary largeness higher than or equal to a specific threshold value, as in the fourth embodiment. Although the identifier according to the fifth embodiment is described on the assumption that the identifier is implemented with the model learned with the deep learning-mechanical learning, any method may be adopted as long as the image pattern concerning the detection target is capable of being detected and identified, as in the fourth embodiment. In other words, for example, the acquisition of the detector (estimator) is capable of being achieved with various identification techniques, such as fuzzy inference, genetic algorithm, or rules artificially defined with various parameters. Although the wine grape trees are exemplified for description also in the fifth embodiment, the target is not limited to the wine grape trees. The fifth embodiment is applicable to all the targets having any rule in the relationship of arrangement between the rectangular regions to be detected.

### Sixth Embodiment

The example is described in the fourth embodiment, in which the non-detected region is capable of being corrected, and the example is described in the fifth embodiment, in which the falsely-detected region is capable of being corrected. Although the non-detected region and the falsely-detected region are learned using the different data sets for handling in the fourth and fifth embodiments, an example is described in a sixth embodiment, in which the non-detected region and the falsely-detected region are handled with one identifier. Since the configuration of the prediction system and so on in the sixth embodiment are the same as those in the fourth embodiment described above, illustration and description of the configuration of the prediction system and so on are omitted and only the portion different from the fourth embodiment will be described.

Although the large amount of varied learning data is required in the sixth embodiment, both the non-detection and the false detection are capable of being handled only by adding one identifier. FIG. 35 is a flowchart illustrating the flow of a learning data generating process in the sixth embodiment. The flowchart in FIG. 35 is a flowchart in which the flowchart in FIG. 26 and the flowchart in FIG. 32 are concurrently performed.

Also in the sixth embodiment, the learned AI model used to detect the rectangular region to be detected is generated in advance, as in the embodiments described above. In Step S210, the CPU 131 acquires the GT of the learning data used in the learning of the learned AI model.

In Step S211, the CPU 131 generates the GT data including the missing portion described in the fourth embodiment and including the falsely added region described in the fifth embodiment from the GT of the learning data acquired in Step S210. The GT data including the missing portion and the falsely added region is referred to as “defective and false GT data” in the sixth embodiment.

In Step S212, the CPU 131 performs the same imaging process as that described in the embodiments described above for the rectangular regions in the defective and false GT data generated in Step S211. Also in the sixth embodiment, the same luminance value is allocated to the rectangular regions to which the same label is attached in the imaging, as in the embodiments described above.

In Step S213, the CPU 131 makes a set of the rectangular images subjected to the imaging in Step S212 and the defective and false GT data generated in Step S211 to generate the learning data set. The learning data acquired in Step S213 is the learning data set for learning the identifier capable of estimating the rectangular region with no non-detected and false detection.

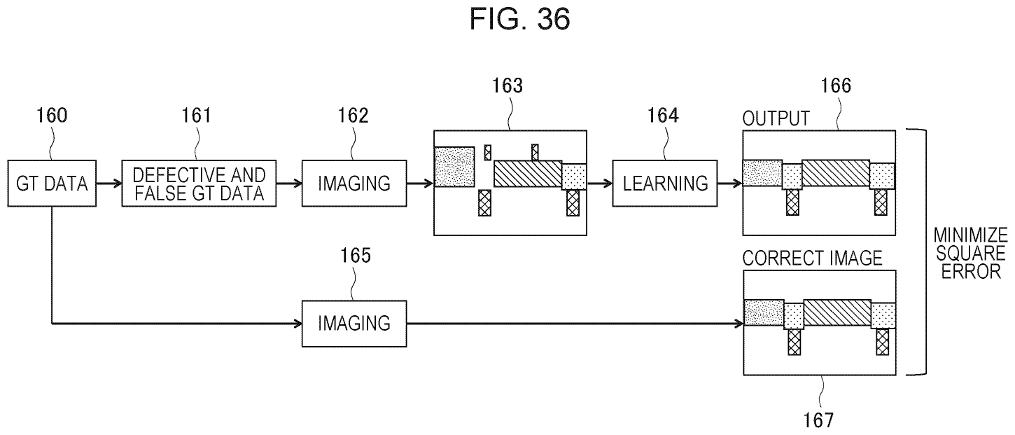

FIG. 36 is a diagram schematically illustrating the generation of the learning data set leaning the identifier capable of correcting both the non-detected region and the falsely-detected region and the learning process in the information processing apparatus 13 according to the sixth embodiment. As illustrated in FIG. 36, the information processing apparatus 13 performs the processing process, such as deletion of part of the rectangular regions from original GT data 160, change of the label, or addition of the falsely added region, to generate defective and false GT data 161. In addition, the information processing apparatus 13 performs imaging 162 to the rectangular regions in the defective and false GT data 161 to generate a rectangular image 163.

The information processing apparatus 13 learns 164 the DNN so as to output an output image 166 that is the same as a correct image 167 subjected to imaging 165 for the correct GT data 160. In other words, the information processing apparatus 13 learns the DNN correcting the non-detected region and the falsely-detected region through the learning of the DNN. When the generated DNN is used in the actual operation, imaging the rectangular regions as the result of detection using the learned AI model that is pre-learned and inputting the imaged rectangular regions into the DNN causes the corrected rectangular images to be output. Finally converting the output image into the information about the rectangular regions enables the same data as in the normal output or data similar to the data in the normal output to be acquired.

Also in the sixth embodiment, the learned AI model itself may be updated (re-learned) using the GT after the result of detection using the learned AI model is corrected with the results of detection using the deficit correction identifier and the false detection correction identifier. Then, the detection process may be performed for a new input image using only the updated learned AI model.

### Seventh Embodiment

In the fourth to sixth embodiments described above, even if the result of detection using the learned AI model exhibits the level indicating the insufficient performance, the output of the sufficient detection performance is capable of being acquired by using the deficit correction identifier, the false detection correction identifier, and/or like, which is generated through learning. However, in the actual operation, it may be necessary to determine whether the deficit correction identifier, the false detection correction identifier, and/or the like is used and how they are used, that is, whether the correction is performed for the result of detection using the learned AI model.

Accordingly, in a seventh embodiment, a process of determining how the result of output by the AI model of the deficit correction identifier or the false detection correction identifier is operated for correction is described. In the following description, when the deficit correction identifier or the false detection correction identifier are described with no discrimination, the deficit correction identifier and the false detection correction identifier are collectively referred to as a “correction identifier”. Since the configuration of the prediction system and so on in the seventh embodiment are the same as those in the fourth embodiment described above, illustration and description of the configuration of the prediction system and so on are omitted and only the portion different from the fourth embodiment will be described.

Also in the seventh embodiment, the detection target is the wine grape trees, as in the fourth to sixth embodiments. Although each partial region of the wine grape trees is detected as the rectangular region using the learned AI model also in the seventh embodiment, a case will be exemplified, in which the detection of the non-production region is performed particularly for repair or the like of the non-production region. The occurrence of the non-detected region or the falsely-detected region when the learned AI model is used is handled in the same manner as in the fourth to sixth embodiments described above and a description of this is omitted herein.

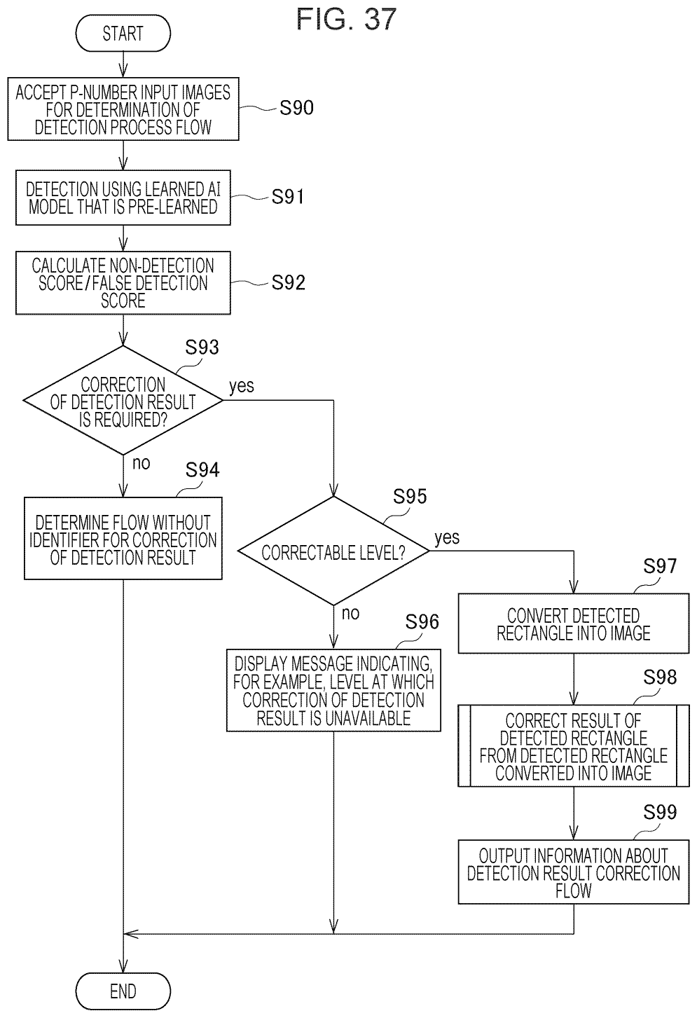

FIG. 37 is a flowchart illustrating the flow of a process of determining how to operate and correct the result of detection using the AI model of the correction identifier, which is the deficit correction identifier or the false detection correction identifier, in the seventh embodiment. In the following description, the correction using the AI model of the deficit correction identifier for the result of detection using the learned AI model is referred to as “non-detected rectangle correction” and the correction using the AI model of the false detection correction identifier for the result of detection using the learned AI model is referred to as “falsely-detected rectangle correction”.

In Step S90, the CPU 131 accepts the images captured by the camera 10 mounted on, for example, the tractor as the P-number input images (P>1). Although the P-number input images may be all the images resulting from shooting of the target farm field with the movement of the tractor, the P-number may be a minimal number of images required to determine the correction identifier for achieving the accurate result of detection for all the images. For example, the CPU 131 preferably selects a specific P-number at random and accepts the selected P-number input images.

In Step S91, the information processing apparatus 13 or the cloud server 12 performs the detection process for the P-number input images using the learned AI model that is pre-learned, as in the first to sixth embodiments described above.

In Step S92, the CPU 131 in the information processing apparatus 13 calculates a non-detection score and/or a false detection score. The non-detection score is an evaluation value representing a concept close to a non-detection ratio indicating the ratio of the non-detected regions to the rectangular regions to be detected as a score. The false detection score is an evaluation value representing a concept close to a false detection ratio indicating the ratio of the falsely-detected regions to the rectangular regions to be detected as a score. In general, the GT, which is the position or the label of the rectangular region in the correct data, is used and the position and the label of the rectangular region in the correct GT are compared with the position and the label of the detected rectangular region to calculate the non-detection ratio and the false detection ratio. However, since the position and the label of the rectangular region representing the true class are unknown in the case of an unknown farm field, it is not possible to calculate the non-detection ratio and the false detection ratio. In contrast, even if the accurate non-detection ratio or the accurate false detection ratio is unknown, a method of calculating the score the value of which is increased as the increasing non-detection ratio or the score the value of which is increased with the increasing false detection ratio may be used for determination.

For example, in the common farm field, it is considered that the agricultural crops are planted with equal spacing, as illustrated in FIG. 2A and FIG. 2B, and the detection target exists in most cases even in the production region or the non-production region. Accordingly, when the objects are detected as in the example of the annotation (the rectangular regions) illustrated in FIG. 4A and FIG. 4B, a state in which the rectangular regions are continuously detected from the left end to the right end of the image is considered to be the normal state. In contrast, when the detection process is performed for the input image having a tendency greatly different from the shooting condition of the learned image, non-detection of the rectangular region in the portion where the rectangular region of any label is to be detected occurs, as exemplified in FIG. 27B. In other words, the state in which the rectangular regions are continuously detected from the left end to the right end of the image does not occur. It is considered that the number of the portions where the rectangular regions are not detected in the image is increased as the condition of the input image is more apart from the shooting condition of the learned image of the learned AI model.

A simple scoring method for calculating the non-detection score described above for the result of detection using the learned AI model that is pre-learned to evaluate the non-detected region based on the non-detection score will now be described. For example, it is assumed that the detection process has been performed for the P-number input images using the learned AI model that is pre-learned. One input image, among the P-number input images, is focused on. This input image is referred to a target image. In the evaluation of the detection process of the target image, the CPU 131 searches for the detected region in the vertical direction with respect to the target image to count a number-of-pixels C(p) in a region with no detected region. In addition, the CPU 131 calculates the ratio of the number-of-pixels C(p) to a number-of-pixels Ci in the width direction of the target image as the non-detection score of the target image. The CPU 131 acquires the average value of the non-detection scores calculated from the respective P-number input images as a non-detection score Score_{ud} having high correlation with the non-detection ratio, as represented in Formula (1):

$$\begin{matrix}[ Formula 1 ] & \\ {Score}_{ud} = \frac{1}{P} {\sum }_{p = 0}^{P - 1} \frac{C ( p )}{{C}_{i}} & ( 1 )\end{matrix}$$

In the case of the input image captured by the camera 10 on the tractor, since the images shot by the camera 10 of the same tractor are always input, the number-of-pixels Ci is a constant. However, also in the case of the input images of different sizes, the calculation may be performed in the same manner. In the seventh embodiment, the non-detection score calculated according to Formula (1) is used as a non-detection evaluation value that occurs in the learned AI model for the farm field to be detected. Although the non-detection score is not calculated from the result of measurement of the true non-detected region, whether the deficit correction identifier is applied may be determined based on the non-detection score used as the evaluation value because the non-detection score has obvious positive correlation with the true non-detected region.

Next, a method of calculating the evaluation value capable of being used as the false detection score will now be described. In the calculation of the false detection score, a likelihood map representing the region where each rectangular region is detected in the learned image as the likelihood of each pixel is prepared in advance for all the learned images used in the pre-learning of the learned AI model. It is assumed that, for example, a T-number images are used as the learned images. It is assumed that the likelihood map has the same size as that of the image captured by the camera 10 in the numbers of pixels in the horizontal direction and the vertical direction. It is assumed that the likelihood maps of a number corresponding to the kinds of labels are prepared and that the likelihoods of all the pixels are set to zero as an initial value.

Here, when the number of the kinds of labels in all the rectangular regions in the learning data is denoted by M, the respective rectangular regions are classified into the M-number kinds of labels. Among the labels of the respective kinds, only the rectangular regions of one kind of target label are extracted. If the rectangular region of the target label exists at the position of the rectangular region in each of all the learned images, l/T is added to all the pixels in the rectangular region. For example, when the likelihood map corresponding to the Arm pattern is exemplified, only the rectangular regions of the Arm pattern are extracted from the T-number pieces of learning data. As the result of the addition of 1/T to all the pixels corresponding to the coordinates where the rectangular regions of the Arm pattern exist, the likelihood of a specific rectangular region to be focused on is one only when the specific rectangular regions have the Arm pattern in all the images. Conversely, the likelihood of the region where the rectangular region of the Arm pattern does not occur is kept at zero. In the seventh embodiment, it is assumed that the likelihood maps described above are created for all the kinds of labels in advance.

The CPU 131 performs a comparison operation between all the pixels R_{c} (x,y) in the respective rectangular regions for each label c detected in the learned AI model from the P-number input images and all the pixels l_{c} (x,y) at the coordinates in the rectangular regions in the likelihood map of the corresponding label to calculate a false detection score Score_{fp}. Formula (2) is a comparison operation expression for calculating the false detection score Score_{fp}:

$$\begin{matrix}[ Formula 2 ] & \\ {Score}_{fp} = \frac{1}{P} {\sum }_{p = 0}^{P - 1} {\sum }_{c = 0}^{M - 1} {\sum }_{{R}_{c} ( x , y )} \frac{{t}_{c} ( x , y )}{{I}_{c} ( x , y ) + K} , K = const & ( 2 )\end{matrix}$$

In Formula (2), k is a constant. The scoring is desirably designed by adding penalties so that the penalty is minimized when the rectangular region of the same label is detected at a point having a likelihood of one on the likelihood map and the penalty is maximized when the rectangular region is detected at a point having a likelihood of zero. For example, when k is set to 0.1 or the like, no problem practically occurs. Although the score detected in a class c in the learned AI model that is pre-learned is supposed to be set for t_{c} (x,y) in Formula (2), t_{c} (x,y) may be simply set to a constant.

Although the false detection score described above is not calculated from the result of measurement of the true false detected region, the false detection score is designed as the score resulting from evaluation based on whether the score is detected in a region where the falsely-detected region is likely to be detected in advance. Since the input images shot in the similar conditions every time are assumed here, the tendency of the false detection is sufficiently recognized through such scoring in the scoring of the shift in tendency between the captured image of the farm field to be detected and the learned image. Accordingly, whether the false detection correction identifier is applied may be determined based on the false detection score used as the evaluation value.

The CPU 131 calculates the non-detection score and the false detection score for the result of detection using the learned AI model in the above manner. In other words, the CPU 131 acquires the evaluation value providing an indication of whether the non-detected rectangle correction with the deficit correction identifier is applied or the falsely-detected rectangle correction with the false detection correction identifier is applied to the input image resulting from shooting of the target farm field.

In Step S93, the CPU 131 determines whether the correction is required for the result of detection using the learned AI model using the non-detection score and the false detection score described above as the criteria.

For example, if the non-detection score and the false detection score are lower than or equal to threshold values that are set in advance for determination of whether the correction is required, the CPU 131 determines that the correction of the result of detection using the learned AI model that is pre-learned is not required. The CPU 131 determines that the result of detection using the learned AI model is reliable and the process goes to Step S94. In Step S94, the CPU 131 determines that the correction is not required in the flowchart in FIG. 37. Then, the process in FIG. 37 is terminated. If either of the non-detection score and the false detection score exceeds the corresponding threshold value for determination of whether the correction is required in Step S93, the CPU 131 determines that the correction is required and the process goes to Step S95.

In Step S95, the CPU 131 determines whether the score is within a level correctable through the non-detected rectangle correction with the deficit correction identifier or the falsely-detected rectangle correction with the false detection correction identifier. For example, if the non-detection score according to Formula (1) is very close to one, almost all the rectangular regions are not detected and only a few number of rectangular regions are detected. Accordingly, it is difficult to estimate all the non-detected regions with high accuracy from a few number of rectangular regions. Consequently, if the non-detection score is higher than or equal to a threshold value that is set in advance for determination of whether the non-detected rectangle correction is available, the CPU 131 determines that it is difficult to perform recovery through the correction and the process goes to Step S96. In Step S96, the CPU 131 displays a message indicating, for example, a level at which the correction of the result of detection is unavailable. Then, the process in FIG. 37 is terminated. Similarly, if the false detection score according to Formula (2) is higher than or equal to a threshold value for determination of whether the falsely-detected rectangle correction is available, the CPU 131 determines that it is difficult to perform recovery through the correction and the process goes to Step S96. In Step S96, the CPU 131 displays a message indicating, for example, a level at which the correction of the result of detection is unavailable. Then, the process in FIG. 37 is terminated.

If the CPU 131 determines in Step S95 that the non-detection score and the false detection score are lower than the threshold values for determination of the correctable level and that the non-detection score and the false detection score are at a level at which improvement of the performance is expected through the correction, the process goes to Step S97. In Step S97, the CPU 131 converts all the rectangular regions detected using the learned AI model from the P-number input images into the rectangular images through the imaging process described above.

In Step S98, the CPU 131 performs the non-detected rectangle correction or the falsely-detected rectangle correction to the rectangular images resulting from the imaging process. Although the non-detected rectangle correction and the falsely-detected rectangle correction in Step S98 are similar to the processes described in the above embodiments, the non-detected rectangle correction may be combined with the falsely-detected rectangle correction.

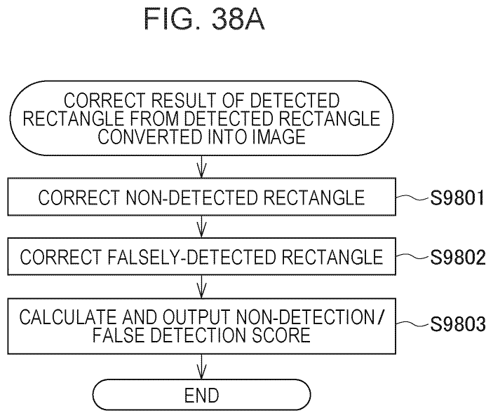

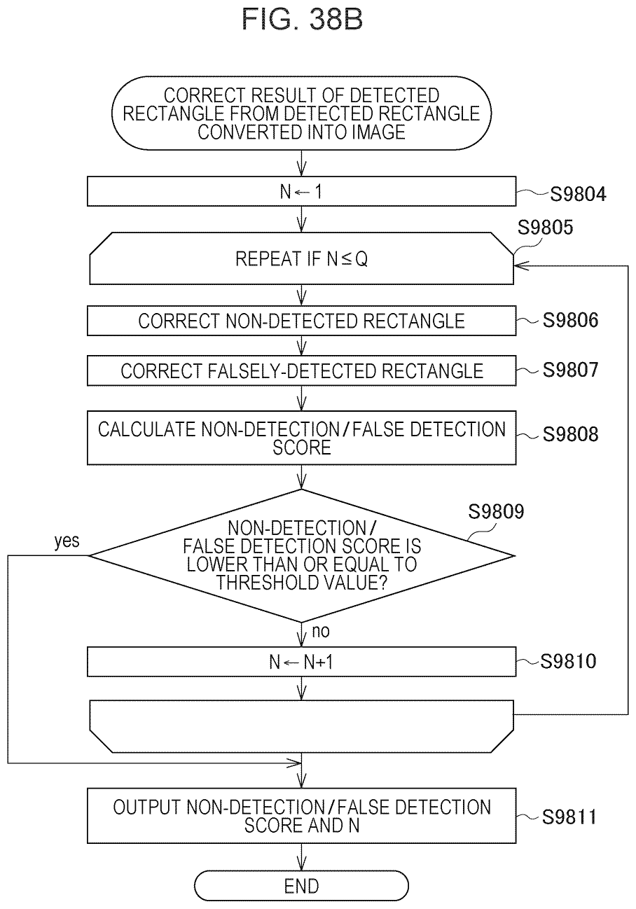

A process in which the non-detected rectangle correction is combined with the falsely-detected rectangle correction will now be described with reference to flowcharts in FIG. 38A and FIG. 38B. FIG. 38A is a flowchart when the non-detected rectangle correction is simply combined with the falsely-detected rectangle correction and each of the non-detected rectangle correction and the falsely-detected rectangle correction is determined to be performed once. FIG. 38B is a flowchart in which the process in FIG. 38A is performed multiple times to search for the probability to improve the estimation accuracy.

In the flowchart in FIG. 38A, in Step S9801, the CPU 131 performs the non-detected rectangle correction, as in the fourth embodiment. In Step S9802, the CPU 131 performs the falsely-detected rectangle correction, as in the fifth embodiment. Specifically, the CPU 131 estimates the rectangular region corresponding to the non-detected region in a state in which the presence of the falsely-detected region is permitted for the rectangular region detected using the learned AI model. Then, the CPU 131 identifies the falsely-detected region from each rectangular region existing at this time and corrects the label of the rectangular region identified as the falsely-detected region.

Then, in Step S9803, the CPU 131 calculates the scores defined according to Formula (1) and Formula (2) to determine whether the recovery succeeds through the correction processes in Step S9801 and Step S9802. In Step S99 in FIG. 37, the CPU 131 outputs (displays) the result of the determination in Step S9803. In the flowchart in FIG. 38A, the process is performed after the detection process using the learned AI model that is pre-learned to present information indicating whether the favorable performance is achieved to the user.

In the flowchart in FIG. 38B, the CPU 131 repeats the process in the flowchart in FIG. 38A multiple times until the level of improvement of the accuracy reaches a predetermined level (the number of times of repetition does not exceeds Q). Specifically, in Step S9804, the CPU 131 sets an initial value of one to a number-of-loops N to be repeated. In Step S9805, the CPU 131 performs a loop process of repetition. When the maximum-number-of-times-of-repetition Q is set in advance, the maximum-number-of-times-of-repetition Q may be set based on the number of times permitted in the processing time in the actual operation.

In Step S9806 in the loop process of repetition, the CPU 131 performs the non-detected rectangle correction described above. In Step S9807, the CPU 131 performs the falsely-detected rectangle correction described above. In Step S9808, the CPU 131 calculates the non-detection score and the false detection score at this stage.

In Step S9809, the CPU 131 determines whether the performance set in advance is achieved with the calculated scores through comparison with a threshold value. If the performance is not achieved, in Step S9810, one is added to the number-of-loops N and the process goes back to the beginning of the loop process of repetition. If the CPU 131 determines that the performance is achieved in Step S9809, the CPU 131 leaves the loop process of repetition and the process goes to Step S9811.

In Step S9811, the CPU 131 outputs the final scores calculated in Step S9808 and the final number-of-loops N. The value of the number-of-loops N is output (displayed) to finally indicate what frequency the non-detected rectangle correction and the falsely-detected rectangle correction are actually performed on in the farm field to be detected.

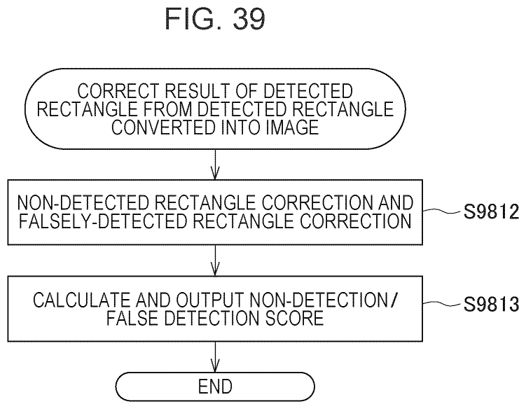

In the seventh embodiment, when the process described in the sixth embodiment with reference to FIG. 36 as the example in which the non-detected rectangle correction and the falsely-detected rectangle correction are concurrently performed is performed in Step S98 in the flowchart in FIG. 37, the process is realized only through a flowchart in FIG. 39. In this case, in Step S9812, the CPU 131 performs the non-detected rectangle correction and the falsely-detected rectangle correction. In Step S9813, the CPU 131 calculates the non-detection score and the false detection score after the correction process and outputs the non-detection score and the false detection score.

The CPU 131 outputs the result of processing described above in Step S99 and performs the process in the flowchart in FIG. 38B after the detection process using the learned AI model that is pre-learned to present information indicating whether the favorable performance is achieved to the user.

According to the seventh embodiment, it is possible to achieve the favorable result by performing the detection process for all the images resulting from shooting of the farm field to be detected with the correction identifier determined upon termination of the processes in the flowcharts described above.

Although the example is described in the seventh embodiment, in which the correction identifiers for the non-detected rectangle correction and the falsely-detected rectangle correction are composed as different identifiers, the two correction identifiers may be composed as one identifier as in FIG. 35 in the sixth embodiment. Although the example is described also in the seventh embodiment, in which all the detected regions are processed as the rectangular regions, the detected region may be a circular region or a region that derives from an arbitrary heat map and that has an arbitrary largeness higher than or equal to a specific threshold value, as described in the above embodiments. The identifier is not limited to the learning model learned with the deep learning-mechanical learning also in the seventh embodiment and any method may be adopted as long as the image pattern concerning the detection target is capable of being detected and identified. The acquisition of the detector (estimator) is capable of being achieved with various identification techniques, such as fuzzy inference, genetic algorithm, or rules artificially defined with various parameters. The target is not limited to the wine grape trees also in the seventh embodiment. The seventh embodiment is applicable to all the targets having any rule in the relationship of arrangement between the rectangular regions to be detected.

### Eighth Embodiment

An example is described in an eighth embodiment, in which the result of the detection process for the input image using the learned AI model is not used for the evaluation and it is determined whether the non-detected rectangle correction and the falsely-detected rectangle correction are applied before the detection process of the input image is performed. In the eighth embodiment, before the detection process using the learned AI model, it is determined whether the non-detected rectangle correction and the falsely-detected rectangle correction are performed with reference to only parameters concerning the capturing and the detection target of the input image and parameters concerning the capturing and the detection target of the learned image. Since the index in the selection of the learned AI model from the cloud server 12 is directly used for the determination of whether the non-detected rectangle correction and the falsely-detected rectangle correction are performed in the eighth embodiment, the description will be started from the step before selecting the learned AI model from the cloud server 12. Since the configuration of the prediction system and so on are the same as those in the fourth embodiment described above also in the eighth embodiment, illustration and description of the configuration of the prediction system and so on are omitted and only the portion different from the fourth embodiment will be described.

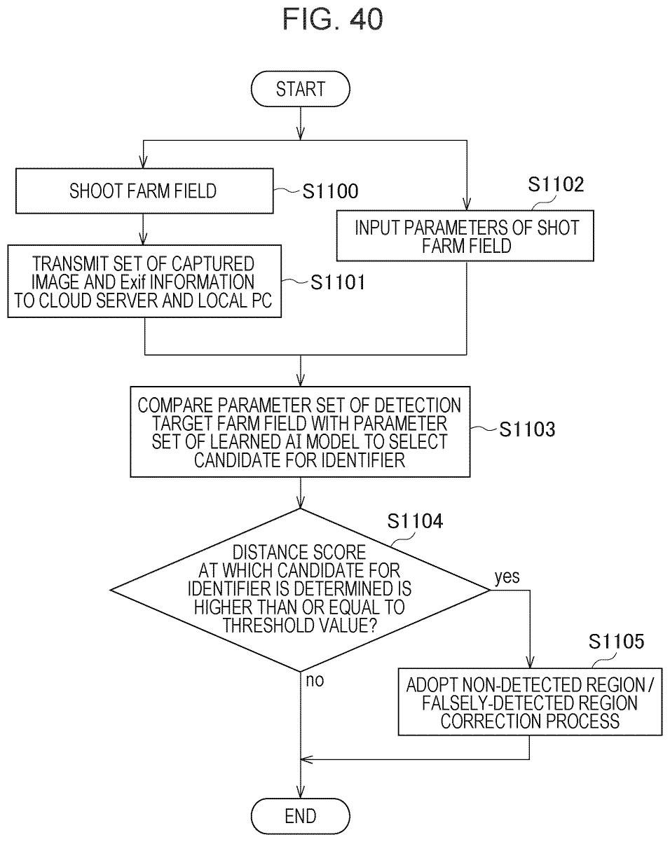

FIG. 40 is a flowchart illustrating the flow of a process in the eighth embodiment. In Step S1100, the farm field to be detected is shot by the camera 10. In Step S1101, the captured image by the camera 10 is transmitted to the cloud server 12 where the multiple learned AI models are stored and the information processing apparatus 13 (local PC) for viewing along with the Exif information. Concurrently, in Step S1102, the parameters of the farm field to be shot (referred to as farm field parameters) are input into the information processing apparatus 13 and the farm field parameters are also transmitted to the cloud server 12. Here, the farm field parameters are parameters of the breed, the tree age, the growing method, and so on of the plant grown in each farm field. Comparing the farm field parameters of the learned image of the learned AI model to be used and the farm field parameters of the farm field to be detected (detection target farm field) enables simple determination of whether the learned image is close to the captured image of the detection target farm field in property. More intuitively, since the plants of the same breed are similar to each other in look and the plants of the close tree ages are similar to each other in the entire growth state, the property of similar features on the image is used.

The cloud server 12 acquires a detection target farm field parameter set including the set of the farm field parameters of the detection target farm field and the Exif information added to the captured image. The cloud server 12 holds the parameter set added to the learned AI model as the property of the learning data. In Step S1103, the cloud server 12 compares the parameter set of the detection target farm field with the parameter set of the learned AI model to select the learned AI model as a candidate for the identifier based on the result of comparison. In the comparison process in Step S1103, the cloud server 12 calculates the learned AI model that is learned with the image captured in a condition closest to that of the detection target farm field, for example, according to Formula (3) described below:

$$\begin{matrix}[ Formula 3 ] & \\ D ( Q , {M}_{x} ) = {\sum }_{k} {α}_{k} * {f}_{k} ( {q}_{k} , {m}_{x , k} ) , 1 \leq k & ( 3 )\end{matrix}$$

Q in Formula (3) denotes the parameters added to the captured image of the detection target farm field and is hereinafter referred to as a query parameter set. Mx in Formula (3) denotes the parameter set of each of the multiple learned AI models stored in the cloud server 12. These parameter sets are each composed of k-number parameters.

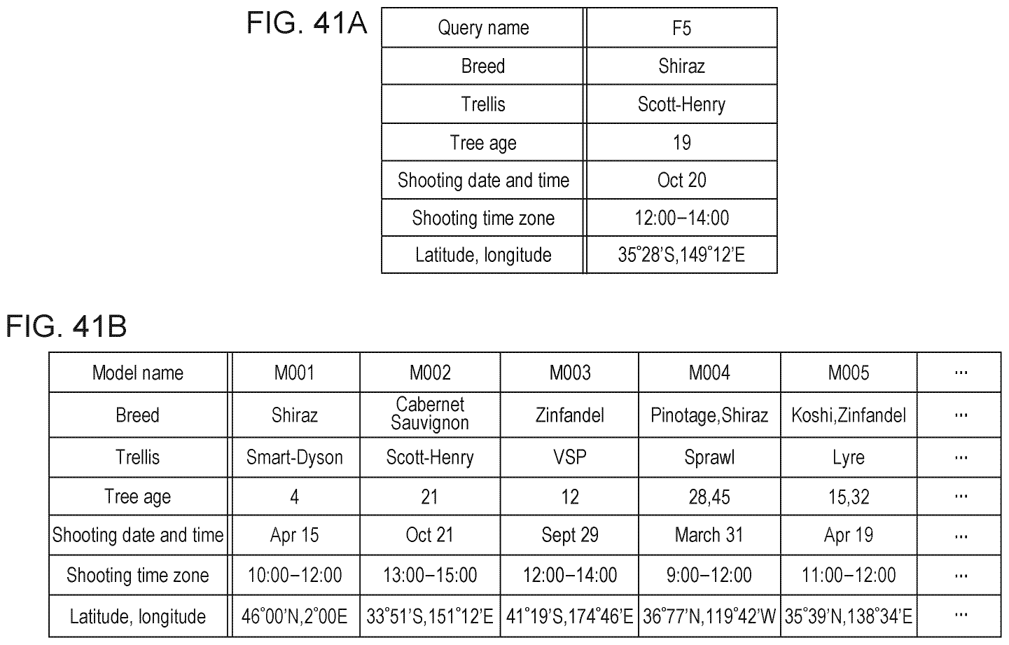

FIG. 41A indicates an example of the query parameter set and FIG. 41B indicates an example of the parameter set of the learned AI model. Breed, Trellis (how to plant the trees), Tree age, . . . are exemplified as the parameters in FIG. 41A and FIG. 41B. In the examples in FIG. 41A and FIG. 41B, k=6. Each parameter in the query parameter set Q illustrated in FIG. 41A is denoted by qₖ and each parameter in a model Mx is denoted by m_{x,k}. The respective AI model names are denoted by M001, M002, M003, . . . in FIG. 41B. The method of calculating the distance between the parameter qₖ and the parameter m_{x,k} is defined individually in advance. Although the method of calculating the distance may be carefully set in advance by experiment in the individual definition, the method may be simply set in the following manner because the AI models having more different properties basically have higher values in the definition of the distance according to Formula (3). The respective individual parameters are basically separated into the case of classification parameters (Breed and Trellis) and the case of continuous value parameters (Tree age, Shooting date and time, . . . ). Accordingly, patterns according to Formula (4) and Formula (5) are allocated to each k.

For example, the classification parameters (Breed and Trellis) may be set according to Formula (4) and the continuous value parameters (Tree age, Shooting date and time, . . . ) when k=3 may be set according to Formula (5):

$$\begin{matrix}[ Formula 4 ] & \\ {f}_{k} ( {q}_{k} , {m}_{x , k} ) = \{ \begin{matrix}0 ( {q}_{k} = {m}_{x , k} ) \\ 0 ( {q}_{k} \neq {m}_{x , k} )\end{matrix} & ( 4 )\end{matrix}$$

$$\begin{matrix}[ Formula 5 ] & \\ {f}_{k} ( {q}_{k} , {m}_{x , k} ) = \vert {q}_{k} - {m}_{x , k} \vert & ( 5 )\end{matrix}$$

Formula (4) is a conditional expression that sets the distance between the parameters to zero when the parameter qₖ and the parameter m_{x,k} have the same value and that constantly returns one when the parameter qₖ and the parameter m_{x,k} have different values. Formula (5) is an expression that returns the absolute value of the distance between the parameters. It is assumed that the conditional expression for all k in these Formulas is implemented in a rule-based manner in advance. It is assumed that the magnitude of αk is determined depending on the degree of influence of each parameter on the final distance between the AI models. The parameters are adjusted, for example, so that αk when k=1 is made close to one as much as possible because the difference caused by the parameters concerning the breed does not clearly appear in the difference of the images while αk when k=2 is set to a high value because the difference caused by the parameters concerning the trellis has large influence on the images.

In the case of the AI model that has performed the learning with the multiple kinds of data set for the breed and the tree age, as in the respective AI models such as the model names M004 and M005 in FIG. 41B, the selection is performed in the following manner. For example, distance scores of the multiple conditions of the parameters at the AI model side for the query parameters may be calculated for the corresponding k in Formulas (4) and (5) to calculate the average value of the distance scores.

According to Formula (3), the distance score is calculated based on the difference between the farm field parameter set of the detection target farm field and the parameters of the respective learned AI models held in the cloud server 12. The learned AI model that has performed the learning with the image having the closest condition, which is the minimum distance with respect to the distance score, is selected as a candidate AI model. However, the image may be apart from the growth status, the shooting condition, and so on of the detection target farm field even with the candidate AI model and, in this case, the non-detected region or the falsely-detected region may frequently occur.

Accordingly, in Step S1104, the cloud server 12 calculates the difference between the parameters of the detection target farm field when the optimal candidate AI model is determined and the parameters of the candidate AI model as the evaluation value. In the eighth embodiment, the distance score between the parameters of the detection target farm field when the optimal candidate AI model is determined and the parameters of the candidate AI model, when the respective parameters are, for example, two-dimensionally or three-dimensionally represented, is calculated as the evaluation value indicating the difference between both of the parameters. In the eighth embodiment, it is determined whether the distance score between the both of the parameters is higher than or equal to a predetermined threshold value. In the determination process, if the distance score is lower than or equal to the threshold value, it is determined that the image of the farm field, which is learned, is very close to the captured image of the detection target farm field in property in the candidate AI model. Accordingly, it is determined that the process of correcting the non-detected region or the falsely-detected region is not required. If the distance score exceeds the threshold value as the result of comparison in Step S1104, the process goes to Step S1105. In Step S1105, it is determined that the process, such as the non-detected rectangle correction or the falsely-detected rectangle correction, is required. If it is determined in Step S1105 that the process, such as the non-detected rectangle correction or the falsely-detected rectangle correction, is required, information indicating that the process is required is transmitted to the information processing apparatus 13 and the processes in the flowcharts in FIG. 38A, FIG. 38B, and FIG. 39 are performed in the information processing apparatus 13.

In the eighth embodiment, whether the correction process is required is determined concurrently with the selection of the learned AI model with reference to the farm field parameters and so on, without the viewing and the determination of the result of the detection by the user and the calculation of the score for determining whether the correction process is performed from the result of detection. Although the wine grape trees are exemplified also in the eighth embodiment, the eighth embodiment is not limited to this. The method described above is effective for all the targets having any rule in the relationship of arrangement between the detected rectangles.

### Ninth Embodiment

The cases are mainly described in the fourth to eighth embodiments, in which the learned AI model subjected to the insufficient learning is applied to a new input image. A case will be described in a ninth embodiment, in which the learned AI model that is subjected to the sufficient learning and that is capable of robustly detecting the target is used. Since the configuration of the prediction system and so on in the ninth embodiment are the same as those in the fourth embodiment described above, illustration and description of the configuration of the prediction system and so on are omitted and only the portion different from the fourth embodiment will be described.

An example is described in the ninth embodiment, in which a runner is detected as the detection target when it is necessary to detect only runners for achieving a special camera effect or the like in a scene, such as a marathon. It is assumed that an AI model for general-purpose human body detection, which is generally used in a monitoring camera or the like, is supposed as the learned AI model used for the detection of the runners and the learned AI model for general-purpose human body detection performs joint identification enabling recognition of the posture of a person.

Here, when the learned AI model for general-purpose human body detection is used in the marathon, not only the runners but also persons who views the running of the runners along the course may be detected. Since it is necessary to detect only the runners in the example supposed in the ninth embodiment, direct use of the result of detection by the learned AI model for general-purpose human body detection may cause detection of unrelated persons, which are not the runners, that is, false detection of the persons.

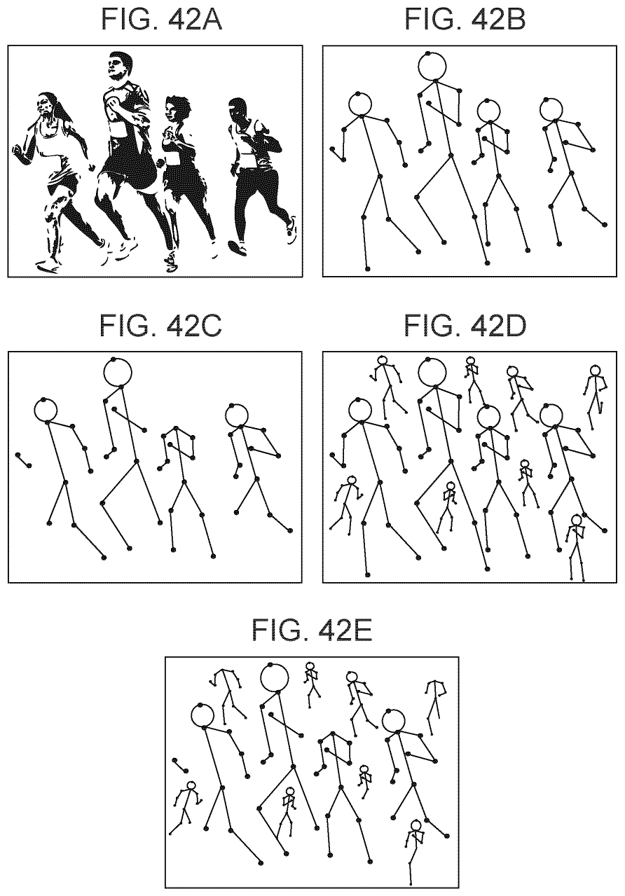

Accordingly, an example is described in the ninth embodiment, in which the AI model of the correction identifier is created, which accepts the result of detection by the learned AI model for general-purpose human body detection and converts the accepted result of detection into the result of detection of only the runners for output. First, the captured image is acquired, which results from shooting of the runners in advance at the angle of view in the shooting, supposed in the camera 10 shooting the runners in the marathon. At this time, the shooting is performed so that persons other than the runners do not exist on the image, as illustrated in FIG. 42A. Then, a process of detecting the heads and the joints of the human bodies using the learned AI model for general-purpose human body detection is performed for the captured image. FIG. 42B illustrates a diagram imaging the result of detection at this time. The result of detection in FIG. 42B corresponds to an ideal result of detection including no falsely-detected viewers even when the viewers and so on exist along the course on the day of the marathon. The result of detection by the learned AI model for general-purpose human body detection is detected as not the rectangular regions described in the above embodiments but information, such as the lines and the points connecting the heads and the joints of the human bodies.

In the ninth embodiment, the GT of the learning data for generating the correction identifier of the result of detection described above in the respective embodiments is generated based on the result of detection. In the ninth embodiment, the information processing apparatus 13 generates the defective GT data resulting from deletion of part of the joints or the like to be detected for the detection of the human bodies and the postures of the persons based on the same idea as in the fourth embodiment described above. In other words, in the ninth embodiment, the result of detection when the likelihood of the joints is relatively reduced due to the many viewers in the background to cause the non-detected region is supposed. If the GT data on which the generation of the defective GT data is based is the GT data illustrated in FIG. 42B, the defective GT data resulting from deletion of part of the joints is generated, as in FIG. 42C. The regions to be deleted are not limited to the joints and the regions to be deleted may be determined at random.

The information processing apparatus 13 generates the defective GT data, makes a set of the defective GT data and the original GT data, and performs the learning for estimating the mission portions (the non-detected regions) to generate the correction identifier through the same detection process as in the fourth embodiment. In other words, the correction identifier in this case is generated as the identifier capable of recovering the joints or the likes that are not detected (the non-detected regions). The imaging process in the generation of the correction identifier is performed in the same manner as in the example in which the different luminance values are allocated to the respective labels, described in the fourth embodiment. In the ninth embodiment, for example, the respective joints and the straight lines (bones) connecting the respective joints may have a fixed width and the different luminance values may be allocated to the straight lines having different meanings for the imaging.

Also in the ninth embodiment, the processing process based on the same idea as in the eighth embodiment is performed to the GT in the learning of the learned AI model to generate the GT data. In the processing process in the ninth embodiment, the persons, the joints (the bones), and the likes the sizes and the positions of which are varied at random are added to the regions other than the runners, as illustrated in FIG. 42D. A set of the GT data after the processing process and the original GT data is made and the learning for modifying falsely-detected portions (the falsely-detected regions) is performed to generate the correction identifier. In the ninth embodiment, the correction identifier, which is generated through the learning using the set of the GT data after the processing process illustrated in FIG. 42D and the original GT data illustrated in FIG. 42B, is the identifier capable of detecting the joints and so on that are falsely detected (the falsely-detected regions) as the joints and so on with no false detection.

Also in the ninth embodiment, the learning data for concurrently identifying and correcting the non-detected region and the falsely-detected region may be generated, as in the sixth embodiment. In the processing process in this case, part of the joints of the GT is deleted or the persons, the joints (the bones), and so on the sizes and the positions of which are varied at random are added to unrelated regions, as illustrated in FIG. 42E, based on the same idea as in the eighth embodiment. The learning for correcting the non-detection and the false detection is performed using a set of the GT data after the processing process illustrated in FIG. 42E and the original GT data illustrated in FIG. 42B to generate the correction identifier. In other words, the correction identifier, which is generated through the learning using the set of the GT data after the processing process illustrated in FIG. 42E and the original GT data illustrated in FIG. 42B, is the identifier capable of recovering the non-detection and the false detection.

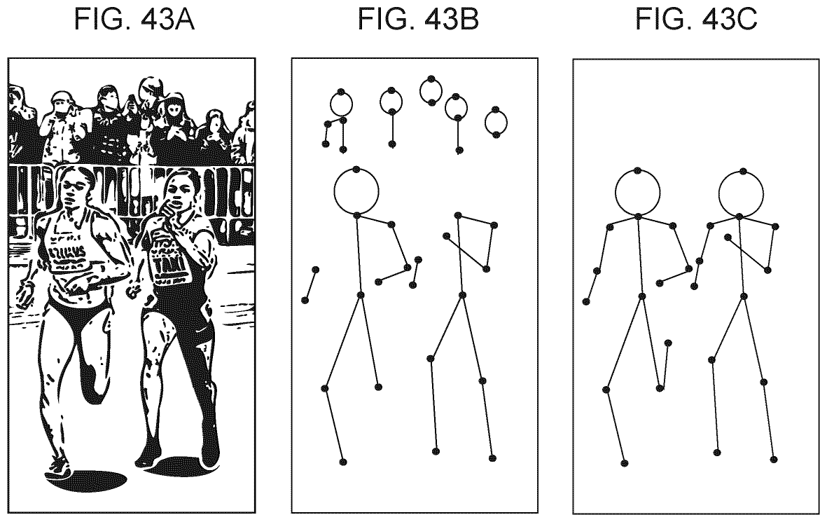

Also in the ninth embodiment, the learned AI model for general-purpose human body detection is combined with the AI model of the correction identifier described above, as in the above embodiments. Accordingly, it is possible to finally achieve the result of detection illustrated in FIG. 43C in which the non-detected portions and the falsely-detected portions are corrected even if, for example, the image illustrated in FIG. 43A is input on the day of the marathon and the result of detection of the learned AI model for general-purpose human body detection illustrated in FIG. 43B is output.

As described above, according to the ninth embodiment, in the operation example in which the person is detected as the detection target, it is possible to acquire the AI model correcting the result of detection using the learned AI model even when persons or the likes very similar to the detection target exist in the background or the like.

The present disclosure is capable of being realized by a process in which a program realizing one or more functions of the above embodiments is supplied to a system or an apparatus via a network or a storage medium and one or more processors in the computer in the system or the apparatus reads out the program for execution. Alternatively, the present disclosure is capable of being realized by a circuit (for example, an application specific integrated circuit (ASIC)) realizing the one or more functions. The above embodiments only indicate examples of embodiment when the present disclosure is implemented, and the technical scope of the present disclosure is not limitedly interpreted by the above embodiments. In other words, the present disclosure may be embodied in various modes without departing from the technical idea or the main features of the present disclosure.

For example, the partial region corresponding to the detection target to be detected by detecting means may be a partial region of an agricultural crop plant, a partial region of an industrial product, or a partial region, for example, on the surface of a structure (an infrastructure structure or a concrete structure), such as a bridge or a building, or the surface of a moving body, such as an aircraft.

The disclosure of the respective embodiments includes the following components, methods, and programs.

### (Configuration 1)

An information processing apparatus includes detecting means for detecting a partial region corresponding to a detection target from an input image using a learning model; accepting means for accepting information indicating a specific partial region, which is input by a user based on the input image; and generating means for generating learning data from a result of correction of a result of detection by the detecting means based on the information indicating the specific partial region, accepted by the accepting means, and the input image.

### (Configuration 2)

In the information processing apparatus described in Configuration 1, the generating means performs the correction of the result of detection by the detecting means also using a rule in which positional relationship of the detection target is defined in advance.

### (Configuration 3)

The information processing apparatus described in Configuration 1 or 2 further includes estimating means that has performed learning so as to detect a specific partial region corresponding to a format detected by the learning model. The generating means performs the correction of the result of detection by the detecting means also using the estimating means.

### (Configuration 4)

In the information processing apparatus described in Configuration 3, the estimating means is generated through learning using the learning data generated for learning of the learning model and data resulting from modification of the learning data.

### (Configuration 5)

In the information processing apparatus described in Configuration 4, the estimating means generates data resulting from deletion of part of the partial region to be detected from the learning data generated for the learning of the learning model or addition of information about a false partial region to the learning data generated for the learning of the learning model, as the data resulting from modification of the learning data.

### (Configuration 6)

In the information processing apparatus described in any of Configurations 1 to 5, the generating means generates the learning model detecting the specific partial region through learning using a result of correction of the result of detection by the detecting means based on the information indicating the specific partial region, accepted by the accepting means, and the learning data generated from the input image.

### (Configuration 7)

In the information processing apparatus described in any of Configurations 1 to 6, the generating means generates a learning model that is different from the learning model used by the detecting means and that detects a partial region different from the partial region detected by the learning model used by the detecting means.

### (Configuration 8)

In the information processing apparatus described in Configuration 7, the generating means generates the learning model that detects a partial region different from the partial region detected by the learning model used by the detecting means based on geometrical information indicating positional relationship between the partial regions detected from the input image using the learning model used by the detecting means.

### (Configuration 9)

In the information processing apparatus described in any of Configurations 1 to 8, the generating means performs error determination of the specific partial region used by the user based on at least one of a size of the specific partial region input by the user and an overlapped area of the partial regions.

### (Configuration 10)

In the information processing apparatus described in Configuration 2, the generating means corrects a magnitude of the result of detection by the detecting means based on the rule in which the positional relationship of the detection target is defined in advance.

### (Configuration 11)

In the information processing apparatus described in Configuration 1 or 10, the generating means modifies a label representing a pattern of the rule in which the positional relationship of the detection target is defined in advance as the correction of the result of detection by the detecting means.

### (Configuration 12)

In the information processing apparatus described in any of Configurations 1 to 11, the partial region corresponding to the detection target detected by the detecting means is a partial region of an agricultural crop plant.

### (Configuration 13)

In the information processing apparatus described in Configuration 12, the specific partial region is a non-production region of the agricultural crop plant.

### (Configuration 14)

In the information processing apparatus described in any of Configurations 1 to 11, the partial region corresponding to the detection target detected by the detecting means is a partial region of an industrial product.

### (Configuration 15)

In the information processing apparatus described in any of Configurations 1 to 11, the partial region corresponding to the detection target detected by the detecting means is a partial region of a structure.

### (Method 1)

An information processing method includes detecting a partial region corresponding to a detection target from an input image using a learning model; accepting information indicating a specific partial region, which is input by a user based on the input image; and generating learning data from a result of correction of a result of detection in the detecting based on the information indicating the specific partial region, accepted in the accepting, and the input image.

### (Configuration 16)

An information processing apparatus includes detecting means for detecting a partial region corresponding to a detection target from an input image using a learning model and correcting means for correcting a result of detection by the detecting means. The correcting means corrects the result of detection by the detecting means using an identifier generated through learning using data resulting from certain processing to correct data generated for learning of the learning model as learning data.

### (Configuration 17)

An information processing apparatus includes acquiring means for acquiring correct data generated for learning of a learning model that detects a detection target from an image; processing means for performing certain processing to the correct data; and generating means for generating an identifier through learning using data subjected to the certain processing to the correct data by the processing means as learning data.

### (Configuration 18)

The information processing apparatus described in Configuration 17 further includes detecting means for detecting a partial region corresponding to a detection target from an input image using the learning model and correcting means for correcting a result of detection by the detecting means. The correcting means corrects the result of detection by the detecting means using the identifier generated by the generating means.

### (Configuration 19)

In the information processing apparatus described in any of Configuration 16 to 18, the certain processing includes at least one of processing to delete part of the correct data, processing to add false data to the correct data, and processing to rewrite part of the correct data to false data.

### (Configuration 20)

In the information processing apparatus described in any of Configuration 16 to 19, the identifier is generated through learning using an image resulting from imaging of the data after the certain processing is performed to the correct data.

### (Configuration 21)

The information processing apparatus described in Configuration 16 or 18 further includes calculating means for calculating a certain evaluation value and determining means for determining whether the correction using the identifier of the correcting means is performed based on the evaluation value calculated by the calculating means.

### (Configuration 22)

In the information processing apparatus described in Configuration 21, the calculating means calculates the evaluation value based on the result of detection by the detecting means using the learning model.

### (Configuration 23)

In the information processing apparatus descried in Configuration 22, the calculating means calculates a ratio of a region where the detection target is not detected with respect to a detection region to be detected in the input image as the evaluation value.

### (Configuration 24)

In the information processing apparatus described in Configuration 23, the calculating means searches for the detection target in the input image to calculate a ratio of a region where the detection target does not exist with respect to a region of the input image as the evaluation value.

### (Configuration 25)

In the information processing apparatus described in Configuration 24, the determining means determines whether the correction using the identifier of the correcting means is performed based on multiple evaluation values calculated by the calculating means from multiple results of detection detected by the detecting means for multiple input images.

### (Configuration 26)

In the information processing apparatus described in Configuration 25, the calculating means calculates the evaluation value based on comparison between a likelihood map representing likelihood of the detection target in multiple images used in the learning of the learning model and the result of detection by the detecting means using the learning model.

### (Configuration 27)

In the information processing apparatus described in Configuration 21, the calculating means calculates the evaluation value based on comparison between a parameter concerning the detection target included in the input image and capturing of the input image and a parameter concerning the detection target included an image used in the learning of the learning model used by the detecting means and capturing of the image.

### (Configuration 28)

In the information processing apparatus described in Configuration 27, the calculating means calculates a distance between a parameter concerning the detection target included in the input image and capturing of the input image and a parameter concerning the detection target included an image used in the learning of the learning model used by the detecting means and capturing of the image as the evaluation value.

### (Configuration 29)

In the information processing apparatus described in any of Configurations 21 to 28, the determining means determines whether the correction using the identifier of the correcting means is performed based on comparison between the evaluation value calculated by the calculating means and a predetermined threshold value.

### (Configuration 30)

The information processing apparatus described in Configuration 16 or 18 further includes updating means for updating the learning model through learning using a result of detection subjected to the correction by the correcting means.

### (Configuration 31)

In the information processing apparatus described in any of Configurations 16 to 30, the partial region corresponding to the detection target detected by the detecting means is a partial region of an agricultural crop plant.

### (Configuration 32)

In the information processing apparatus described in any of Configurations 16 to 30, the partial region corresponding to the detection target detected by the detecting means is a partial region composing a human body.

### (Configuration 33)

In the information processing apparatus described in any of Configurations 16 to 30, the partial region corresponding to the detection target detected by the detecting means is a partial region of an industrial product.

### (Configuration 34)

In the information processing apparatus described in any of Configurations 16 to 30, the partial region corresponding to the detection target detected by the detecting means is a partial region of a structure.

### (Method 2)

An information processing method includes detecting a partial region corresponding to a detection target from an input image using a learning model and correcting a result of detection in the detecting. The correcting corrects the result of detection in the detecting using an identifier generated through learning using data resulting from certain processing to correct data generated for learning of the learning model as learning data.

### (Method 3)

An information processing method includes acquiring correct data generated for learning of a learning model that detects a detection target from an image; performing certain processing to the correct data; and generating an identifier through learning using data subjected to the certain processing to the correct data in the processing as learning data.

### (Program 1)

A program causing a computer to function as the information processing apparatus described in any of Configurations 1 to 33.

The present disclosure is not limited to the embodiments described above and various changes and modifications may be made to the present disclosure without departing from the spirit and scope thereof. Accordingly, the following claims are appended to publicize the scope of the present disclosure.

According to the present disclosure, it is possible to attain a prediction result capable of achieving expected performance with low cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
detecting means for detecting a partial region corresponding to a detection target from an input image using a learning model;
accepting means for accepting information indicating a specific partial region, which is input by a user based on the input image; and
generating means for generating learning data from a result of correction of a result of detection by the detecting means based on the information indicating the specific partial region, accepted by the accepting means, and the input image.

2. The information processing apparatus according to claim 1, wherein the generating means performs the correction of the result of detection by the detecting means also using a rule in which positional relationship of the detection target is defined in advance.

3. The information processing apparatus according to claim 1, further comprising: estimating means that has performed learning so as to detect a specific partial region corresponding to a format detected by the learning model, wherein the generating means performs the correction of the result of detection by the detecting means also using the estimating means.

4. The information processing apparatus according to claim 3, wherein the estimating means is generated through learning using the learning data generated for learning of the learning model and data resulting from modification of the learning data.

5. The information processing apparatus according to claim 4, wherein the estimating means generates data resulting from deletion of part of the partial region to be detected from the learning data generated for the learning of the learning model or addition of information about a false partial region to the learning data generated for the learning of the learning model, as the data resulting from modification of the learning data.

6. The information processing apparatus according to claim 1, wherein the generating means generates the learning model detecting the specific partial region through learning using a result of correction of the result of detection by the detecting means based on the information indicating the specific partial region, accepted by the accepting means, and the learning data generated from the input image.

7. The information processing apparatus according to claim 1, wherein the generating means generates a learning model that is different from the learning model used by the detecting means and that detects a partial region different from the partial region detected by the learning model used by the detecting means.

8. The information processing apparatus according to claim 7, wherein the generating means generates the learning model that detects a partial region different from the partial region detected by the learning model used by the detecting means based on geometrical information indicating positional relationship between the partial regions detected from the input image using the learning model used by the detecting means.

9. The information processing apparatus according to claim 1, wherein the generating means performs error determination of the specific partial region used by the user based on at least one of a size of the specific partial region input by the user and an overlapped area of the partial regions.

10. The information processing apparatus according to claim 2, wherein the generating means corrects a magnitude of the result of detection by the detecting means based on the rule in which the positional relationship of the detection target is defined in advance.

11. The information processing apparatus according to claim 2, wherein the generating means modifies a label representing a pattern of the rule in which the positional relationship of the detection target is defined in advance as the correction of the result of detection by the detecting means.

12. The information processing apparatus according to claim 1, wherein the partial region corresponding to the detection target detected by the detecting means is a partial region of an agricultural crop plant.

13. The information processing apparatus according to claim 12, wherein the specific partial region is a non-production region of the agricultural crop plant.

14. The information processing apparatus according to claim 1, wherein the partial region corresponding to the detection target detected by the detecting means is a partial region of an industrial product.

15. The information processing apparatus according to claim 1, wherein the partial region corresponding to the detection target detected by the detecting means is a partial region of a structure.

16. An information processing method comprising:
detecting a partial region corresponding to a detection target from an input image using a learning model;
accepting information indicating a specific partial region, which is input by a user based on the input image; and
generating learning data from a result of correction of a result of detection in the detecting based on the information indicating the specific partial region, accepted in the accepting, and the input image.

17. A non-transitory computer-readable storage medium storing a program for causing a computer to function as an information processing apparatus comprising:
detecting means for detecting a partial region corresponding to a detection target from an input image using a learning model;
accepting means for accepting information indicating a specific partial region, which is input by a user based on the input image; and
generating means for generating learning data from a result of correction of a result of detection by the detecting means based on the information indicating the specific partial region, accepted by the accepting means, and the input image.

18. An information processing apparatus comprising:
detecting means for detecting a partial region corresponding to a detection target from an input image using a learning model; and
correcting means for correcting a result of detection by the detecting means using an identifier generated through learning using data resulting from certain processing to correct data generated for learning of the learning model as learning data.

19. An information processing apparatus comprising:
acquiring means for acquiring correct data generated for learning of a learning model that detects a detection target from an image;
processing means for performing certain processing to the correct data; and
generating means for generating an identifier through learning using data subjected to the certain processing to the correct data by the processing means as learning data.

20. The information processing apparatus according to claim 19, further comprising:
detecting means for detecting a partial region corresponding to a detection target from an input image using the learning model; and
correcting means for correcting the result of detection by the detecting means,
wherein the correcting means corrects the result of detection by the detecting means using the identifier generated by the generating means.

21. The information processing apparatus according to claim 18, wherein the certain processing includes at least one of processing to delete part of the correct data, processing to add false data to the correct data, and processing to rewrite part of the correct data to false data.

22. The information processing apparatus according to claim 18, wherein the identifier is generated through learning using an image resulting from imaging of the data after the certain processing is performed to the correct data.

23. The information processing apparatus according to claim 18, further comprising:
calculating means for calculating a certain evaluation value; and
determining means for determining whether the correction using the identifier of the correcting means is performed based on the evaluation value calculated by the calculating means.

24. The information processing apparatus according to claim 23, wherein the calculating means calculates the evaluation value based on the result of detection by the detecting means using the learning model.

25. The information processing apparatus according to claim 23, wherein the calculating means calculates a ratio of a region where the detection target is not detected with respect to a detection region to be detected in the input image as the evaluation value.

26. The information processing apparatus according to claim 24, wherein the calculating means searches for the detection target in the input image to calculate a ratio of a region where the detection target does not exist with respect to a region of the input image as the evaluation value.

27. The information processing apparatus according to claim 25, wherein the determining means determines whether the correction using the identifier of the correcting means is performed based on multiple evaluation values calculated by the calculating means from multiple results of detection detected by the detecting means for multiple input images.

28. The information processing apparatus according to claim 24, wherein the calculating means calculates the evaluation value based on comparison between a likelihood map representing likelihood of the detection target in multiple images used in the learning of the learning model and the result of detection by the detecting means using the learning model.

29. The information processing apparatus according to claim 22, wherein the calculating means calculates the evaluation value based on comparison between a parameter concerning the detection target included in the input image and capturing of the input image and a parameter concerning the detection target included an image used in the learning of the learning model used by the detecting means and capturing of the image.

30. The information processing apparatus according to claim 28, wherein the calculating means calculates a distance between a parameter concerning the detection target included in the input image and capturing of the input image and a parameter concerning the detection target included an image used in the learning of the learning model used by the detecting means and capturing of the image as the evaluation value.

31. The information processing apparatus according to claim 23, wherein the determining means determines whether the correction using the identifier of the correcting means is performed based on comparison between the evaluation value calculated by the calculating means and a predetermined threshold value.

32. The information processing apparatus according to claim 18, further comprising:
updating means for updating the learning model through learning using a result of detection subjected to the correction by the correcting means.

33. The information processing apparatus according to claim 18, wherein the partial region corresponding to the detection target detected by the detecting means is a partial region of an agricultural crop plant.

34. The information processing apparatus according to claim 18, wherein the partial region corresponding to the detection target detected by the detecting means is a partial region composing a human body.

35. The information processing apparatus according to claim 18, wherein the partial region corresponding to the detection target detected by the detecting means is a partial region of an industrial product.

36. The information processing apparatus according to claim 18, wherein the partial region corresponding to the detection target detected by the detecting means is a partial region of a structure.

37. An information processing method comprising:
detecting a partial region corresponding to a detection target from an input image using a learning model; and
correcting a result of detection in the detecting, wherein the result of detection in the detecting is corrected using an identifier generated through learning using data resulting from certain processing to correct data generated for learning of the learning model as learning data.

38. An information processing method comprising:
acquiring correct data generated for learning of a learning model that detects a detection target from an image;
performing certain processing to the correct data; and
generating an identifier through learning using data subjected to the certain processing to the correct data in the processing as learning data.

39. A non-transitory computer-readable storage medium storing a program for causing a computer to function as an information processing apparatus comprising:
detecting means for detecting a partial region corresponding to a detection target from an input image using a learning model; and
correcting means for correcting a result of detection by the detecting means, wherein the correcting means corrects the result of detection by the detecting means using an identifier generated through learning using data resulting from certain processing to correct data generated for learning of the learning model as learning data.

40. A non-transitory computer-readable storage medium storing a program for causing a computer to function as an information processing apparatus comprising:
acquiring means for acquiring correct data generated for learning of a learning model that detects a detection target from an image;
processing means for performing certain processing to the correct data; and
generating means for generating an identifier through learning using data subjected to the certain processing to the correct data by the processing means as learning data.
